(19) United States
(12) Patent Application Publication
(10) Pub. No.: US 2026/0120125 A1
(43) Pub. Date: Apr. 30, 2026

(54) ONLINE CHANGE POINT DETECTION IN STREAMING DATA

(71) Applicant: SAS Institute Inc., Cary, NC (US)

(72) Inventors: Srikanth Patala, Lincolnwood, IL (US); Michael David Nisenzon, Carrboro, NC (US); Arin Chaudhuri, Raleigh, NC (US)

(73) Assignee: SAS Institute Inc., Cary, NC (US)

(21) Appl. No.: 19/307,579

(22) Filed: Aug. 22, 2025

Related U.S. Application Data
(60) Provisional application No. 63/714,538, filed on Oct. 31, 2024.

(51) Int. Cl. G06Q 30/0201

(52) U.S. Cl. CPC G06Q 30/0201

(57) ABSTRACT

A system and method include receiving real-time streaming data, detecting a change in a distribution of the real-time streaming data by defining a reference window, defining a current window, computing a first weighted cumulative distribution function for the reference window based on a first weight value, computing a second weighted cumulative distribution function for the current window based on a second weight value, computing a maximum difference between the first weighted cumulative distribution function and the second weighted cumulative distribution function, computing a threshold value, and determining that the maximum difference is greater than the threshold value.

### CROSS-REFERENCE TO RELATED APPLICATIONS

This application is a non-provisional of U.S. provisional application No. 63/714,538, filed on Oct. 31, 2024, the entirety of which is incorporated by reference herein.

### BACKGROUND

Streaming data contains information that is continuously generated and transmitted, often in real-time, from various sources. Event Stream Processing (ESP) involves analyzing streaming data as the data comes in. The streaming data may be marked by change points that indicate moments when the statistical properties of the data shift, indicating that something new or unusual has occurred. Detection of such change points may be beneficial for a variety of reasons. For example, change points may help understand shifts in trends, monitor anomalies, or make informed decisions in various fields such as energy, medicine, climatology, manufacturing, artificial intelligence, etc. Existing mechanisms to detect change points are limited in their applicability and suitability.

### SUMMARY

In accordance with at least some aspects of the present disclosure, a non-transitory computer-readable medium having computer-readable instructions stored thereon is disclosed. The computer-readable instructions when executed by a processor cause the processor to receive real-time streaming data at an event stream processing engine to be processed, the real-time streaming data comprising a plurality of data points; analyze the plurality of data points at the event stream processing engine to detect a change in a distribution of the real-time streaming data by: (A) defining a reference window from the plurality of data points, the reference window comprising n data points of the plurality of data points, wherein the reference window is a damped window; (B) defining a current window from the plurality of data points, the current window comprising greater than n data points of the plurality of data points, wherein the current window is a damped window; (C) in real-time, as each data point of the reference window and the current window is received at the event stream processing engine: computing a first weighted cumulative distribution function for the reference window based on a first weight value assigned to each data point in the reference window; and computing a second weighted cumulative distribution function for the current window based on a second weight value assigned to each data point in the current window; (D) determining that the first weighted cumulative distribution function has been computed for all data points in the reference window and the second weighted cumulative distribution function has been computed for all data points in the current window; (E) responsive to determining that the first weighted cumulative distribution function has been computed for all data points in the reference window and the second weighted cumulative distribution function has been computed for all data points in the current window, computing a maximum difference between the first weighted cumulative distribution function and the second weighted cumulative distribution function; (F) computing a threshold value based on the n data points in the reference window, a damping factor, and a significance level, wherein the threshold value is an acceptable measure of dissimilarity in the distribution of the real-time streaming data; and (G) determining that the maximum difference is greater than the threshold value, wherein the maximum difference being greater than the threshold value indicates that the detected change in the distribution of the real-time streaming data is greater than the acceptable measure of dissimilarity; transform the detected change in the distribution of the real-time streaming data into an alert for a subscriber or client of the event streaming engine; and transmit the alert to the subscriber or client.

In accordance with at least some other aspects of the present disclosure, a system is disclosed. The system includes a memory having computer-readable instructions stored thereon and a processor that executes the computer-readable instructions to receive real-time streaming data at an event stream processing engine to be processed, the real-time streaming data comprising a plurality of data points; analyze the plurality of data points at the event stream processing engine to detect a change in a distribution of the real-time streaming data by: (A) defining a reference window from the plurality of data points, the reference window comprising n data points of the plurality of data points, wherein the reference window is a damped window; (B) defining a current window from the plurality of data points, the current window comprising greater than n data points of the plurality of data points, wherein the current window is a damped window; (C) in real-time, as each data point of the reference window and the current window is received at the event stream processing engine: computing a first weighted cumulative distribution function for the reference window based on a first weight value assigned to each data point in the reference window; and computing a second weighted cumulative distribution function for the current window based on a second weight value assigned to each data point in the current window; (D) determining that the first weighted cumulative distribution function has been computed for all data points in the reference window and the second weighted cumulative distribution function has been computed for all data points in the current window; (E) responsive to determining that the first weighted cumulative distribution function has been computed for all data points in the reference window and the second weighted cumulative distribution function has been computed for all data points in the current window, computing a maximum difference between the first weighted cumulative distribution function and the second weighted cumulative distribution function; (F) computing a threshold value based on the n data points in the reference window, a damping factor, and a significance level, wherein the threshold value is an acceptable measure of dissimilarity in the distribution of the real-time streaming data; and (G) determining that the maximum difference is greater than the threshold value, wherein the maximum difference being greater than the threshold value indicates that the detected change in the distribution of the real-time streaming data is greater than the acceptable measure of dissimilarity; transform the detected change in the distribution of the real-time streaming data into an alert for a subscriber or client of the event streaming engine; and transmit the alert to the subscriber or client.

In accordance with at least some other aspects of the present disclosure, a method is disclosed. The method includes receiving, by a processor executing computer-readable instructions stored on a memory, real-time streaming data at an event stream processing engine to be processed, the real-time streaming data comprising a plurality of data points; analyzing, by the processor, the plurality of data points at the event stream processing engine to detect a change in a distribution of the real-time streaming data by: (A) defining, by the processor, a reference window from the plurality of data points, the reference window comprising n data points of the plurality of data points, wherein the reference window is a damped window; (B) defining, by the processor, a current window from the plurality of data points, the current window comprising greater than n data points of the plurality of data points, wherein the current window is a damped window; (C) in real-time, as each data point of the reference window and the current window is received at the event stream processing engine: computing, by the processor, a first weighted cumulative distribution function for the reference window based on a first weight value assigned to each data point in the reference window; and computing, by the processor, a second weighted cumulative distribution function for the current window based on a second weight value assigned to each data point in the current window; (D) determining, by the processor, that the first weighted cumulative distribution function has been computed for all data points in the reference window and the second weighted cumulative distribution function has been computed for all data points in the current window; (E) responsive to determining that the first weighted cumulative distribution function has been computed for all data points in the reference window and the second weighted cumulative distribution function has been computed for all data points in the current window, computing, by the processor, a maximum difference between the first weighted cumulative distribution function and the second weighted cumulative distribution function; (F) computing, by the processor, a threshold value based on the n data points in the reference window, a damping factor, and a significance level, wherein the threshold value is an acceptable measure of dissimilarity in the distribution of the real-time streaming data; and (G) determining, by the processor, that the maximum difference is greater than the threshold value, wherein the maximum difference being greater than the threshold value indicates that the detected change in the distribution of the real-time streaming data is greater than the acceptable measure of dissimilarity; transforming, by the processor, the detected change in the distribution of the real-time streaming data into an alert for a subscriber or client of the event streaming engine; and transmitting, by the processor, the alert to the subscriber or client.

The foregoing summary is illustrative only and is not intended to be limiting in any way. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 illustrates a block diagram that provides an illustration of the hardware components of a computing system, according to some embodiments of the present technology.

FIG. 2 illustrates an example network including an example set of devices communicating with each other over an exchange system and via a network, according to some embodiments of the present technology.

FIG. 3 illustrates a representation of a conceptual model of a communications protocol system, according to some embodiments of the present technology.

FIG. 4 illustrates a communications grid computing system including a variety of control and worker nodes, according to some embodiments of the present technology.

FIG. 5 illustrates a flow chart showing an example process for adjusting a communications grid or a work project in a communications grid after a failure of a node, according to some embodiments of the present technology.

FIG. 6 illustrates a portion of a communications grid computing system including a control node and a worker node, according to some embodiments of the present technology.

FIG. 7 illustrates a flow chart showing an example process for executing a data analysis or processing project, according to some embodiments of the present technology.

FIG. 8 illustrates a block diagram including components of an Event Stream Processing Engine (ESPE), according to embodiments of the present technology.

FIG. 9 illustrates a flow chart showing an example process including operations performed by an event stream processing engine, according to some embodiments of the present technology.

FIG. 10 illustrates an ESP system interfacing between a publishing device and multiple event subscribing devices, according to embodiments of the present technology.

FIG. 11 illustrates a flow chart of an example of a process for generating and using a machine-learning model according to some aspects, according to embodiments of the present technology.

FIG. 12 illustrates an example of a machine-learning model as a neural network, according to embodiments of the present technology.

FIG. 13 illustrates various aspects of the use of containers as a mechanism to allocate processing, storage and/or other resources of a processing system to the performance of various analyses, according to embodiments of the present technology.

FIG. 14 illustrates a block diagram of an example change point detection system, according to embodiments of the present technology.

FIG. 15 illustrates a block diagram of an example change point detection application of the change point detection system of FIG. 14, according to embodiments of the present technology.

FIG. 16 illustrates an example graph showing damped weights in streaming data for detecting a change point by the change point detection application of FIG. 15, according to embodiments of the present technology.

FIG. 17 illustrates a block diagram of example weighted cumulative distribution functions (weighted CDFs) created using the damped weights of FIG. 16 for detecting a change point in the streaming data by the change point detection application of FIG. 15, according to embodiments of the present technology.

FIG. 18 illustrates an example of a plot showing the maximum difference between two weighted CDFs for detecting a change point in the streaming data by the change point detection application of FIG. 15, according to embodiments of the present technology.

FIG. 19 illustrates an example of a dissimilarity measure used for detecting a change point in the streaming data by the change point detection application of FIG. 15, according to embodiments of the present technology.

FIG. 20 illustrates a flowchart outlining an example process for detecting a change point by the change point detection application of FIG. 15, according to embodiments of the present technology.

FIG. 21 illustrates another flowchart outlining an operation of the flowchart of FIG. 20 in greater detail, according to embodiments of the present technology.

FIG. 22 illustrates another flowchart outlining an example process for detecting a change point by the change point detection application of FIG. 15, according to embodiments of the present technology.

FIGS. 23A-23C illustrate an example of Average Run Length (ARL), according to embodiments of the present technology.

FIG. 24 illustrates an example graph showing a relationship between ARL and a significance level, according to embodiments of the present technology.

FIGS. 25A and 25B illustrate an example of an Expected Detection Delay (EDD), according to embodiments of the present technology.

FIG. 26 illustrates an example graph showing a relationship between noise and EDD, according to embodiments of the present technology.

FIG. 27 illustrates an example graph showing a relationship between a threshold value and a size of a reference window, according to embodiments of the present technology.

FIG. 28 illustrates an example graph showing a relationship between EDD and a the size of the reference window, according to embodiments of the present technology.

FIGS. 29A-29D illustrate example graphs showing a relationship between the size of the reference window, the threshold value, and the significance level, according to embodiments of the present technology.

FIG. 30 illustrates an example graph showing a relationship between EDD, noise, and the significance level, according to embodiments of the present technology

The foregoing and other features of the present disclosure will become apparent from the following description and appended claims, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

### DETAILED DESCRIPTION

In the following description, for the purposes of explanation, specific details are set forth in order to provide a thorough understanding of embodiments of the technology. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the technology as set forth in the appended claims.

Specific details are given in the following description to provide a thorough understanding of the embodiments. However, it will be understood by one of ordinary skills in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional operations not included in a figure. A process may correspond to a method, a function, a procedure, a subroutine, a subprogram, etc. When a process corresponds to a function, its termination can correspond to a return of the function to the calling function or the main function.

Systems depicted in some of the figures may be provided in various configurations. In some embodiments, the systems may be configured as a distributed system where one or more components of the system are distributed across one or more networks in a cloud computing system.

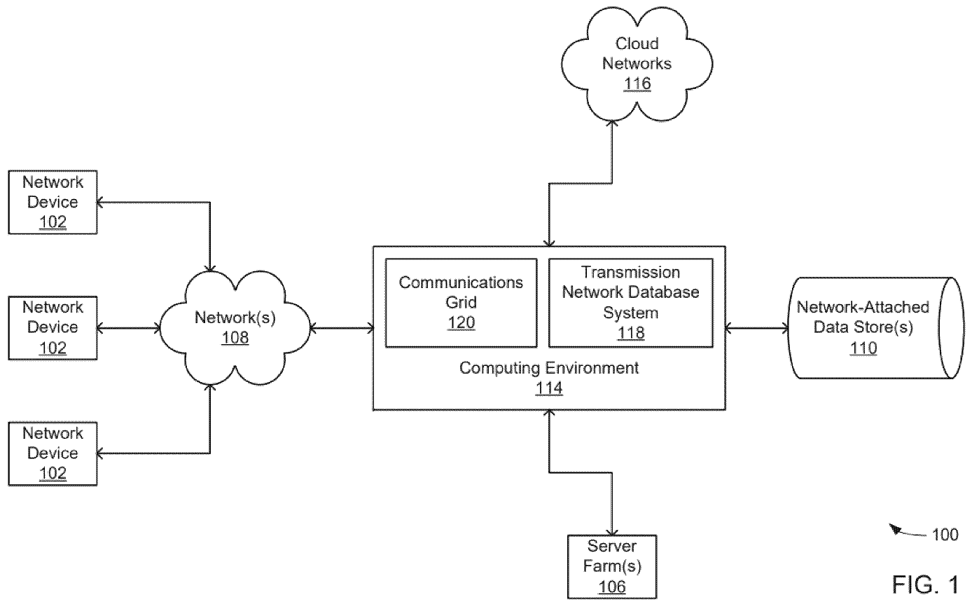

FIG. 1 is a block diagram that provides an illustration of the hardware components of a data transmission network 100, according to embodiments of the present technology. Data transmission network 100 is a specialized computer system that may be used for processing large amounts of data where a large number of computer processing cycles are required.

Data transmission network 100 may also include computing environment 114. Computing environment 114 may be a specialized computer or other machine that processes the data received within the data transmission network 100. Data transmission network 100 also includes one or more network devices 102. Network devices 102 may include client devices that attempt to communicate with computing environment 114. For example, network devices 102 may send data to the computing environment 114 to be processed, may send signals to the computing environment 114 to control different aspects of the computing environment or the data it is processing, among other reasons. Network devices 102 may interact with the computing environment 114 through a number of ways, such as, for example, over one or more networks 108. As shown in FIG. 1, computing environment 114 may include one or more other systems. For example, computing environment 114 may include a database system 118 and/or a communications grid 120.

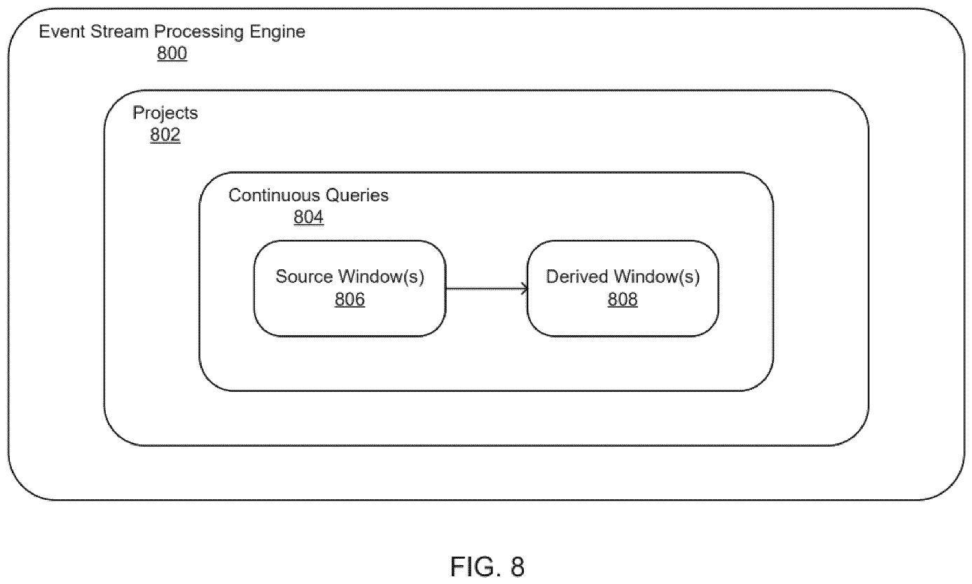

In other embodiments, network devices may provide a large amount of data, either all at once or streaming over a period of time (e.g., using event stream processing (ESP), described further with respect to FIGS. 8-10), to the computing environment 114 via networks 108. For example, network devices 102 may include network computers, sensors, databases, or other devices that may transmit or otherwise provide data to computing environment 114. For example, network devices may include local area network devices, such as routers, hubs, switches, or other computer networking devices. These devices may provide a variety of stored or generated data, such as network data or data specific to the network devices themselves. Network devices may also include sensors that monitor their environment or other devices to collect data regarding that environment or those devices, and such network devices may provide data they collect over time. Network devices may also include devices within the internet of things, such as devices within a home automation network. Some of these devices may be referred to as edge devices and may involve edge computing circuitry. Data may be transmitted by network devices directly to computing environment 114 or to network-attached data stores, such as network-attached data stores 110 for storage so that the data may be retrieved later by the computing environment 114 or other portions of data transmission network 100.

Data transmission network 100 may also include one or more network-attached data stores 110. Network-attached data stores 110 are used to store data to be processed by the computing environment 114 as well as any intermediate or final data generated by the computing system in non-volatile memory. However, in certain embodiments, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated on-the-fly. In this non-limiting situation, the computing environment 114 may be configured to retain the processed information within memory so that responses can be generated for the user at different levels of detail as well as allow a user to interactively query against this information.

Network-attached data stores may store a variety of different types of data organized in a variety of different ways and from a variety of different sources. For example, network-attached data storage may include storage other than primary storage located within computing environment 114 that is directly accessible by processors located therein. Network-attached data storage may include secondary, tertiary or auxiliary storage, such as large hard drives, servers, virtual memory, among other types. Storage devices may include portable or non-portable storage devices, optical storage devices, and various other mediums capable of storing, containing data. A machine-readable storage medium or computer-readable storage medium may include a non-transitory medium in which data can be stored and that does not include carrier waves and/or transitory electronic signals. Examples of a non-transitory medium may include, for example, a magnetic disk or tape, optical storage media such as compact disk or digital versatile disk, flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data, such as manufacturing data (e.g., a database containing records identifying products being manufactured with parameter data for each product, such as colors and models) or product sales databases (e.g., a database containing individual data records identifying details of individual product sales).

The unstructured data may be presented to the computing environment 114 in different forms such as a flat file or a conglomerate of data records, and may have data values and accompanying time stamps. The computing environment 114 may be used to analyze the unstructured data in a variety of ways to determine the best way to structure (e.g., hierarchically) that data, such that the structured data is tailored to a type of further analysis that a user wishes to perform on the data. For example, after being processed, the unstructured time stamped data may be aggregated by time (e.g., into daily time period units) to generate time series data and/or structured hierarchically according to one or more dimensions (e.g., parameters, attributes, and/or variables). For example, data may be stored in a hierarchical data structure, such as a ROLAP OR MOLAP database, or may be stored in another tabular form, such as in a flat-hierarchy form.

Data transmission network 100 may also include one or more server farms 106. Computing environment 114 may route select communications or data to the one or more sever farms 106 or one or more servers within the server farms. Server farms 106 can be configured to provide information in a predetermined manner. For example, server farms 106 may access data to transmit in response to a communication. Server farms 106 may be separately housed from each other device within data transmission network 100, such as computing environment 114, and/or may be part of a device or system.

Server farms 106 may host a variety of different types of data processing as part of data transmission network 100. Server farms 106 may receive a variety of different data from network devices, from computing environment 114, from cloud network 116, or from other sources. The data may have been obtained or collected from one or more sensors, as inputs from a control database, or may have been received as inputs from an external system or device. Server farms 106 may assist in processing the data by turning raw data into processed data based on one or more rules implemented by the server farms. For example, sensor data may be analyzed to determine changes in an environment over time or in real-time.

Data transmission network 100 may also include one or more cloud networks 116. Cloud network 116 may include a cloud infrastructure system that provides cloud services. In certain embodiments, services provided by the cloud network 116 may include a host of services that are made available to users of the cloud infrastructure system on demand. Cloud network 116 is shown in FIG. 1 as being connected to computing environment 114 (and therefore having computing environment 114 as its client or user), but cloud network 116 may be connected to or utilized by any of the devices in FIG. 1. Services provided by the cloud network can dynamically scale to meet the needs of its users. The cloud network 116 may include one or more computers, servers, and/or systems. In some embodiments, the computers, servers, and/or systems that make up the cloud network 116 are different from the user's own on-premises computers, servers, and/or systems. For example, the cloud network 116 may host an application, and a user may, via a communication network such as the Internet, on demand, order and use the application.

While each device, server and system in FIG. 1 is shown as a single device, it will be appreciated that multiple devices may instead be used. For example, a set of network devices can be used to transmit various communications from a single user, or remote server 140 may include a server stack. As another example, data may be processed as part of computing environment 114.

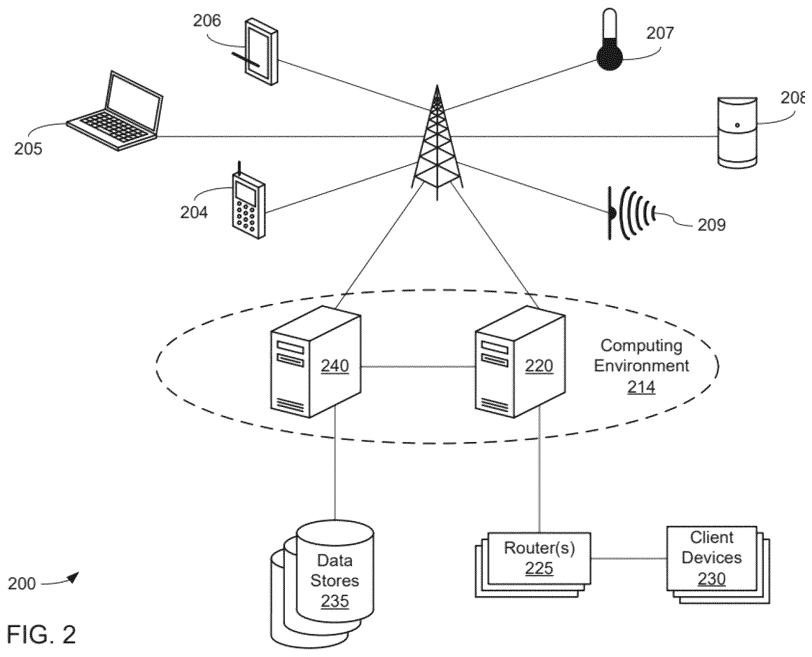

Each communication within data transmission network 100 (e.g., between client devices, between servers 106 and computing environment 114 or between a server and a device) may occur over one or more networks 108. Networks 108 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or combination of wireless interfaces. As an example, a network in the one or more networks 108 may include a short-range communication channel, such as a BLUETOOTH® communication channel or a BLUETOOTH® Low Energy communication channel. A wired network may include a wired interface. The wired and/or wireless networks may be implemented using routers, access points, bridges, gateways, or the like, to connect devices in the network 114, as will be further described with respect to FIG. 2. The one or more networks 108 can be incorporated entirely within or can include an intranet, an extranet, or a combination thereof. In one embodiment, communications between two or more systems and/or devices can be achieved by a secure communications protocol, such as secure sockets layer (SSL) or transport layer security (TLS). In addition, data and/or transactional details may be encrypted.

Some aspects may utilize the Internet of Things (IoT), where things (e.g., machines, devices, phones, sensors) can be connected to networks and the data from these things can be collected and processed within the things and/or external to the things. For example, the IoT can include sensors in many different devices, and high value analytics can be applied to identify hidden relationships and drive increased efficiencies. This can apply to both big data analytics and real-time (e.g., ESP) analytics. This will be described further below with respect to FIG. 2.

As noted, computing environment 114 may include a communications grid 120 and a transmission network database system 118. Communications grid 120 may be a grid-based computing system for processing large amounts of data. The transmission network database system 118 may be for managing, storing, and retrieving large amounts of data that are distributed to and stored in the one or more network-attached data stores 110 or other data stores that reside at different locations within the transmission network database system 118. The compute nodes in the grid-based computing system 120 and the transmission network database system 118 may share the same processor hardware, such as processors that are located within computing environment 114.

FIG. 2 illustrates an example network including an example set of devices communicating with each other over an exchange system and via a network, according to embodiments of the present technology. As noted, each communication within data transmission network 100 may occur over one or more networks. System 200 includes a network device 204 configured to communicate with a variety of types of client devices, for example client devices 230, over a variety of types of communication channels.

As shown in FIG. 2, network device 204 can transmit a communication over a network (e.g., a cellular network via a base station 210). The communication can be routed to another network device, such as network devices 205-209, via base station 210. The communication can also be routed to computing environment 214 via base station 210. For example, network device 204 may collect data either from its surrounding environment or from other network devices (such as network devices 205-209) and transmit that data to computing environment 214.

Although network devices 204-209 are shown in FIG. 2 as a mobile phone, laptop computer, tablet computer, temperature sensor, motion sensor, and audio sensor respectively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, flow rate sensors, among others. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, and electrical current, among others. The sensors may be mounted to various components used as part of a variety of different types of systems (e.g., an oil drilling operation). The network devices may detect and record data related to the environment that it monitors, and transmit that data to computing environment 214.

As noted, one type of system that may include various sensors that collect data to be processed and/or transmitted to a computing environment according to certain embodiments includes an oil drilling system. For example, the one or more drilling operation sensors may include surface sensors that measure a hook load, a fluid rate, a temperature and a density in and out of the wellbore, a standpipe pressure, a surface torque, a rotation speed of a drill pipe, a rate of penetration, a mechanical specific energy, etc. and downhole sensors that measure a rotation speed of a bit, fluid densities, downhole torque, downhole vibration (axial, tangential, lateral), a weight applied at a drill bit, an annular pressure, a differential pressure, an azimuth, an inclination, a dog leg severity, a measured depth, a vertical depth, a downhole temperature, etc. Besides the raw data collected directly by the sensors, other data may include parameters either developed by the sensors or assigned to the system by a client or other controlling device. For example, one or more drilling operation control parameters may control settings such as a mud motor speed to flow ratio, a bit diameter, a predicted formation top, seismic data, weather data, etc. Other data may be generated using physical models such as an earth model, a weather model, a seismic model, a bottom hole assembly model, a well plan model, an annular friction model, etc. In addition to sensor and control settings, predicted outputs, of for example, the rate of penetration, mechanical specific energy, hook load, flow in fluid rate, flow out fluid rate, pump pressure, surface torque, rotation speed of the drill pipe, annular pressure, annular friction pressure, annular temperature, equivalent circulating density, etc. may also be stored in the data warehouse.

In another example, another type of system that may include various sensors that collect data to be processed and/or transmitted to a computing environment according to certain embodiments includes a home automation or similar automated network in a different environment, such as an office space, school, public space, sports venue, or a variety of other locations. Network devices in such an automated network may include network devices that allow a user to access, control, and/or configure various home appliances located within the user's home (e.g., a television, radio, light, fan, humidifier, sensor, microwave, iron, and/or the like), or outside of the user's home (e.g., exterior motion sensors, exterior lighting, garage door openers, sprinkler systems, or the like). For example, network device 102 may include a home automation switch that may be coupled with a home appliance. In another embodiment, a network device can allow a user to access, control, and/or configure devices, such as office-related devices (e.g., copy machine, printer, or fax machine), audio and/or video related devices (e.g., a receiver, a speaker, a projector, a DVD player, or a television), media-playback devices (e.g., a compact disc player, a CD player, or the like), computing devices (e.g., a home computer, a laptop computer, a tablet, a personal digital assistant (PDA), a computing device, or a wearable device), lighting devices (e.g., a lamp or recessed lighting), devices associated with a security system, devices associated with an alarm system, devices that can be operated in an automobile (e.g., radio devices, navigation devices), and/or the like. Data may be collected from such various sensors in raw form, or data may be processed by the sensors to create parameters or other data either developed by the sensors based on the raw data or assigned to the system by a client or other controlling device.

In another example, another type of system that may include various sensors that collect data to be processed and/or transmitted to a computing environment according to certain embodiments includes a power or energy grid. A variety of different network devices may be included in an energy grid, such as various devices within one or more power plants, energy farms (e.g., wind farm, solar farm, among others) energy storage facilities, factories, homes and businesses of consumers, among others. One or more of such devices may include one or more sensors that detect energy gain or loss, electrical input or output or loss, and a variety of other efficiencies. These sensors may collect data to inform users of how the energy grid, and individual devices within the grid, may be functioning and how they may be made more efficient.

Network device sensors may also perform processing on data it collects before transmitting the data to the computing environment 114, or before deciding whether to transmit data to the computing environment 114. For example, network devices may determine whether data collected meets certain rules, for example by comparing data or values calculated from the data and comparing that data to one or more thresholds. The network device may use this data and/or comparisons to determine if the data should be transmitted to the computing environment 214 for further use or processing.

Computing environment 214 may include machines 220 and 240. Although computing environment 214 is shown in FIG. 2 as having two machines, 220 and 240, computing environment 214 may have only one machine or may have more than two machines. The machines that make up computing environment 214 may include specialized computers, servers, or other machines that are configured to individually and/or collectively process large amounts of data. The computing environment 214 may also include storage devices that include one or more databases of structured data, such as data organized in one or more hierarchies, or unstructured data. The databases may communicate with the processing devices within computing environment 214 to distribute data to them. Since network devices may transmit data to computing environment 214, that data may be received by the computing environment 214 and subsequently stored within those storage devices. Data used by computing environment 214 may also be stored in data stores 235, which may also be a part of or connected to computing environment 214.

Computing environment 214 can communicate with various devices via one or more routers 225 or other inter-network or intra-network connection components. For example, computing environment 214 may communicate with devices 230 via one or more routers 225. Computing environment 214 may collect, analyze and/or store data from or pertaining to communications, client device operations, client rules, and/or user-associated actions stored at one or more data stores 235. Such data may influence communication routing to the devices within computing environment 214, how data is stored or processed within computing environment 214, among other actions.

Notably, various other devices can further be used to influence communication routing and/or processing between devices within computing environment 214 and with devices outside of computing environment 214. For example, as shown in FIG. 2, computing environment 214 may include a web server 240. Thus, computing environment 214 can retrieve data of interest, such as client information (e.g., product information, client rules, etc.), technical product details, news, current or predicted weather, and so on.

In addition to computing environment 214 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis. For example, network devices may receive data periodically from network device sensors as the sensors continuously sense, monitor and track changes in their environments. Devices within computing environment 214 may also perform pre-analysis on data it receives to determine if the data received should be processed as part of an ongoing project. The data received and collected by computing environment 214, no matter what the source or method or timing of receipt, may be processed over a period of time for a client to determine results data based on the client's needs and rules.

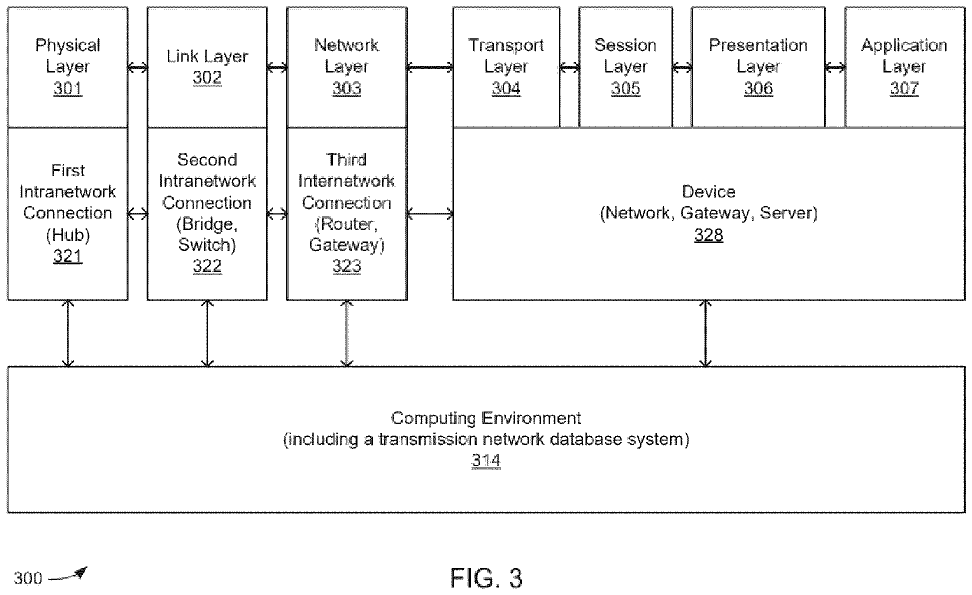

FIG. 3 illustrates a representation of a conceptual model of a communications protocol system, according to embodiments of the present technology. More specifically, FIG. 3 identifies operation of a computing environment in an Open Systems Interaction model that corresponds to various connection components. The model 300 shows, for example, how a computing environment, such as computing environment 314 (or computing environment 214 in FIG. 2) may communicate with other devices in its network, and control how communications between the computing environment and other devices are executed and under what conditions.

The model can include layers 301-307. The layers are arranged in a stack. Each layer in the stack serves the layer one level higher than it (except for the application layer, which is the highest layer), and is served by the layer one level below it (except for the physical layer, which is the lowest layer). The physical layer is the lowest layer because it receives and transmits raw bites of data, and is the farthest layer from the user in a communications system. On the other hand, the application layer is the highest layer because it interacts directly with a software application.

As noted, the model includes a physical layer 301. Physical layer 301 represents physical communication, and can define parameters of that physical communication. For example, such physical communication may come in the form of electrical, optical, or electromagnetic signals. Physical layer 301 also defines protocols that may control communications within a data transmission network.

Link layer 302 defines links and mechanisms used to transmit (i.e., move) data across a network. The link layer 302 manages node-to-node communications, such as within a grid computing environment. Link layer 302 can detect and correct errors (e.g., transmission errors in the physical layer 301). Link layer 302 can also include a media access control (MAC) layer and logical link control (LLC) layer.

Network layer 303 defines the protocol for routing within a network. In other words, the network layer coordinates transferring data across nodes in the same network (e.g., such as a grid computing environment). Network layer 303 can also define the processes used to structure local addressing within the network.

Transport layer 304 can manage the transmission of data and the quality of the transmission and/or receipt of that data. Transport layer 304 can provide a protocol for transferring data, such as, for example, a Transmission Control Protocol (TCP). Transport layer 304 can assemble and disassemble data frames for transmission. The transport layer can also detect transmission errors occurring in the layers below it.

Session layer 305 can establish, maintain, and manage communication connections between devices on a network. In other words, the session layer controls the dialogues or nature of communications between network devices on the network. The session layer may also establish checkpointing, adjournment, termination, and restart procedures.

Presentation layer 306 can provide translation for communications between the application and network layers. In other words, this layer may encrypt, decrypt and/or format data based on data types and/or encodings known to be accepted by an application or network layer.

Application layer 307 interacts directly with software applications and end users, and manages communications between them. Application layer 307 can identify destinations, local resource states or availability and/or communication content or formatting using the applications.

Intra-network connection components 321 and 322 are shown to operate in lower levels, such as physical layer 301 and link layer 302, respectively. For example, a hub can operate in the physical layer, a switch can operate in the link layer, and a router can operate in the network layer. Inter-network connection components 323 and 328 are shown to operate on higher levels, such as layers 303-307. For example, routers can operate in the network layer and network devices can operate in the transport, session, presentation, and application layers.

As noted, a computing environment 314 can interact with and/or operate on, in various embodiments, one, more, all or any of the various layers. For example, computing environment 314 can interact with a hub (e.g., via the link layer) so as to adjust which devices the hub communicates with. The physical layer may be served by the link layer, so it may implement such data from the link layer. For example, the computing environment 314 may control which devices it will receive data from. For example, if the computing environment 314 knows that a certain network device has turned off, broken, or otherwise become unavailable or unreliable, the computing environment 314 may instruct the hub to prevent any data from being transmitted to the computing environment 314 from that network device. Such a process may be beneficial to avoid receiving data that is inaccurate or that has been influenced by an uncontrolled environment. As another example, computing environment 314 can communicate with a bridge, switch, router or gateway and influence which device within the system (e.g., system 200) the component selects as a destination. In some embodiments, computing environment 314 can interact with various layers by exchanging communications with equipment operating on a particular layer by routing or modifying existing communications. In another embodiment, such as in a grid computing environment, a node may determine how data within the environment should be routed (e.g., which node should receive certain data) based on certain parameters or information provided by other layers within the model.

As noted, the computing environment 314 may be a part of a communications grid environment, the communications of which may be implemented as shown in the protocol of FIG. 3. For example, referring back to FIG. 2, one or more of machines 220 and 240 may be part of a communications grid computing environment. A gridded computing environment may be employed in a distributed system with non-interactive workloads where data resides in memory on the machines, or compute nodes. In such an environment, analytic code, instead of a database management system, controls the processing performed by the nodes. Data is co-located by pre-distributing it to the grid nodes, and the analytic code on each node loads the local data into memory. Each node may be assigned a particular task such as a portion of a processing project, or to organize or control other nodes within the grid.

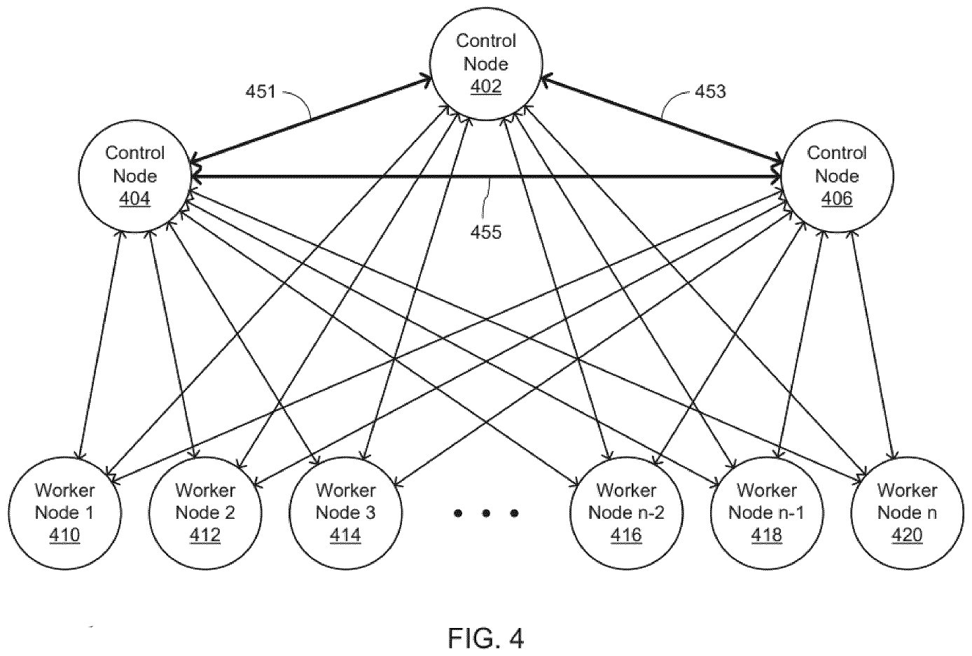

FIG. 4 illustrates a communications grid computing system 400 including a variety of control and worker nodes, according to embodiments of the present technology. Communications grid computing system 400 includes three control nodes and one or more worker nodes. Communications grid computing system 400 includes control nodes 402, 404, and 406. The control nodes are communicatively connected via communication paths 451, 453, and 455. Therefore, the control nodes may transmit information (e.g., related to the communications grid or notifications), to and receive information from each other. Although communications grid computing system 400 is shown in FIG. 4 as including three control nodes, the communications grid may include more or less than three control nodes.

Communications grid computing system (or just “communications grid”) 400 also includes one or more worker nodes. Shown in FIG. 4 are six worker nodes 410-420. Although FIG. 4 shows six worker nodes, a communications grid according to embodiments of the present technology may include more or less than six worker nodes. The number of worker nodes included in a communications grid may be dependent upon how large the project or data set is being processed by the communications grid, the capacity of each worker node, the time designated for the communications grid to complete the project, among others. Each worker node within the communications grid 400 may be connected (wired or wirelessly, and directly or indirectly) to control nodes 402-406. Therefore, each worker node may receive information from the control nodes (e.g., an instruction to perform work on a project) and may transmit information to the control nodes (e.g., a result from work performed on a project). Furthermore, worker nodes may communicate with each other (either directly or indirectly). For example, worker nodes may transmit data between each other related to a job being performed or an individual task within a job being performed by that worker node. However, in certain embodiments, worker nodes may not, for example, be connected (communicatively or otherwise) to certain other worker nodes. In an embodiment, worker nodes may only be able to communicate with the control node that controls it, and may not be able to communicate with other worker nodes in the communications grid, whether they are other worker nodes controlled by the control node that controls the worker node, or worker nodes that are controlled by other control nodes in the communications grid.

A control node may connect with an external device with which the control node may communicate (e.g., a grid user, such as a server or computer, may connect to a controller of the grid). For example, a server or computer may connect to control nodes and may transmit a project or job to the node. The project may include a data set. The data set may be of any size. Once the control node receives such a project including a large data set, the control node may distribute the data set or projects related to the data set to be performed by worker nodes. Alternatively, for a project including a large data set, the data set may be received or stored by a machine other than a control node (e.g., a HADOOP® standard-compliant data node employing the HADOOP® Distributed File System, or HDFS).

Control nodes may maintain knowledge of the status of the nodes in the grid (i.e., grid status information), accept work requests from clients, subdivide the work across worker nodes, and coordinate the worker nodes, among other responsibilities. Worker nodes may accept work requests from a control node and provide the control node with results of the work performed by the worker node. A grid may be started from a single node (e.g., a machine, computer, server, etc.). This first node may be assigned or may start as the primary control node that will control any additional nodes that enter the grid.

When a project is submitted for execution (e.g., by a client or a controller of the grid) it may be assigned to a set of nodes. After the nodes are assigned to a project, a data structure (i.e., a communicator) may be created. The communicator may be used by the project for information to be shared between the project codes running on each node. A communication handle may be created on each node. A handle, for example, is a reference to the communicator that is valid within a single process on a single node, and the handle may be used when requesting communications between nodes.

A control node, such as control node 402, may be designated as the primary control node. A server, computer or other external device may connect to the primary control node. Once the control node receives a project, the primary control node may distribute portions of the project to its worker nodes for execution. For example, when a project is initiated on communications grid 400, primary control node 402 controls the work to be performed for the project in order to complete the project as requested or instructed. The primary control node may distribute work to the worker nodes based on various factors, such as which subsets or portions of projects may be completed most efficiently and in the correct amount of time. For example, a worker node may perform analysis on a portion of data that is already local (e.g., stored on) the worker node. The primary control node also coordinates and processes the results of the work performed by each worker node after each worker node executes and completes its job. For example, the primary control node may receive a result from one or more worker nodes, and the control node may organize (e.g., collect and assemble) the results received and compile them to produce a complete result for the project received from the end user.

Any remaining control nodes, such as control nodes 404 and 406, may be assigned as backup control nodes for the project. In an embodiment, backup control nodes may not control any portion of the project. Instead, backup control nodes may serve as a backup for the primary control node and take over as primary control node if the primary control node were to fail. If a communications grid were to include only a single control node, and the control node were to fail (e.g., the control node is shut off or breaks) then the communications grid as a whole may fail and any project or job being run on the communications grid may fail and may not complete. While the project may be run again, such a failure may cause a delay (severe delay in some cases, such as overnight delay) in completion of the project. Therefore, a grid with multiple control nodes, including a backup control node, may be beneficial.

To add another node or machine to the grid, the primary control node may open a pair of listening sockets, for example. A socket may be used to accept work requests from clients, and the second socket may be used to accept connections from other grid nodes. The primary control node may be provided with a list of other nodes (e.g., other machines, computers, servers) that will participate in the grid, and the role that each node will fill in the grid. Upon startup of the primary control node (e.g., the first node on the grid), the primary control node may use a network protocol to start the server process on every other node in the grid. Command line parameters, for example, may inform each node of one or more pieces of information, such as: the role that the node will have in the grid, the host name of the primary control node, the port number on which the primary control node is accepting connections from peer nodes, among others. The information may also be provided in a configuration file, transmitted over a secure shell tunnel, recovered from a configuration server, among others. While the other machines in the grid may not initially know about the configuration of the grid, that information may also be sent to each other node by the primary control node. Updates of the grid information may also be subsequently sent to those nodes.

For any control node other than the primary control node added to the grid, the control node may open three sockets. The first socket may accept work requests from clients, the second socket may accept connections from other grid members, and the third socket may connect (e.g., permanently) to the primary control node. When a control node (e.g., primary control node) receives a connection from another control node, it first checks to see if the peer node is in the list of configured nodes in the grid. If it is not on the list, the control node may clear the connection. If it is on the list, it may then attempt to authenticate the connection. If authentication is successful, the authenticating node may transmit information to its peer, such as the port number on which a node is listening for connections, the host name of the node, information about how to authenticate the node, among other information. When a node, such as the new control node, receives information about another active node, it will check to see if it already has a connection to that other node. If it does not have a connection to that node, it may then establish a connection to that control node.

Any worker node added to the grid may establish a connection to the primary control node and any other control nodes on the grid. After establishing the connection, it may authenticate itself to the grid (e.g., any control nodes, including both primary and backup, or a server or user controlling the grid). After successful authentication, the worker node may accept configuration information from the control node.

When a node joins a communications grid (e.g., when the node is powered on or connected to an existing node on the grid or both), the node is assigned (e.g., by an operating system of the grid) a universally unique identifier (UUID). This unique identifier may help other nodes and external entities (devices, users, etc.) to identify the node and distinguish it from other nodes. When a node is connected to the grid, the node may share its unique identifier with the other nodes in the grid. Since each node may share its unique identifier, each node may know the unique identifier of every other node on the grid. Unique identifiers may also designate a hierarchy of each of the nodes (e.g., backup control nodes) within the grid. For example, the unique identifiers of each of the backup control nodes may be stored in a list of backup control nodes to indicate an order in which the backup control nodes will take over for a failed primary control node to become a new primary control node. However, a hierarchy of nodes may also be determined using methods other than using the unique identifiers of the nodes. For example, the hierarchy may be predetermined, or may be assigned based on other predetermined factors.

The grid may add new machines at any time (e.g., initiated from any control node). Upon adding a new node to the grid, the control node may first add the new node to its table of grid nodes. The control node may also then notify every other control node about the new node. The nodes receiving the notification may acknowledge that they have updated their configuration information.

Primary control node 402 may, for example, transmit one or more communications to backup control nodes 404 and 406 (and, for example, to other control or worker nodes within the communications grid). Such communications may be sent periodically, at fixed time intervals, between known fixed stages of the project's execution, among other protocols. The communications transmitted by primary control node 402 may be of varied types and may include a variety of types of information. For example, primary control node 402 may transmit snapshots (e.g., status information) of the communications grid so that backup control node 404 always has a recent snapshot of the communications grid. The snapshot or grid status may include, for example, the structure of the grid (including, for example, the worker nodes in the grid, unique identifiers of the nodes, or their relationships with the primary control node) and the status of a project (including, for example, the status of each worker node's portion of the project). The snapshot may also include analysis or results received from worker nodes in the communications grid. The backup control nodes may receive and store the backup data received from the primary control node. The backup control nodes may transmit a request for such a snapshot (or other information) from the primary control node, or the primary control node may send such information periodically to the backup control nodes.

As noted, the backup data may allow the backup control node to take over as primary control node if the primary control node fails without requiring the grid to start the project over from scratch. If the primary control node fails, the backup control node that will take over as primary control node may retrieve the most recent version of the snapshot received from the primary control node and use the snapshot to continue the project from the stage of the project indicated by the backup data. This may prevent failure of the project as a whole.

A backup control node may use various methods to determine that the primary control node has failed. In one example of such a method, the primary control node may transmit (e.g., periodically) a communication to the backup control node that indicates that the primary control node is working and has not failed, such as a heartbeat communication. The backup control node may determine that the primary control node has failed if the backup control node has not received a heartbeat communication for a certain predetermined period of time. Alternatively, a backup control node may also receive a communication from the primary control node itself (before it failed) or from a worker node that the primary control node has failed, for example because the primary control node has failed to communicate with the worker node.

Different methods may be performed to determine which backup control node of a set of backup control nodes (e.g., backup control nodes 404 and 406) will take over for failed primary control node 402 and become the new primary control node. For example, the new primary control node may be chosen based on a ranking or “hierarchy” of backup control nodes based on their unique identifiers. In an alternative embodiment, a backup control node may be assigned to be the new primary control node by another device in the communications grid or from an external device (e.g., a system infrastructure or an end user, such as a server or computer, controlling the communications grid). In another alternative embodiment, the backup control node that takes over as the new primary control node may be designated based on bandwidth or other statistics about the communications grid.

A worker node within the communications grid may also fail. If a worker node fails, work being performed by the failed worker node may be redistributed amongst the operational worker nodes. In an alternative embodiment, the primary control node may transmit a communication to each of the operable worker nodes still on the communications grid that each of the worker nodes should purposefully fail also. After each of the worker nodes fail, they may each retrieve their most recent saved checkpoint of their status and restart the project from that checkpoint to minimize lost progress on the project being executed.

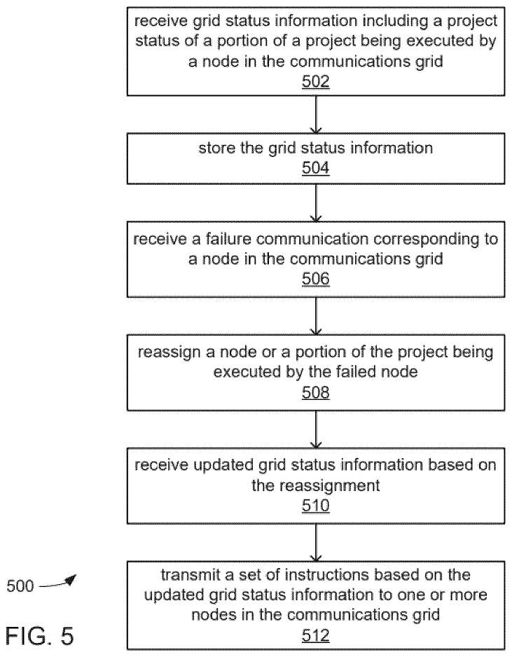

FIG. 5 illustrates a flow chart showing an example process 500 for adjusting a communications grid or a work project in a communications grid after a failure of a node, according to embodiments of the present technology. The process may include, for example, receiving grid status information including a project status of a portion of a project being executed by a node in the communications grid, as described in operation 502. For example, a control node (e.g., a backup control node connected to a primary control node and a worker node on a communications grid) may receive grid status information, where the grid status information includes a project status of the primary control node or a project status of the worker node. The project status of the primary control node and the project status of the worker node may include a status of one or more portions of a project being executed by the primary and worker nodes in the communications grid. The process may also include storing the grid status information, as described in operation 504. For example, a control node (e.g., a backup control node) may store the received grid status information locally within the control node. Alternatively, the grid status information may be sent to another device for storage where the control node may have access to the information.

The process may also include receiving a failure communication corresponding to a node in the communications grid in operation 506. For example, a node may receive a failure communication including an indication that the primary control node has failed, prompting a backup control node to take over for the primary control node. In an alternative embodiment, a node may receive a failure that a worker node has failed, prompting a control node to reassign the work being performed by the worker node. The process may also include reassigning a node or a portion of the project being executed by the failed node, as described in operation 508. For example, a control node may designate the backup control node as a new primary control node based on the failure communication upon receiving the failure communication. If the failed node is a worker node, a control node may identify a project status of the failed worker node using the snapshot of the communications grid, where the project status of the failed worker node includes a status of a portion of the project being executed by the failed worker node at the failure time.

The process may also include receiving updated grid status information based on the reassignment, as described in operation 510, and transmitting a set of instructions based on the updated grid status information to one or more nodes in the communications grid, as described in operation 512. The updated grid status information may include an updated project status of the primary control node or an updated project status of the worker node. The updated information may be transmitted to the other nodes in the grid to update their stale stored information.

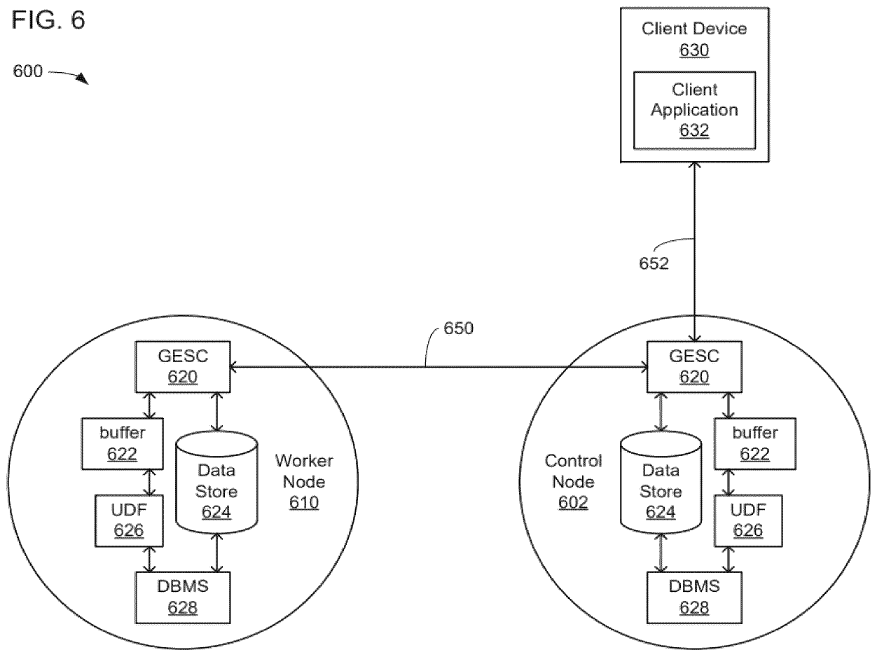

FIG. 6 illustrates a portion of a communications grid computing system 600 including a control node and a worker node, according to embodiments of the present technology. Communications grid 600 computing system includes one control node (control node 602) and one worker node (worker node 610) for purposes of illustration, but may include more worker and/or control nodes. The control node 602 is communicatively connected to worker node 610 via communication path 650. Therefore, control node 602 may transmit information (e.g., related to the communications grid or notifications), to and receive information from worker node 610 via path 650.

Similar to in FIG. 4, communications grid computing system (or just “communications grid”) 600 includes data processing nodes (control node 602 and worker node 610). Nodes 602 and 610 include multi-core data processors. Each node 602 and 610 includes a grid-enabled software component (GESC) 620 that executes on the data processor associated with that node and interfaces with buffer memory 622 also associated with that node. Each node 602 and 610 includes database management software (DBMS) 628 that executes on a database server (not shown) at control node 602 and on a database server (not shown) at worker node 610.

Each node also includes a data store 624. Data stores 624, similar to network-attached data stores 110 in FIG. 1 and data stores 235 in FIG. 2, are used to store data to be processed by the nodes in the computing environment. Data stores 624 may also store any intermediate or final data generated by the computing system after being processed, for example in non-volatile memory. However in certain embodiments, the configuration of the grid computing environment allows its operations to be performed such that intermediate and final data results can be stored solely in volatile memory (e.g., RAM), without a requirement that intermediate or final data results be stored to non-volatile types of memory. Storing such data in volatile memory may be useful in certain situations, such as when the grid receives queries (e.g., ad hoc) from a client and when responses, which are generated by processing large amounts of data, need to be generated quickly or on-the-fly. In such a situation, the grid may be configured to retain the data within memory so that responses can be generated at different levels of detail and so that a client may interactively query against this information.

Each node also includes a user-defined function (UDF) 626. The UDF provides a mechanism for the DBMS 628 to transfer data to or receive data from the database stored in the data stores 624 that are managed by the DBMS. For example, UDF 626 can be invoked by the DBMS to provide data to the GESC for processing. The UDF 626 may establish a socket connection (not shown) with the GESC to transfer the data. Alternatively, the UDF 626 can transfer data to the GESC by writing data to shared memory accessible by both the UDF and the GESC.

The GESC 620 at the nodes 602 and 620 may be connected via a network, such as network 108 shown in FIG. 1. Therefore, nodes 602 and 620 can communicate with each other via the network using a predetermined communication protocol such as, for example, the Message Passing Interface (MPI). Each GESC 620 can engage in point-to-point communication with the GESC at another node or in collective communication with multiple GESCs via the network. The GESC 620 at each node may contain identical (or nearly identical) software instructions. Each node may be capable of operating as either a control node or a worker node. The GESC at the control node 602 can communicate, over a communication path 652, with a client device 630. More specifically, control node 602 may communicate with client application 632 hosted by the client device 630 to receive queries and to respond to those queries after processing large amounts of data.

DBMS 628 may control the creation, maintenance, and use of database or data structure (not shown) within a node 602 or 610. The database may organize data stored in data stores 624. The DBMS 628 at control node 602 may accept requests for data and transfer the appropriate data for the request. With such a process, collections of data may be distributed across multiple physical locations. In this example, each node 602 and 610 stores a portion of the total data managed by the management system in its associated data store 624.

Furthermore, the DBMS may be responsible for protecting against data loss using replication techniques. Replication includes providing a backup copy of data stored on one node on one or more other nodes. Therefore, if one node fails, the data from the failed node can be recovered from a replicated copy residing at another node. However, as described herein with respect to FIG. 4, data or status information for each node in the communications grid may also be shared with each node on the grid.

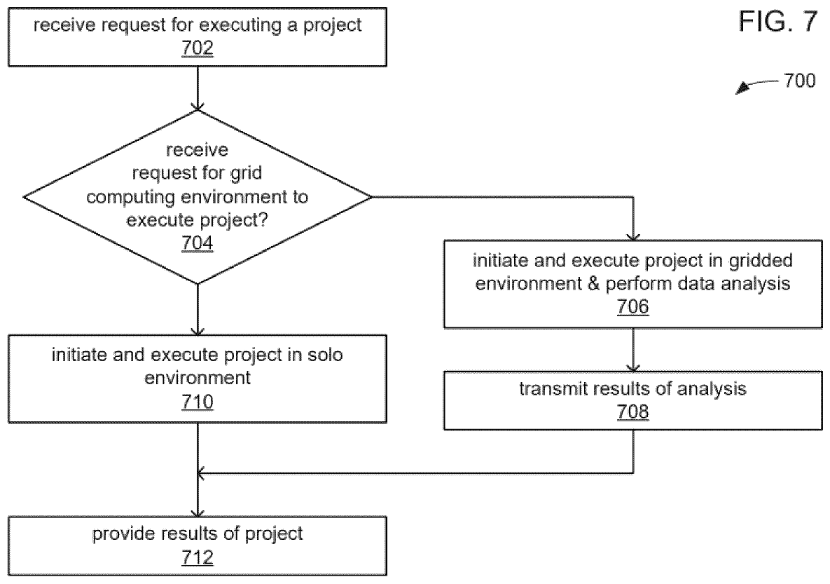

FIG. 7 illustrates a flow chart showing an example method 700 for executing a project within a grid computing system, according to embodiments of the present technology. As described with respect to FIG. 6, the GESC at the control node may transmit data with a client device (e.g., client device 630) to receive queries for executing a project and to respond to those queries after large amounts of data have been processed. The query may be transmitted to the control node, where the query may include a request for executing a project, as described in operation 702. The query can contain instructions on the type of data analysis to be performed in the project and whether the project should be executed using the grid-based computing environment, as shown in operation 704.

To initiate the project, the control node may determine if the query requests use of the grid-based computing environment to execute the project. If the determination is no, then the control node initiates execution of the project in a solo environment (e.g., at the control node), as described in operation 710. If the determination is yes, the control node may initiate execution of the project in the grid-based computing environment, as described in operation 706. In such a situation, the request may include a requested configuration of the grid. For example, the request may include a number of control nodes and a number of worker nodes to be used in the grid when executing the project. After the project has been completed, the control node may transmit results of the analysis yielded by the grid, as described in operation 708. Whether the project is executed in a solo or grid-based environment, the control node provides the results of the project, as described in operation 712.

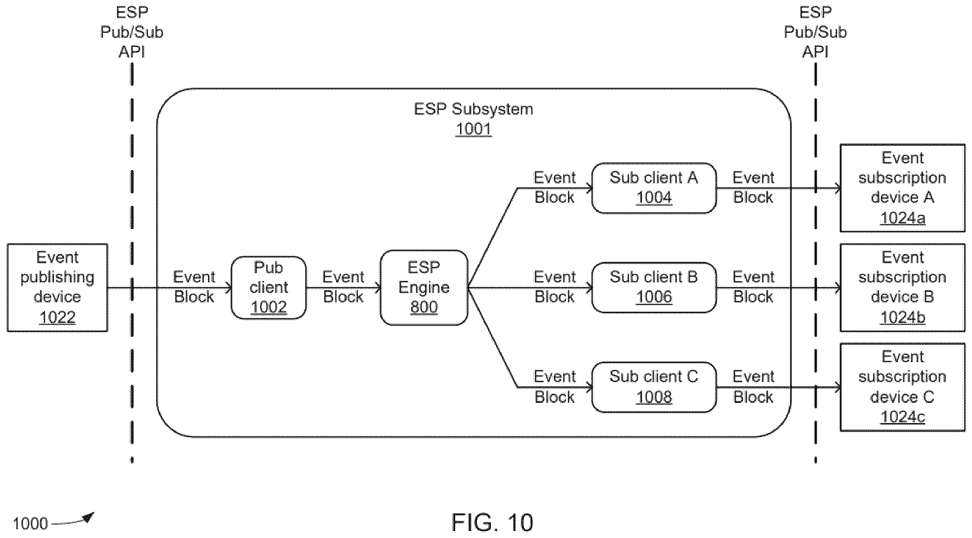

As noted with respect to FIG. 2, the computing environments described herein may collect data (e.g., as received from network devices, such as sensors, such as network devices 204-209 in FIG. 2, and client devices or other sources) to be processed as part of a data analytics project, and data may be received in real time as part of a streaming analytics environment (e.g., ESP). Data may be collected using a variety of sources as communicated via different kinds of networks or locally, such as on a real-time streaming basis. For example, network devices may receive data periodically from network device sensors as the sensors continuously sense, monitor and track changes in their environments. More specifically, an increasing number of distributed applications develop or produce continuously flowing data from distributed sources by applying queries to the data before distributing the data to geographically distributed recipients. An event stream processing engine (ESPE) may continuously apply the queries to the data as it is received and determines which entities should receive the data. Client or other devices may also subscribe to the ESPE or other devices processing ESP data so that they can receive data after processing, based on for example the entities determined by the processing engine. For example, client devices 230 in FIG. 2 may subscribe to the ESPE in computing environment 214. In another example, event subscription devices 1024a-c, described further with respect to FIG. 10, may also subscribe to the ESPE. The ESPE may determine or define how input data or event streams from network devices or other publishers (e.g., network devices 204-209 in FIG. 2) are transformed into meaningful output data to be consumed by subscribers, such as for example client devices 230 in FIG. 2.

FIG. 8 illustrates a block diagram including components of an Event Stream Processing Engine (ESPE), according to embodiments of the present technology. ESPE 800 may include one or more projects 802. A project may be described as a second-level container in an engine model managed by ESPE 800 where a thread pool size for the project may be defined by a user. Each project of the one or more projects 802 may include one or more continuous queries 804 that contain data flows, which are data transformations of incoming event streams. The one or more continuous queries 804 may include one or more source windows 806 and one or more derived windows 808.

The ESPE may receive streaming data over a period of time related to certain events, such as events or other data sensed by one or more network devices. The ESPE may perform operations associated with processing data created by the one or more devices. For example, the ESPE may receive data from the one or more network devices 204-209 shown in FIG. 2. As noted, the network devices may include sensors that sense different aspects of their environments, and may collect data over time based on those sensed observations. For example, the ESPE may be implemented within one or more of machines 220 and 240 shown in FIG. 2. The ESPE may be implemented within such a machine by an ESP application. An ESP application may embed an ESPE with its own dedicated thread pool or pools into its application space where the main application thread can do application-specific work and the ESPE processes event streams at least by creating an instance of a model into processing objects.

The engine container is the top-level container in a model that manages the resources of the one or more projects 802. In an illustrative embodiment, for example, there may be only one ESPE 800 for each instance of the ESP application, and ESPE 800 may have a unique engine name. Additionally, the one or more projects 802 may each have unique project names, and each query may have a unique continuous query name and begin with a uniquely named source window of the one or more source windows 806. ESPE 800 may or may not be persistent.

Continuous query modeling involves defining directed graphs of windows for event stream manipulation and transformation. A window in the context of event stream manipulation and transformation is a processing node in an event stream processing model. A window in a continuous query can perform aggregations, computations, pattern-matching, and other operations on data flowing through the window. A continuous query may be described as a directed graph of source, relational, pattern matching, and procedural windows. The one or more source windows 806 and the one or more derived windows 808 represent continuously executing queries that generate updates to a query result set as new event blocks stream through ESPE 800. A directed graph, for example, is a set of nodes connected by edges, where the edges have a direction associated with them.

An event object may be described as a packet of data accessible as a collection of fields, with at least one of the fields defined as a key or unique identifier (ID). The event object may be created using a variety of formats including binary, alphanumeric, XML, etc. Each event object may include one or more fields designated as a primary identifier (ID) for the event so ESPE 800 can support operation codes (opcodes) for events including insert, update, upsert, and delete. Upsert opcodes update the event if the key field already exists; otherwise, the event is inserted. For illustration, an event object may be a packed binary representation of a set of field values and include both metadata and field data associated with an event. The metadata may include an opcode indicating if the event represents an insert, update, delete, or upsert, a set of flags indicating if the event is a normal, partial-update, or a retention generated event from retention policy management, and a set of microsecond timestamps that can be used for latency measurements.

An event block object may be described as a grouping or package of event objects. An event stream may be described as a flow of event block objects. A continuous query of the one or more continuous queries 804 transforms a source event stream made up of streaming event block objects published into ESPE 800 into one or more output event streams using the one or more source windows 806 and the one or more derived windows 808. A continuous query can also be thought of as data flow modeling.

The one or more source windows 806 are at the top of the directed graph and have no windows feeding into them. Event streams are published into the one or more source windows 806, and from there, the event streams may be directed to the next set of connected windows as defined by the directed graph. The one or more derived windows 808 are all instantiated windows that are not source windows and that have other windows streaming events into them. The one or more derived windows 808 may perform computations or transformations on the incoming event streams. The one or more derived windows 808 transform event streams based on the window type (that is operators such as join, filter, compute, aggregate, copy, pattern match, procedural, union, etc.) and window settings. As event streams are published into ESPE 800, they are continuously queried, and the resulting sets of derived windows in these queries are continuously updated.

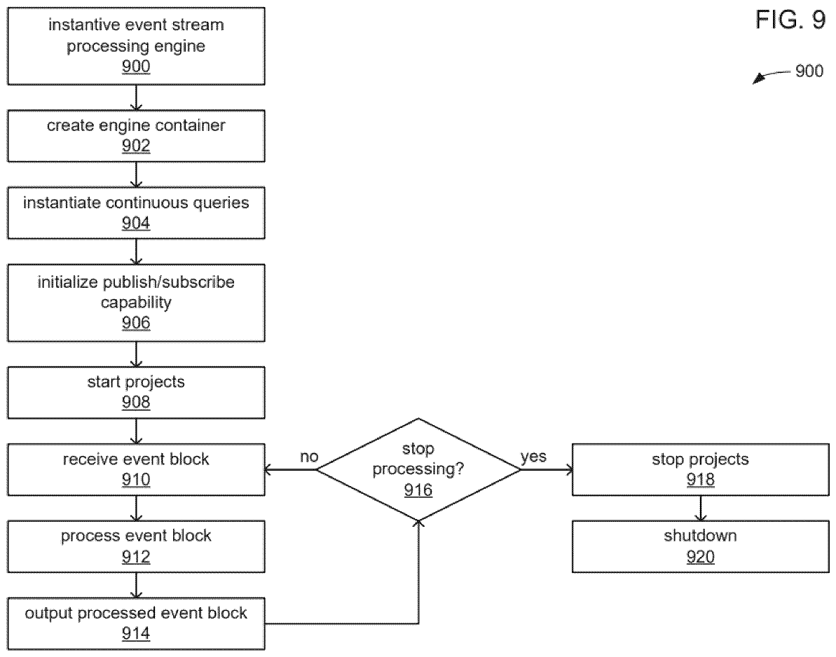

FIG. 9 illustrates a flow chart showing an example process including operations performed by an event stream processing engine, according to some embodiments of the present technology. As noted, the ESPE 800 (or an associated ESP application) defines how input event streams are transformed into meaningful output event streams. More specifically, the ESP application may define how input event streams from publishers (e.g., network devices providing sensed data) are transformed into meaningful output event streams consumed by subscribers (e.g., a data analytics project being executed by a machine or set of machines).

Within the application, a user may interact with one or more user interface windows presented to the user in a display under control of the ESPE independently or through a browser application in an order selectable by the user. For example, a user may execute an ESP application, which causes presentation of a first user interface window, which may include a plurality of menus and selectors such as drop down menus, buttons, text boxes, hyperlinks, etc. associated with the ESP application as understood by a person of skill in the art. As further understood by a person of skill in the art, various operations may be performed in parallel, for example, using a plurality of threads.

At operation 900, an ESP application may define and start an ESPE, thereby instantiating an ESPE at a device, such as machine 220 and/or 240. In an operation 902, the engine container is created. For illustration, ESPE 800 may be instantiated using a function call that specifies the engine container as a manager for the model.

In an operation 904, the one or more continuous queries 804 are instantiated by ESPE 800 as a model. The one or more continuous queries 804 may be instantiated with a dedicated thread pool or pools that generate updates as new events stream through ESPE 800. For illustration, the one or more continuous queries 804 may be created to model business processing logic within ESPE 800, to predict events within ESPE 800, to model a physical system within ESPE 800, to predict the physical system state within ESPE 800, etc. For example, as noted, ESPE 800 may be used to support sensor data monitoring and management (e.g., sensing may include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, or electrical current, etc.).

ESPE 800 may analyze and process events in motion or “event streams.” Instead of storing data and running queries against the stored data, ESPE 800 may store queries and stream data through them to allow continuous analysis of data as it is received. The one or more source windows 806 and the one or more derived windows 808 may be created based on the relational, pattern matching, and procedural algorithms that transform the input event streams into the output event streams to model, simulate, score, test, predict, etc. based on the continuous query model defined and application to the streamed data.

In an operation 906, a publish/subscribe (pub/sub) capability is initialized for ESPE 800. In an illustrative embodiment, a pub/sub capability is initialized for each project of the one or more projects 802. To initialize and enable pub/sub capability for ESPE 800, a port number may be provided. Pub/sub clients can use a host name of an ESP device running the ESPE and the port number to establish pub/sub connections to ESPE 800.

FIG. 10 illustrates an ESP system 1000 interfacing between publishing device 1022 and event subscribing devices 1024a-c, according to embodiments of the present technology. ESP system 1000 may include ESP device or subsystem 851, event publishing device 1022, an event subscribing device A 1024a, an event subscribing device B 1024b, and an event subscribing device C 1024c. Input event streams are output to ESP device 851 by publishing device 1022. In alternative embodiments, the input event streams may be created by a plurality of publishing devices. The plurality of publishing devices further may publish event streams to other ESP devices. The one or more continuous queries instantiated by ESPE 800 may analyze and process the input event streams to form output event streams output to event subscribing device A 1024a, event subscribing device B 1024b, and event subscribing device C 1024c. ESP system 1000 may include a greater or a fewer number of event subscribing devices of event subscribing devices.

Publish-subscribe is a message-oriented interaction paradigm based on indirect addressing. Processed data recipients specify their interest in receiving information from ESPE 800 by subscribing to specific classes of events, while information sources publish events to ESPE 800 without directly addressing the receiving parties. ESPE 800 coordinates the interactions and processes the data. In some cases, the data source receives confirmation that the published information has been received by a data recipient.

A publish/subscribe API may be described as a library that enables an event publisher, such as publishing device 1022, to publish event streams into ESPE 800 or an event subscriber, such as event subscribing device A 1024a, event subscribing device B 1024b, and event subscribing device C 1024c, to subscribe to event streams from ESPE 800. For illustration, one or more publish/subscribe APIs may be defined. Using the publish/subscribe API, an event publishing application may publish event streams into a running event stream processor project source window of ESPE 800, and the event subscription application may subscribe to an event stream processor project source window of ESPE 800.

The publish/subscribe API provides cross-platform connectivity and endianness compatibility between ESP application and other networked applications, such as event publishing applications instantiated at publishing device 1022, and event subscription applications instantiated at one or more of event subscribing device A 1024a, event subscribing device B 1024b, and event subscribing device C 1024c.

Referring back to FIG. 9, operation 906 initializes the publish/subscribe capability of ESPE 800. In an operation 908, the one or more projects 802 are started. The one or more started projects may run in the background on an ESP device. In an operation 910, an event block object is received from one or more computing device of the event publishing device 1022.

ESP subsystem 800 may include a publishing client 1002, ESPE 800, a subscribing client A 1004, a subscribing client B 1006, and a subscribing client C 1008. Publishing client 1002 may be started by an event publishing application executing at publishing device 1022 using the publish/subscribe API. Subscribing client A 1004 may be started by an event subscription application A, executing at event subscribing device A 1024a using the publish/subscribe API. Subscribing client B 1006 may be started by an event subscription application B executing at event subscribing device B 1024b using the publish/subscribe API. Subscribing client C 1008 may be started by an event subscription application C executing at event subscribing device C 1024c using the publish/subscribe API.

An event block object containing one or more event objects is injected into a source window of the one or more source windows 806 from an instance of an event publishing application on event publishing device 1022. The event block object may be generated, for example, by the event publishing application and may be received by publishing client 1002. A unique ID may be maintained as the event block object is passed between the one or more source windows 806 and/or the one or more derived windows 808 of ESPE 800, and to subscribing client A 1004, subscribing client B 1006, and subscribing client C 1008 and to event subscription device A 1024a, event subscription device B 1024b, and event subscription device C 1024c. Publishing client 1002 may further generate and include a unique embedded transaction ID in the event block object as the event block object is processed by a continuous query, as well as the unique ID that publishing device 1022 assigned to the event block object.

In an operation 912, the event block object is processed through the one or more continuous queries 804. In an operation 914, the processed event block object is output to one or more computing devices of the event subscribing devices 1024a-c. For example, subscribing client A 1004, subscribing client B 1006, and subscribing client C 1008 may send the received event block object to event subscription device A 1024a, event subscription device B 1024b, and event subscription device C 1024c, respectively.

ESPE 800 maintains the event block containership aspect of the received event blocks from when the event block is published into a source window and works its way through the directed graph defined by the one or more continuous queries 804 with the various event translations before being output to subscribers. Subscribers can correlate a group of subscribed events back to a group of published events by comparing the unique ID of the event block object that a publisher, such as publishing device 1022, attached to the event block object with the event block ID received by the subscriber.

In an operation 916, a determination is made concerning whether or not processing is stopped. If processing is not stopped, processing continues in operation 910 to continue receiving the one or more event streams containing event block objects from the, for example, one or more network devices. If processing is stopped, processing continues in an operation 918. In operation 918, the started projects are stopped. In operation 920, the ESPE is shutdown.

As noted, in some embodiments, big data is processed for an analytics project after the data is received and stored. In other embodiments, distributed applications process continuously flowing data in real-time from distributed sources by applying queries to the data before distributing the data to geographically distributed recipients. As noted, an event stream processing engine (ESPE) may continuously apply the queries to the data as it is received and determines which entities receive the processed data. This allows for large amounts of data being received and/or collected in a variety of environments to be processed and distributed in real time. For example, as shown with respect to FIG. 2, data may be collected from network devices that may include devices within the internet of things, such as devices within a home automation network. However, such data may be collected from a variety of different resources in a variety of different environments. In any such situation, embodiments of the present technology allow for real-time processing of such data.

Aspects of the current disclosure provide technical solutions to technical problems, such as computing problems that arise when an ESP device fails which results in a complete service interruption and potentially significant data loss. The data loss can be catastrophic when the streamed data is supporting mission critical operations such as those in support of an ongoing manufacturing or drilling operation. An embodiment of an ESP system achieves a rapid and seamless failover of ESPE running at the plurality of ESP devices without service interruption or data loss, thus significantly improving the reliability of an operational system that relies on the live or real-time processing of the data streams. The event publishing systems, the event subscribing systems, and each ESPE not executing at a failed ESP device are not aware of or effected by the failed ESP device. The ESP system may include thousands of event publishing systems and event subscribing systems. The ESP system keeps the failover logic and awareness within the boundaries of out-messaging network connector and out-messaging network device.

In one example embodiment, a system is provided to support a failover when event stream processing (ESP) event blocks. The system includes, but is not limited to, an out-messaging network device and a computing device. The computing device includes, but is not limited to, a processor and a computer-readable medium operably coupled to the processor. The processor is configured to execute an ESP engine (ESPE). The computer-readable medium has instructions stored thereon that, when executed by the processor, cause the computing device to support the failover. An event block object is received from the ESPE that includes a unique identifier. A first status of the computing device as active or standby is determined. When the first status is active, a second status of the computing device as newly active or not newly active is determined. Newly active is determined when the computing device is switched from a standby status to an active status. When the second status is newly active, a last published event block object identifier that uniquely identifies a last published event block object is determined. A next event block object is selected from a non-transitory computer-readable medium accessible by the computing device. The next event block object has an event block object identifier that is greater than the determined last published event block object identifier. The selected next event block object is published to an out-messaging network device. When the second status of the computing device is not newly active, the received event block object is published to the out-messaging network device. When the first status of the computing device is standby, the received event block object is stored in the non-transitory computer-readable medium.

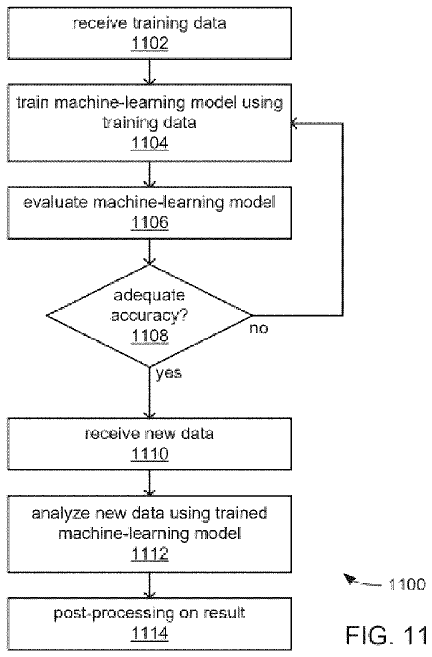

FIG. 11 is a flow chart of an example of a process for generating and using a machine-learning model according to some aspects. Machine learning is a branch of artificial intelligence that relates to mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusterers, such as k-means clusterers, mean-shift clusterers, and spectral clusterers; (v) factorizers, such as factorization machines, principal component analyzers and kernel principal component analyzers; and (vi) ensembles or other combinations of machine-learning models. In some examples, neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these. Other networks may include transformers, large language models (LLMs), and agents for LLMs.

Different machine-learning models may be used interchangeably to perform a task. Examples of tasks that can be performed at least partially using machine-learning models include various types of scoring; bioinformatics; cheminformatics; software engineering; fraud detection; customer segmentation; generating online recommendations; adaptive websites; determining customer lifetime value; search engines; placing advertisements in real time or near real time; classifying DNA sequences; affective computing; performing natural language processing and understanding; object recognition and computer vision; robotic locomotion; playing games; optimization and metaheuristics; detecting network intrusions; medical diagnosis and monitoring; or predicting when an asset, such as a machine, will need maintenance.

Any number and combination of tools can be used to create machine-learning models. Examples of tools for creating and managing machine-learning models can include SAS® Enterprise Miner, SAS® Rapid Predictive Modeler, and SAS® Model Manager, SAS® Cloud Analytic Services (CAS), SAS Viya® of all which are by SAS Institute Inc. of Cary, North Carolina.

Machine-learning models can be constructed through an at least partially automated (e.g., with little or no human involvement) process called training. During training, input data can be iteratively supplied to a machine-learning model to enable the machine-learning model to identify patterns related to the input data or to identify relationships between the input data and output data. With training, the machine-learning model can be transformed from an untrained state to a trained state. Input data can be split into one or more training sets and one or more validation sets, and the training process may be repeated multiple times. The splitting may follow a k-fold cross-validation rule, a leave-one-out-rule, a leave-p-out rule, or a holdout rule. An overview of training and using a machine-learning model is described below with respect to the flow chart of FIG. 11.

In block 1102, training data is received. In some examples, the training data is received from a remote database or a local database, constructed from various subsets of data, or input by a user. The training data can be used in its raw form for training a machine-learning model or pre-processed into another form, which can then be used for training the machine-learning model. For example, the raw form of the training data can be smoothed, truncated, aggregated, clustered, or otherwise manipulated into another form, which can then be used for training the machine-learning model.

In block 1104, a machine-learning model is trained using the training data. The machine-learning model can be trained in a supervised, unsupervised, or semi-supervised manner. In supervised training, each input in the training data is correlated to a desired output. This desired output may be a scalar, a vector, or a different type of data structure such as text or an image. This may enable the machine-learning model to learn a mapping between the inputs and desired outputs. In unsupervised training, the training data includes inputs, but not desired outputs, so that the machine-learning model has to find structure in the inputs on its own. In semi-supervised training, only some of the inputs in the training data are correlated to desired outputs.

In block 1106, the machine-learning model is evaluated. For example, an evaluation dataset can be obtained, for example, via user input or from a database. The evaluation dataset can include inputs correlated to desired outputs. The inputs can be provided to the machine-learning model and the outputs from the machine-learning model can be compared to the desired outputs. If the outputs from the machine-learning model closely correspond with the desired outputs, the machine-learning model may have a high degree of accuracy. For example, if 90% or more of the outputs from the machine-learning model are the same as the desired outputs in the evaluation dataset, the machine-learning model may have a high degree of accuracy. Otherwise, the machine-learning model may have a low degree of accuracy. The 90% number is an example only. A realistic and desirable accuracy percentage is dependent on the problem and the data.

In some examples, if, at 1108, the machine-learning model has an inadequate degree of accuracy for a particular task, the process can return to block 1104, where the machine-learning model can be further trained using additional training data or otherwise modified to improve accuracy. However, if, at 1108, the machine-learning model has an adequate degree of accuracy for the particular task, the process can continue to block 1110.

In block 1110, new data is received. In some examples, the new data is received from a remote database or a local database, constructed from various subsets of data, or input by a user. The new data may be unknown to the machine-learning model. For example, the machine-learning model may not have previously processed or analyzed the new data.

In block 1112, the trained machine-learning model is used to analyze the new data and provide a result. For example, the new data can be provided as input to the trained machine-learning model. The trained machine-learning model can analyze the new data and provide a result that includes a classification of the new data into a particular class, a clustering of the new data into a particular group, a prediction based on the new data, or any combination of these.

In block 1114, the result is post-processed. For example, the result can be added to, multiplied with, or otherwise combined with other data as part of a job. As another example, the result can be transformed from a first format, such as a time series format, into another format, such as a count series format. Any number and combination of operations can be performed on the result during post-processing.

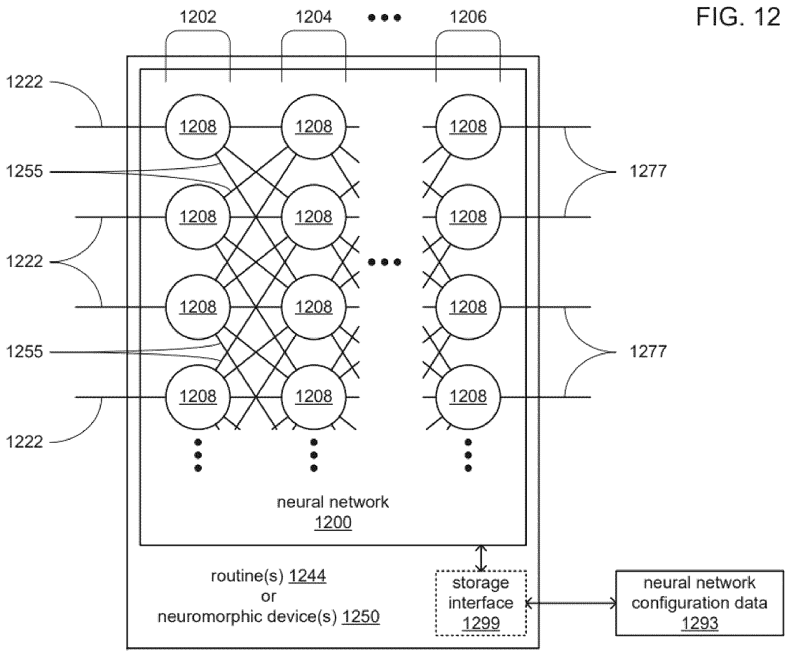

A more specific example of a machine-learning model is the neural network 1200 shown in FIG. 12. The neural network 1200 is represented as multiple layers of neurons 1208 that can exchange data between one another via connections 1255 that may be selectively instantiated thereamong. The layers include an input layer 1202 for receiving input data provided at inputs 1222, one or more hidden layers 1204, and an output layer 1206 for providing a result at outputs 1277. The hidden layer(s) 1204 are referred to as hidden because they may not be directly observable or have their inputs or outputs directly accessible during the normal functioning of the neural network 1200. Although the neural network 1200 is shown as having a specific number of layers and neurons for exemplary purposes, the neural network 1200 can have any number and combination of layers, and each layer can have any number and combination of neurons.

The neurons 1208 and connections 1255 thereamong may have numeric weights, which can be tuned during training of the neural network 1200. For example, training data can be provided to at least the inputs 1222 to the input layer 1202 of the neural network 1200, and the neural network 1200 can use the training data to tune one or more numeric weights of the neural network 1200. In some examples, the neural network 1200 can be trained using backpropagation. Backpropagation can include determining a gradient of a particular numeric weight based on a difference between an actual output of the neural network 1200 at the outputs 1277 and a desired output of the neural network 1200. Based on the gradient, one or more numeric weights of the neural network 1200 can be updated to reduce the difference therebetween, thereby increasing the accuracy of the neural network 1200. This process can be repeated multiple times to train the neural network 1200. For example, this process can be repeated hundreds or thousands of times to train the neural network 1200.

In some examples, the neural network 1200 is a feed-forward neural network. In a feed-forward neural network, the connections 1255 are instantiated and/or weighted so that every neuron 1208 only propagates an output value to a subsequent layer of the neural network 1200. For example, data may only move one direction (forward) from one neuron 1208 to the next neuron 1208 in a feed-forward neural network. Such a “forward” direction may be defined as proceeding from the input layer 1202 through the one or more hidden layers 1204, and toward the output layer 1206.

In other examples, the neural network 1200 may be a recurrent neural network. A recurrent neural network can include one or more feedback loops among the connections 1255, thereby allowing data to propagate in both forward and backward through the neural network 1200. Such a “backward” direction may be defined as proceeding in the opposite direction of forward, such as from the output layer 1206 through the one or more hidden layers 1204, and toward the input layer 1202. This can allow for information to persist within the recurrent neural network. For example, a recurrent neural network can determine an output based at least partially on information that the recurrent neural network has seen before, giving the recurrent neural network the ability to use previous input to inform the output.

In some examples, the neural network 1200 operates by receiving a vector of numbers from one layer; transforming the vector of numbers into a new vector of numbers using a matrix of numeric weights, a nonlinearity, or both; and providing the new vector of numbers to a subsequent layer (“subsequent” in the sense of moving “forward”) of the neural network 1200. Each subsequent layer of the neural network 1200 can repeat this process until the neural network 1200 outputs a final result at the outputs 1277 of the output layer 1206. For example, the neural network 1200 can receive a vector of numbers at the inputs 1222 of the input layer 1202. The neural network 1200 can multiply the vector of numbers by a matrix of numeric weights to determine a weighted vector. The matrix of numeric weights can be tuned during the training of the neural network 1200. The neural network 1200 can transform the weighted vector using a nonlinearity, such as a sigmoid tangent or the hyperbolic tangent. In some examples, the nonlinearity can include a rectified linear unit, which can be expressed using the equation y=max(x, 0) where y is the output and x is an input value from the weighted vector. The transformed output can be supplied to a subsequent layer (e.g., a hidden layer 1204) of the neural network 1200. The subsequent layer of the neural network 1200 can receive the transformed output, multiply the transformed output by a matrix of numeric weights and a nonlinearity, and provide the result to yet another layer of the neural network 1200 (e.g., another, subsequent, hidden layer 1204). This process continues until the neural network 1200 outputs a final result at the outputs 1277 of the output layer 1206.

As also depicted in FIG. 12, the neural network 1200 may be implemented either through the execution of the instructions of one or more routines 1244 by central processing units (CPUs), or through the use of one or more neuromorphic devices 1250 that incorporate a set of memristors (or other similar components) that each function to implement one of the neurons 1208 in hardware. Where multiple neuromorphic devices 1250 are used, they may be interconnected in a depth-wise manner to enable implementing neural networks with greater quantities of layers, and/or in a width-wise manner to enable implementing neural networks having greater quantities of neurons 1208 per layer.

The neuromorphic device 1250 may incorporate a storage interface 1299 by which neural network configuration data 1293 that is descriptive of various parameters and hyper parameters of the neural network 1200 may be stored and/or retrieved. More specifically, the neural network configuration data 1293 may include such parameters as weighting and/or biasing values derived through the training of the neural network 1200, as has been described. Alternatively or additionally, the neural network configuration data 1293 may include such hyperparameters as the manner in which the neurons 1208 are to be interconnected (e.g., feed-forward or recurrent), the trigger function to be implemented within the neurons 1208, the quantity of layers and/or the overall quantity of the neurons 1208. The neural network configuration data 1293 may provide such information for more than one neuromorphic device 1250 where multiple ones have been interconnected to support larger neural networks.

Other examples of the present disclosure may include any number and combination of machine-learning models having any number and combination of characteristics. The machine-learning model(s) can be trained in a supervised, semi-supervised, or unsupervised manner, or any combination of these. The machine-learning model(s) can be implemented using a single computing device or multiple computing devices, such as the communications grid computing system 400 discussed above.

Implementing some examples of the present disclosure at least in part by using machine-learning models can reduce the total number of processing iterations, time, memory, electrical power, or any combination of these consumed by a computing device when analyzing data. For example, a neural network may more readily identify patterns in data than other approaches. This may enable the neural network and/or a transformer model to analyze the data using fewer processing cycles and less memory than other approaches, while obtaining a similar or greater level of accuracy.

Some machine-learning approaches may be more efficiently and speedily executed and processed with machine-learning specific processors (e.g., not a generic CPU). Such processors may also provide energy savings when compared to generic CPUs. For example, some of these processors can include a graphical processing unit (GPU), an application-specific integrated circuit (ASIC), a field-programmable gate array (FPGA), an artificial intelligence (AI) accelerator, a neural computing core, a neural computing engine, a neural processing unit, a purpose-built chip architecture for deep learning, and/or some other machine-learning specific processor that implements a machine learning approach or one or more neural networks using semiconductor (e.g., silicon (Si), gallium arsenide(GaAs)) devices. These processors may also be employed in heterogeneous computing architectures with a number of and/or a variety of different types of cores, engines, nodes, and/or layers to achieve various energy efficiencies, processing speed improvements, data communication speed improvements, and/or data efficiency targets and improvements throughout various parts of the system when compared to a homogeneous computing architecture that employs CPUs for general purpose computing.

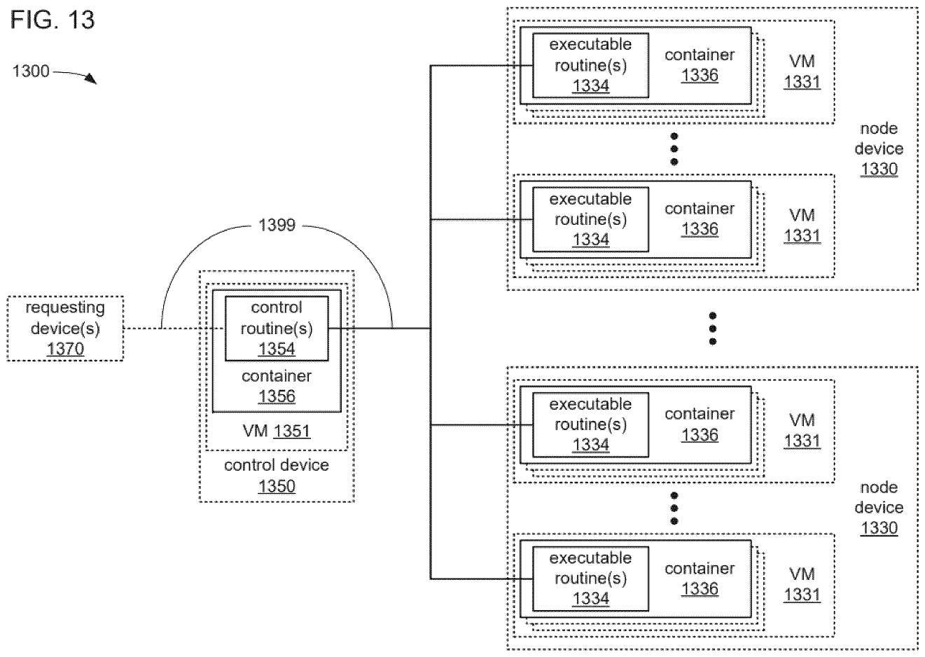

FIG. 13 illustrates various aspects of the use of containers 1336 as a mechanism to allocate processing, storage and/or other resources of a processing system 1300 to the performance of various analyses. More specifically, in a processing system 1300 that includes one or more node devices 1330 (e.g., the aforedescribed grid system 400), the processing, storage and/or other resources of each node device 1330 may be allocated through the instantiation and/or maintenance of multiple containers 1336 within the node devices 1330 to support the performance(s) of one or more analyses. As each container 1336 is instantiated, predetermined amounts of processing, storage and/or other resources may be allocated thereto as part of creating an execution environment therein in which one or more executable routines 1334 may be executed to cause the performance of part or all of each analysis that is requested to be performed.

It may be that at least a subset of the containers 1336 are each allocated a similar combination and amounts of resources so that each is of a similar configuration with a similar range of capabilities, and therefore, are interchangeable. This may be done in embodiments in which it is desired to have at least such a subset of the containers 1336 already instantiated prior to the receipt of requests to perform analyses, and thus, prior to the specific resource requirements of each of those analyses being known.

Alternatively or additionally, it may be that at least a subset of the containers 1336 are not instantiated until after the processing system 1300 receives requests to perform analyses where each request may include indications of the resources required for one of those analyses. Such information concerning resource requirements may then be used to guide the selection of resources and/or the amount of each resource allocated to each such container 1336. As a result, it may be that one or more of the containers 1336 are caused to have somewhat specialized configurations such that there may be differing types of containers to support the performance of different analyses and/or different portions of analyses.

It may be that the entirety of the logic of a requested analysis is implemented within a single executable routine 1334. In such embodiments, it may be that the entirety of that analysis is performed within a single container 1336 as that single executable routine 1334 is executed therein. However, it may be that such a single executable routine 1334, when executed, is at least intended to cause the instantiation of multiple instances of itself that are intended to be executed at least partially in parallel. This may result in the execution of multiple instances of such an executable routine 1334 within a single container 1336 and/or across multiple containers 1336.

Alternatively or additionally, it may be that the logic of a requested analysis is implemented with multiple differing executable routines 1334. In such embodiments, it may be that at least a subset of such differing executable routines 1334 are executed within a single container 1336. However, it may be that the execution of at least a subset of such differing executable routines 1334 is distributed across multiple containers 1336.

Where an executable routine 1334 of an analysis is under development, and/or is under scrutiny to confirm its functionality, it may be that the container 1336 within which that executable routine 1334 is to be executed is additionally configured assist in limiting and/or monitoring aspects of the functionality of that executable routine 1334. More specifically, the execution environment provided by such a container 1336 may be configured to enforce limitations on accesses that are allowed to be made to memory and/or I/O addresses to control what storage locations and/or I/O devices may be accessible to that executable routine 1334. Such limitations may be derived based on comments within the programming code of the executable routine 1334 and/or other information that describes what functionality the executable routine 1334 is expected to have, including what memory and/or I/O accesses are expected to be made when the executable routine 1334 is executed. Then, when the executable routine 1334 is executed within such a container 1336, the accesses that are attempted to be made by the executable routine 1334 may be monitored to identify any behavior that deviates from what is expected.

Where the possibility exists that different executable routines 1334 may be written in different programming languages, it may be that different subsets of containers 1336 are configured to support different programming languages. In such embodiments, it may be that each executable routine 1334 is analyzed to identify what programming language it is written in, and then what container 1336 is assigned to support the execution of that executable routine 1334 may be at least partially based on the identified programming language. Where the possibility exists that a single requested analysis may be based on the execution of multiple executable routines 1334 that may each be written in a different programming language, it may be that at least a subset of the containers 1336 are configured to support the performance of various data structure and/or data format conversion operations to enable a data object output by one executable routine 1334 written in one programming language to be accepted as an input to another executable routine 1334 written in another programming language.

As depicted, at least a subset of the containers 1336 may be instantiated within one or more VMs 1331 that may be instantiated within one or more node devices 1330. Thus, in some embodiments, it may be that the processing, storage and/or other resources of at least one node device 1330 may be partially allocated through the instantiation of one or more VMs 1331, and then in turn, may be further allocated within at least one VM 1331 through the instantiation of one or more containers 1336.

In some embodiments, it may be that such a nested allocation of resources may be carried out to affect an allocation of resources based on two differing criteria. By way of example, it may be that the instantiation of VMs 1331 is used to allocate the resources of a node device 1330 to multiple users or groups of users in accordance with any of a variety of service agreements by which amounts of processing, storage and/or other resources are paid for each such user or group of users. Then, within each VM 1331 or set of VMs 1331 that is allocated to a particular user or group of users, containers 1336 may be allocated to distribute the resources allocated to each VM 1331 among various analyses that are requested to be performed by that particular user or group of users.

As depicted, where the processing system 1300 includes more than one node device 1330, the processing system 1300 may also include at least one control device 1350 within which one or more control routines 1354 may be executed to control various aspects of the use of the node device(s) 1330 to perform requested analyses. By way of example, it may be that at least one control routine 1354 implements logic to control the allocation of the processing, storage and/or other resources of each node device 1300 to each VM 1331 and/or container 1336 that is instantiated therein. Thus, it may be the control device(s) 1350 that effects a nested allocation of resources, such as the aforedescribed example allocation of resources based on two differing criteria.

As also depicted, the processing system 1300 may also include one or more distinct requesting devices 1370 from which requests to perform analyses may be received by the control device(s) 1350. Thus, and by way of example, it may be that at least one control routine 1354 implements logic to monitor for the receipt of requests from authorized users and/or groups of users for various analyses to be performed using the processing, storage and/or other resources of the node device(s) 1330 of the processing system 1300. The control device(s) 1350 may receive indications of the availability of resources, the status of the performances of analyses that are already underway, and/or still other status information from the node device(s) 1330 in response to polling, at a recurring interval of time, and/or in response to the occurrence of various preselected events. More specifically, the control device(s) 1350 may receive indications of status for each container 1336, each VM 1331 and/or each node device 1330. At least one control routine 1354 may implement logic that may use such information to select container(s) 1336, VM(s) 1331 and/or node device(s) 1330 that are to be used in the execution of the executable routine(s) 1334 associated with each requested analysis.

As further depicted, in some embodiments, the one or more control routines 1354 may be executed within one or more containers 1356 and/or within one or more VMs 1351 that may be instantiated within the one or more control devices 1350. It may be that multiple instances of one or more varieties of control routine 1354 may be executed within separate containers 1356, within separate VMs 1351 and/or within separate control devices 1350 to better enable parallelized control over parallel performances of requested analyses, to provide improved redundancy against failures for such control functions, and/or to separate differing ones of the control routines 1354 that perform different functions. By way of example, it may be that multiple instances of a first variety of control routine 1354 that communicate with the requesting device(s) 1370 are executed in a first set of containers 1356 instantiated within a first VM 1351, while multiple instances of a second variety of control routine 1354 that control the allocation of resources of the node device(s) 1330 are executed in a second set of containers 1356 instantiated within a second VM 1351. It may be that the control of the allocation of resources for performing requested analyses may include deriving an order of performance of portions of each requested analysis based on such factors as data dependencies thereamong, as well as allocating the use of containers 1336 in a manner that effectuates such a derived order of performance.

Where multiple instances of control routine 1354 are used to control the allocation of resources for performing requested analyses, such as the assignment of individual ones of the containers 1336 to be used in executing executable routines 1334 of each of multiple requested analyses, it may be that each requested analysis is assigned to be controlled by just one of the instances of control routine 1354. This may be done as part of treating each requested analysis as one or more “ACID transactions” that each have the four properties of atomicity, consistency, isolation and durability such that a single instance of control routine 1354 is given full control over the entirety of each such transaction to better ensure that either all of each such transaction is either entirely performed or is entirely not performed. As will be familiar to those skilled in the art, allowing partial performances to occur may cause cache incoherencies and/or data corruption issues.

As additionally depicted, the control device(s) 1350 may communicate with the requesting device(s) 1370 and with the node device(s) 1330 through portions of a network 1399 extending thereamong. Again, such a network as the depicted network 1399 may be based on any of a variety of wired and/or wireless technologies, and may employ any of a variety of protocols by which commands, status, data and/or still other varieties of information may be exchanged. It may be that one or more instances of a control routine 1354 cause the instantiation and maintenance of a web portal or other variety of portal that is based on any of a variety of communication protocols, etc. (e.g., a restful API). Through such a portal, requests for the performance of various analyses may be received from requesting device(s) 1370, and/or the results of such requested analyses may be provided thereto. Alternatively or additionally, it may be that one or more instances of a control routine 1354 cause the instantiation of and maintenance of a message passing interface and/or message queues. Through such an interface and/or queues, individual containers 1336 may each be assigned to execute at least one executable routine 1334 associated with a requested analysis to cause the performance of at least a portion of that analysis.

Although not specifically depicted, it may be that at least one control routine 1354 may include logic to implement a form of management of the containers 1336 based on the Kubernetes container management platform promulgated by Cloud Native Computing Foundation of San Francisco, CA, USA. In such embodiments, containers 1336 in which executable routines 1334 of requested analyses may be instantiated within “pods” (not specifically shown) in which other containers may also be instantiated for the execution of other supporting routines. Such supporting routines may cooperate with control routine(s) 1354 to implement a communications protocol with the control device(s) 1350 via the network 1399 (e.g., a message passing interface, one or more message queues, etc.). Alternatively or additionally, such supporting routines may serve to provide access to one or more storage repositories (not specifically shown) in which at least data objects may be stored for use in performing the requested analyses.

The present disclosure is directed to change point detection in streaming data using ESP and particularly to online change point detection. An overview of ESP is provided in FIGS. 8-10. Streaming data refers to data that is continuously generated, often in real-time, and transmitted in a steady flow. In some embodiments, the streaming data may include time series data. Time series data may include data that is characterized by sequential observations recorded at regular time intervals. Specifically, time series data may include an ordered collection of data points on a single subject collected over a period of time at regular time intervals and indexed in chronological order. Time series data is widely used for tracking patterns, trends, or changes over time. Change point detection involves identifying moments when the statistical properties of the streaming data shift significantly. In other words, change point detection may involve detecting change points, which are moments when the streaming data significantly deviates from previous patterns. For example, sudden jump in temperature, shift in stock prices, equipment malfunction, new patterns of user activity, environment shifts, etc. may also be associated with a change point in the streaming data. Seasonal changes (e.g., increase in ornament sale during Christmas time) may also be reflected by change points in the streaming data. Changes in sensor readings (e.g., of a heating, ventilation, and air conditioning (HVAC) system) such as changes in temperature, pressure, airflow, energy consumption etc. may be indicated by change points. In some embodiments, change point detection may be used for monitoring and detecting distributional shifts in Internet of Things (IoT) sensor data. In some embodiments, change point detection may be used in medical condition monitoring (e.g., electrocardiogram signals), audio segmentation, real-time monitoring of systems, etc. Change point detection may have other or additional applications.

Change point detection in time series data may involve identifying points in time when the statistical properties of a sequence of observations change. In some embodiments, these change points may occur in the mean, variance, correlation structure, or other properties of the time series data. Change points may be indicative in potential underlying shifts in the behavior of the systems generating the streaming data (e.g., the time series data). Thus, detecting change points may help understand shifts in trends, monitor for anomalies, and make informed decisions in various fields such as energy, medicine, climatology, and manufacturing, etc.

Change point detection may be offline change point detection or online change point detection. Offline change point detection involves identifying change points in the streaming data (e.g., the time series data) after all the streaming data has been collected. Thus, offline change point detection is not real-time and cannot be used to understand shifts in behavior of underlying systems in real-time. If real-time detection is critical (e.g., in fraud detection, critical machinery failure, etc.), offline change point detection may fall short. In contrast, online change point detection involves identifying change points in the streaming data (e.g., the time series data) as the streaming data is received at the ESP in real-time (or substantial real-time). Online change point detection provides real-time or substantial real-time monitoring (e.g., detecting changes while data is still being collected), sequential processing (e.g., evaluating each data point immediately without waiting for future data points), and low latency (e.g., quick responses). The present disclosure is directed to online change point detection. As used herein, “real-time” may refer to the immediate or near-immediate processing and response to streaming data.

In some instances, online change point detection may be based on statistical algorithms or machine learning algorithms. In general, online change point detection algorithms may be classified as parametric (distributional) or non-parametric (or distribution-free) methods. Parametric methods may be used when the distributional assumptions for the underlying data are more or less reasonably specified. However, the non-parametric methods may gain robustness when the data distributions are not easy to identify using parametric models. The present disclosure is directed to a non-parametric method for change point detection.

Conventional non-parametric methods use a sliding window, usually of a fixed length, to store streaming data for detecting change points. A sliding window may be considered a pre-defined sized segment of data. For example, if a fixed sliding window is used (e.g., having a fixed size of X number of data points), the sliding window may be configured to store X number of data points. In some embodiments, the sliding window may be configured to “slide” or update data as new data comes in. For example, in some embodiments, the sliding window may be configured to update its contents by deleting old data points and replacing the deleted data points with more recent data points. Existing techniques that rely on sliding windows for change point detection aim to keep the size of the sliding window as small as possible to minimize computational costs and reduce memory consumption. However, reducing the size of the sliding window comes with a reduction in the statistical performance of the underlying change point algorithm. Thus, existing change point detection algorithms that rely on sliding windows have to compromise either on statistical performance or computational costs/resource utilization.

In some embodiments, computational cost/resource utilization may be shown using a time complexity metric and a memory complexity metric using the Big O notation. For example, Table 1 below shows how the time complexity and memory complexity of state-of-the-art conventional approaches compares with the proposed approach:

TABLE 1

| Approach | Time complexity | Memory Complexity |
|---|---|---|
| A. Lall, “Data streaming | O(\sqrt{n} log n) | O(\sqrt{n} log n) |
| algorithms for the | | |
| Kolmogorov-Smirnov test”, | | |
| Proceedings of the 2015 | | |
| IEEE International | | |
| Conference on Big Data | | |
| (Big Data), in: BIG | | |
| DATA ′15, IEEE Computer | | |
| Society, USA, 2015, | | |
| pp. 95-104 | | |
| Denis dos Reis, Peter Flach, | O(n log n) | O(n) |
| Stan Matwin, Gustavo | | |
| Batista, “Fast unsupervised | | |
| online drift detection using | | |
| incremental Kolmogorov- | | |
| Smirnov test,” Proceedings | | |
| of the 22nd ACM SIGKDD | | |
| International Conference on | | |
| Knowledge Discovery and | | |
| Data Mining, in: KDD ′16, | | |
| Association for Computing | | |
| Machinery, New York, NY, | | |
| USA, 2016, pp. 1545-1554 | | |
| H. D. Nguyen, “A stream- | O(nm) | O(m) |
| suitable Kolmogorov- | | |
| Smirnov-type test for big | | |
| data analysis,” 2017, | | |
| arXiv: 1704.03721 | | |
| Charles Masson, Jee E. Rim, | O(nm) | O(m) |
| Homin K. Lee, “DDsketch: | | |
| A fast and fully-mergeable | | |
| quantile sketch with | | |
| relative-error guarantees,” | | |
| Proc. VLDB Endow. 12 (12) | | |
| (2019) 2195-2205 | | |
| Proposed Approach | O(m) | O(m) |

In Table 1 above, n is the number of observations in a sliding window and m is a number of bins in a damped histogram. As seen from Table 1 above, the proposed approach has a time complexity and a memory complexity less than the other conventional approaches, indicating that the proposed approach is faster and consumes less memory than the conventional approaches.

Other non-parametric methods rely on kernel-based non-parametric statistics. While these kernel-based approaches are distribution-free and more robust, these kernel-based approaches exhibit O(n_{w}²) computational complexity for a sliding window with n, samples. Some non-parametric methods attempt to reduce the computational complexity associated with the kernel-based approaches by using a B-test method, which has a computational complexity O(B²) where the sliding window is sub-sampled into N blocks of size B. While the B-test method has constant computational complexity with time, large sliding window sizes n_{w}=NB are usually required for efficient detection, which as discussed above lead to higher computational costs and higher resource utilization (e.g., higher memory consumption). Thus, existing non-parametric change point methods have technical problems relating to compromising either statistical performance or computational costs/resource utilization.

The present disclosure provides technical solutions to the technical problems identified above. For example, the present disclosure provides a technique with improved statistical performance relative to existing change point detection techniques, without increased computational costs or resource utilization. Thus, the proposed approach does not need to make the compromise that the conventional techniques have to. The proposed approach is directed to an online change point detection algorithm using a non-parametric method in streaming data. The proposed approach is implemented using ESP.

In particular, the proposed approach uses a Kolmogorov Smirnov (KS) test to compare pre- and post-change distributions for detecting change points in streaming data (e.g., the time series data) using ESP. The proposed non-parametric change point detection approach relies on damped histograms instead of sliding windows for detecting change points. In particular, the proposed approach computes two histograms using damped windows: a reference window for an initial set of data points (also referred to herein as “observations”) and a current window representing the recent history of observations. The characteristic of damped windows is a damping factor λ∈(0, 1], which exponentially damps old observations (e.g., gives more importance to recent data points relative to older data points). The proposed approach detects change points by comparing weighted-CDFs (computed using the damped histograms) from the reference and current windows, using specific statistical measures, and detecting change points when the computed measure crosses a certain threshold value.

The proposed approach also provides fine-tuning of the threshold value that accounts for the sample-size effect while also controlling for false alarm rates. Thus, the proposed approach extends the KS test to damped histograms in streaming data and provides a statistical intuitive method of setting the threshold value depending on input parameters of the change point method (e.g., a significance level a and damping factor A).

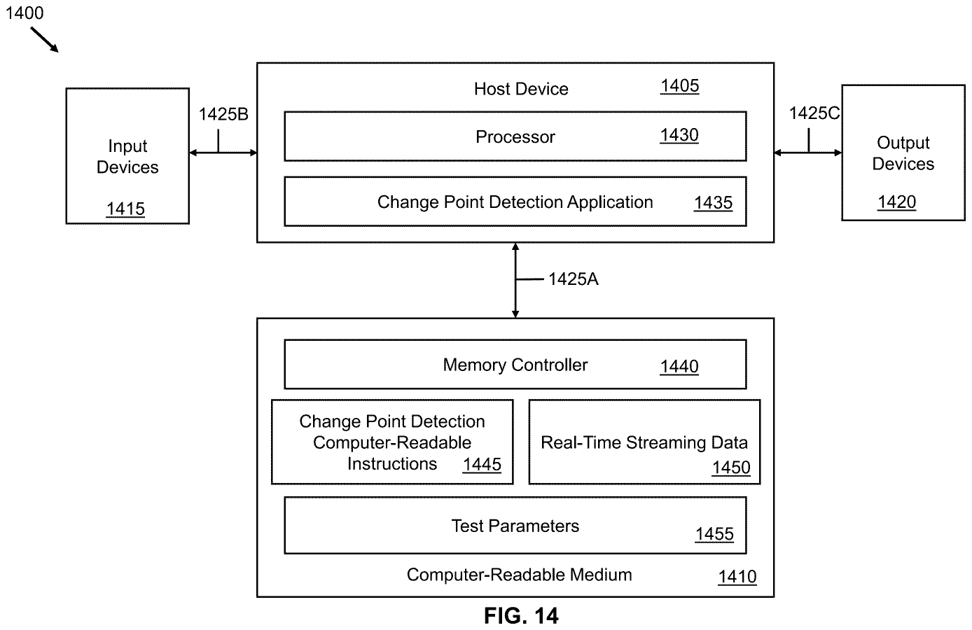

Turning now to FIG. 14, a block diagram of an example change point detection system 1400 is shown, in accordance with some embodiments of the present disclosure. The change point detection system 1400 may be part of, or otherwise associated with, the computing environment 114. The change point detection system 1400 includes a host device 1405 associated with a computer-readable medium 1410. The host device 1405 may be configured to receive input from one or more input devices 1415 and provide output to one or more output devices 1420. The host device 1405 may be configured to communicate with the computer-readable medium 1410, the input devices 1415, and the output devices 1420 via appropriate communication interfaces, buses, or channels 1425A, 1425B, and 1425C, respectively. The change point detection system 1400 may be implemented in a variety of computing devices such as computers (e.g., desktop, laptop, etc.), servers, tablets, personal digital assistants, mobile devices, wearable computing devices such as smart watches, other handheld or portable devices, or any other computing units suitable for performing operations described herein using the host device 1405.

Further, some or all of the features described in the present disclosure may be implemented on a client device, an on-premise server device, a cloud/distributed computing environment, or a combination thereof. Additionally, unless otherwise indicated, functions described herein as being performed by a computing device (e.g., the change point detection system 1400) may be implemented by multiple computing devices in a distributed environment, and vice versa.

The input devices 1415 may include any of a variety of input technologies such as a keyboard, stylus, touch screen, mouse, track ball, keypad, microphone, voice recognition, motion recognition, remote controllers, input ports, one or more buttons, dials, joysticks, point of sale/service devices, card readers, chip readers, and any other input peripheral that is associated with the host device 1405 and that allows an external source, such as a user, to enter information (e.g., data) into the host device and send instructions to the host device 1405. Similarly, the output devices 1420 may include a variety of output technologies such as external memories, printers, speakers, displays, microphones, light emitting diodes, headphones, plotters, speech generating devices, video devices, and any other output peripherals that are configured to receive information (e.g., data) from the host device 1405. The “data” that is either input into the host device 1405 and/or output from the host device may include any of a variety of textual data, numerical data, alphanumerical data, graphical data, video data, sound data, position data, combinations thereof, or other types of analog and/or digital data that is suitable for processing using the change point detection system 1400.

The host device 1405 may include a processor 1430 that may be configured to execute instructions for running one or more applications associated with the host device 1405. In some embodiments, the instructions and data needed to run the one or more applications may be stored within the computer-readable medium 1410. The host device 1405 may also be configured to store the results of running the one or more applications within the computer-readable medium 1410. One such application on the host device 1405 may be a change point detection application 1435. The change point detection application 1435 may be used to detect change points in streaming data (e.g., time series data).

The change point detection application 1435 may be executed by the processor 1430. The instructions to execute the change point detection application 1435 may be stored within the computer-readable medium 1410. To facilitate communication between the host device 1405 and the computer-readable medium 1410, the computer-readable medium may include or be associated with a memory controller 1440. Although the memory controller 1440 is shown as being part of the computer-readable medium 1410, in some embodiments, the memory controller may instead be part of the host device 1405 or another element of the change point detection system 1400 and operatively associated with the computer-readable medium 1410. The memory controller 1440 may be configured as a logical block or circuitry that receives instructions from the host device 1405 and performs operations in accordance with those instructions. For example, to execute the change point detection application 1435, the host device 1405 may send a request to the memory controller 1440. The memory controller 1440 may read the instructions associated with the change point detection application 1435. For example, the memory controller 1440 may read change point detection computer-readable instructions 1445 stored within the computer-readable medium 1410 and send those instructions back to the host device 1405. In some embodiments, those instructions may be temporarily stored within a memory on the host device 1405. The processor 1430 may then execute those instructions by performing one or more operations called for by those instructions.

The computer-readable medium 1410 may include one or more memory circuits. The memory circuits may be any of a variety of memory types, including a variety of volatile memories, non-volatile memories, or a combination thereof. For example, in some embodiments, one or more of the memory circuits or portions thereof may include NAND flash memory cores. In other embodiments, one or more of the memory circuits or portions thereof may include NOR flash memory cores, Static Random Access Memory (SRAM) cores, Dynamic Random Access Memory (DRAM) cores, Magnetoresistive Random Access Memory (MRAM) cores, Phase Change Memory (PCM) cores, Resistive Random Access Memory (ReRAM) cores, 3D XPoint memory cores, ferroelectric random-access memory (FeRAM) cores, and other types of memory cores that are suitable for use within the computer-readable medium 1410. In some embodiments, one or more of the memory circuits or portions thereof may be configured as other types of storage class memory (“SCM”). Generally speaking, the memory circuits may include any of a variety of Random Access Memory (RAM), Read-Only Memory (ROM), Programmable ROM (PROM), Erasable PROM (EPROM), Electrically EPROM (EEPROM), hard disk drives, flash drives, memory tapes, cloud memory, or any combination of primary and/or secondary memory that is suitable for performing the operations described herein.

The computer-readable medium 1410 may also be configured to store data 1450. The data 1450 may include streaming data (e.g., real-time streaming data) and/or other data used by the change point detection application 1435. The computer-readable medium 1410 may also be configured to store test parameters 1455. The test parameters 1455 may include data associated with parameters needed/used by the change point detection application 1435 in detecting change points in the data 1450.

It is to be understood that only some components of the change point detection system 1400 are shown and described in FIG. 14. However, the change point detection system 1400 may include other components such as various batteries and power sources, networking interfaces, routers, switches, external memory systems, controllers, etc. Generally speaking, the change point detection system 1400 may include any of a variety of hardware, software, and/or firmware components that are needed or considered desirable in performing the functions described herein. Similarly, the host device 1405, the input devices 1415, the output devices 1420, and the computer-readable medium 1410, including the memory controller 1440, may include hardware, software, and/or firmware components that are considered necessary or desirable in performing the functions described herein.

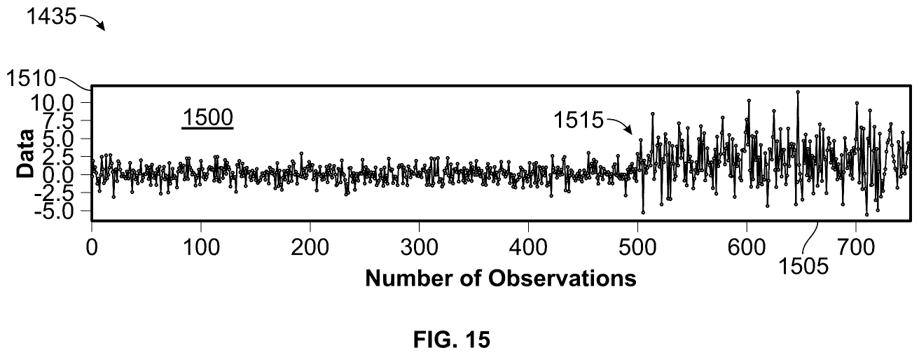

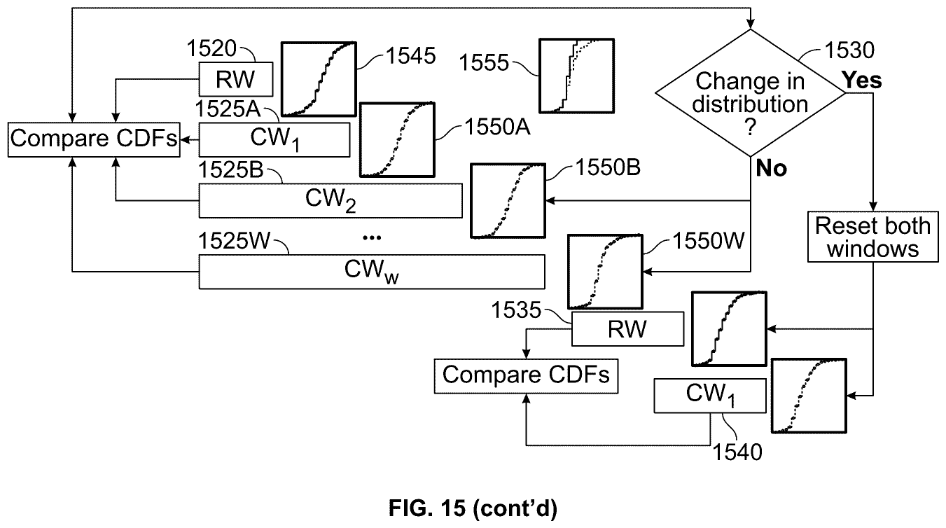

Turning now to FIG. 15, an example block diagram of the change point detection application 1435 is shown, in accordance with some embodiments of the present disclosure. The block diagram illustrates an implementation of the proposed approach in ESP. The change point detection allows for detecting changes in distribution of data 1500. The data 1500 may be streaming data. For example, the data 1500 may be time-series data. In some embodiments, the data 1500 may be generated by one or more IoT sensors. In some embodiments, the data 1500 may be generated by other mechanical, non-mechanical, electro-mechanical, or other types of systems that generate data in real-time and that may benefit from change point detection. The data 1500 may include a plurality of data points (e.g., a number of observations shown on X-axis 1505). Each of the plurality of data points may be associated with a data value, shown on Y-axis 1510. The change point detection may be configured to detect a change point 1515 in the data 1500. The change point 1515 may indicate a change in the distribution of the data 1500. A change in the distribution of the data 1500 may refer to a shift in the statistical properties of the data.

To detect the change point 1515, in some embodiments, the change point detection application 1435 may define a reference window 1520. The reference window 1520 may include n data points of the plurality of data points of the data 1500. The reference window 1520 is a fixed sized window. The change point detection application 1435 also defines one or more current windows 1525A-1525W. Although three current windows are shown in FIG. 15, the number of current windows may vary from embodiment to embodiment. In some embodiments, the number of current windows may be dependent upon when a change point is detected. When a change point is detected (e.g., a change in distribution 1530 is detected), the reference window 1520 is reset and new current windows from the reset reference window are defined. For example, when the change point 1515 is detected, the change in distribution 1530 may become true (e.g., YES), the reference window and all current windows are reset. For example, the reference window 1520 is reset and a new reference window 1535 is defined. The new reference window 1535 also includes n data points, however, starting from or after the data point at which the change point 1515 is detected. The new current windows are then defined from the new reference window 1535. Only one new current window 1540 is shown in FIG. 15. However, a plurality of current windows may be defined after the new reference window 1535, similar to the current windows 1525A-1525W. If no change point is detected (e.g., the change in distribution 1530 is false (e.g., NO), additional current windows from the reference window 1520 continue to be defined.

In some embodiments, each current window of the one or more current windows 1525A-1525W may be of a varying size. In some embodiments, each current window of the one or more current windows 1525A-1525W includes the n data points of the reference window plus additional data points from the plurality of data points of the data 1500. For example, in some embodiments, the current window 1525A may include the n data points of the reference window 1520 plus the next m data points of the plurality of data points. The current window 1525B may include the n+m data points of the current window 1525A plus the next m data points of the plurality of data points, thereby having n+2m data points of the plurality of data points of the data 1500. In some embodiments, each subsequent current window may be longer than a previous current window. In some embodiments, the number of additional data points in each successive current window may be different from a previous window current window. In other words, instead of having m additional data points, each successive current window may have a different number of additional data points.

In some embodiments, each reference window (e.g., the reference window 1520, the new reference window 1535) and each current window (e.g., the current windows 1525A-1525W, the new current window 1540) may be a damped window. Instead of treating all data points in a window equally, a damped window assigns a higher weight to more recent data points, thereby gradually fading the impact of older data points. Thus, in some embodiments, as each data point of the plurality of data points of the data 1500 is received, in some embodiments, the change point detection application 1435 may assign that data point a weight. Simultaneously, the change point detection application 1435 may adjust (e.g., reduce) the weights of the older data points, thereby exponentially decaying the influence of the older data points as new data points are received. In some embodiments, the change point detection application 1435 may compute the weight of each data point in the reference window 1520 or the weight of each data point in the new reference window 1535 using Equation 1 below:

$${w}^{i} = {λ}^{i} \qquad Equation 1$$

In Equation 1 above, w is the weight value of a data point in the reference window 1520 (or the new reference window 1535), λ is a damping factor, and i=0, 1, . . . , n is the i^{th} data point of the plurality of data points. Simply as an example, Table 2 below shows example weights that may be computed for the reference window 1520 (or the new reference window 1535) for various example values of the index, i:

TABLE 2

| Index (i) | Weight (wⁱ) |
|---|---|
| 0 | 1 |
| 50 | 0.364 |
| 100 | 0.133 |
| 150 | 0.048 |
| 200 | 0.018 |
| 250 | 0.006 |

In some embodiments, the change point detection application 1435 may compute the weight of each data point in the current windows 1525A-1525W or the weight of each data point in the new current window 1540 using Equation 2 below:

$${w}^{i} = {λ}^{i} \qquad Equation 2$$

In Equation 2 above, w is the weight value of a data point in each current window of the current windows 1525A-1525W (or the new current window 1540), λ is the damping factor, and i=0, 1, . . . , m is the i^{th} data point of the plurality of data points. Simply as an example, Table 3 below shows example weights that may be computed for ach current window (e.g., the current windows 1525A-1525W, the new current window 1540) for various example values of the index, i:

TABLE 3

| Index (i) | Weight (wⁱ) |
|---|---|
| 0 | 1 |
| 50 | 0.364 |
| 100 | 0.133 |
| 150 | 0.048 |
| 200 | 0.018 |
| 250 | 0.006 |

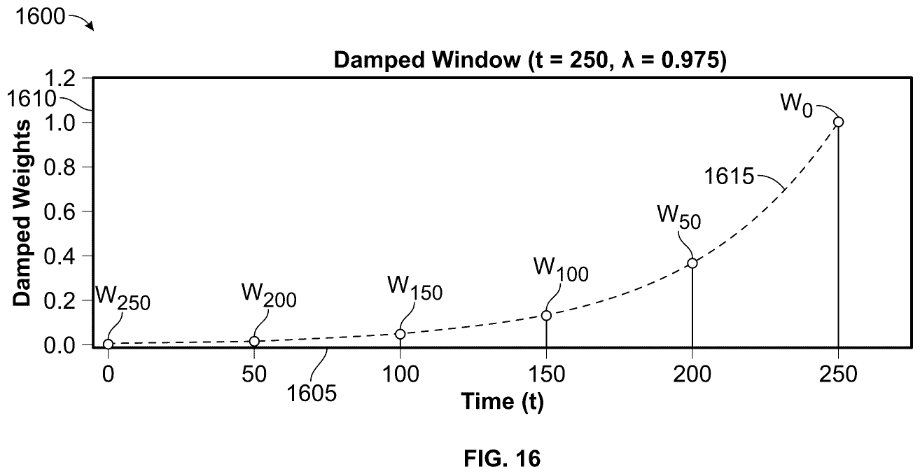

Thus, as seen from Tables 2 and 3, newer data points are assigned a higher weight value than older data points. Therefore, the reference window 1520 and the new reference window 1535 and each of the current windows 1525A-1525W and the new current window 1540 are all damped windows. The computed weight values (also referred to as damped weights) of a damped window may be adjusted by adjusting the damping factor, λ. FIG. 16 shows an example of computed damped weight assignments of a damped window for a damping factor, λ of 0.975. In some embodiments, the damping factor, λ∈(0, 1].

Referring to FIG. 16 in conjunction with FIG. 15, an example graph 1600 is shown, in accordance with some embodiments of the present disclosure. The graph 1600 shows a plot for a window (whether reference or current) having 250 data points (e.g., i=0, 1, . . . 250). The graph 1600 plots the index, i, on X-axis 1605 against damped weights on Y-axis 1610. In some embodiments, the index, i, may be understood in terms of time. For example, in some embodiments, each data point may be associated with a time at which that data point is generated (or streamed or collected). Thus, data point, d₀, may be associated with time t₀, data point, d₁, may be associated with time t₁, and so on. Thus, the X-axis 1605 may also reflect time, with time, tᵢ, corresponding to data point, dᵢ.

As seen from plot 1615, data point received at time, t₂₅₀, may be the most recent data point and thus has the highest computed damped weight value. The weight value of the older data points (e.g., approaching time, t₀) is damped, thereby exponentially decaying the weight value for older data points. By damping the data points, newer data points may have a higher influence in the change point detection, thereby minimizing the impact of outdated or irrelevant data and minimizing noise. Damping the data points may also help manage the amount of memory needed to store the data points by focusing on more relevant data. For example, because the actual data is not stored (only histograms are stored), less memory may be needed. Damping the data points may also provide real-time responsiveness to keep the proposed approach sensitive to recent changes in underlying systems from which the data 1500 is generated.

Returning to FIG. 15, to detect the change point 1515, the change point detection application 1435 may compare the reference window 1520 with each of the current windows 1525A-1525W. In some embodiments, to compare the reference window 1520 with each of the current windows 1525A-1525W, the change point detection application 1435 may compute weighted cumulative distribution functions (weighted-CDFs). In some embodiments, the change point detection application 1435 may compute the weighted CDFs using damped histograms of the reference window 1520 and each of the current windows 1525A-1525W. For example, the change point detection application 1435 may compute a weighted CDF 1545 for the reference window 1520, a weighted CDF 1550A for the current window 1525A, weighted CDF 1550B for the current window 1550B, and so on. Thus, each of the current windows 1525A-1525W has a corresponding instance of the weighted CDF 1550A-1550W. Each of the weighted CDFs 1545, 1550A, and 1550B may be computed using a corresponding damped histogram. Thus, in some embodiments, for each of the reference window 1520 and the current windows 1550A-1550W, a damped histogram may be computed.

A damped histogram may be computed using the damped weight values in a damped window. In some embodiments, a damped histogram may apply a decaying function to exponentially reduce the influence of older data. In some embodiments, a damped histogram may include a plurality of bins. In some embodiments, the number of bins in the plurality of bins may be user defined. In some embodiments, a default number of bins may be used. In some embodiments, each bin of the plurality of bins may be configured to contain a specific range of data point values or bin intervals. For example, in some embodiments, a first bin may include a bin interval between (and including) 0 and 1, a second bin may include a bin interval between (and including) 1.01 and 2.0, a third bin may include a bin interval between (and including) 2.01 and 3, and so on. Thus, in some embodiments, the number of bins in the plurality of bins may be defined based on the defined bin interval of each bin and the total data point value range. For example, if the total data point value range is between 0 and 10 and each bin has a bin interval of 1 (e.g., 0-1, 1.01-2.0, 2.01-3, and so on), a total of 10 bins may be defined. In some embodiments, the number of data points in each bin may vary based on the number of data points that have data point values in the bin interval associated with a particular bin. In some embodiments, each bin of the plurality of bins may have the same bin interval. In some embodiments, one or more bins of the plurality of bins may have different bin intervals.

In some embodiments, the number of bins in the plurality of bins may be a function of the size (e.g., number of data points) of the reference window 1520 (or the new reference window 1535). For example, if the reference window 1520 (or the new reference window 1535) has n data points, the number of bins in the plurality of bins may be computed using Equation 3 below:

$$Number of bins = O ( \sqrt{n} ) \qquad Equation 3$$

In Equation 3 above, O is the Big O notation to express an algorithm's complexity. In some embodiments, and as discussed below, the size of the reference window 1520 (or the new reference window 1535) may be strategically varied as well. Thus, by varying the size of the reference window 1520 (or the new reference window 1535), the number of bins in the plurality of bins may be varied.

Thus, to compute a damped histogram, in some embodiments, the change point detection application 1435 may define a bin interval for each bin of the plurality of bins. In some embodiments, the change point detection application 1435 may compute the range of data point values of the data points received so far, and using the specified number of bins in the plurality of bins, divide the range into bins of equal width (e.g., bin interval). Each bin of the plurality of bins may track the weighted frequency (e.g., exponential decay) that falls within its range. The change point detection application 1435 may initialize a damped histogram based on the data point values in each bin of the plurality of bins. In some embodiments, the change point detection application 1435 may create a dictionary to store the damped weight assigned to each data point in each bin. In some embodiments, the damped histogram may be initialized to zero or another default value. In some embodiments, the change point detection application 1435 may update the damped histogram as a data point arrives at the change point detection application. For example, when a new data point arrives, the change point detection application 1435 may multiply the damping factor with the damped weights assigned to each data point in each bin of the plurality of bins. The change point detection application 1435 may identify the appropriate bin of the plurality of bins based on the data point value of the new data point and the assigned weight value. The change point detection application 1435 may add the new data point to the identified bin and increase the weight of the bin by one. In other embodiments, the change point detection application 1435 may create the damped histograms in other ways. In some embodiments, the space and computational complexity for each damped histogram may be given by O(n_{b}), where n_{b} is the number of bins in the plurality of bins and O is the Big O notation.

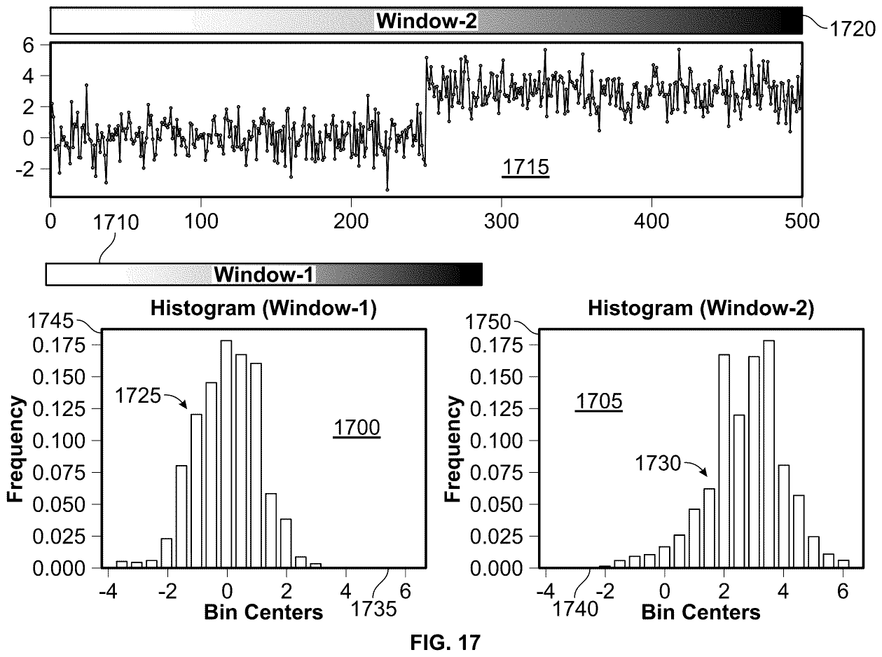

The change point detection application 1435 may compute weighted CDFs from the computed damped histograms. Examples of weighted CDFs are shown in FIG. 17. Referring now to FIG. 17 in conjunction with FIG. 15, a weighted CDF 1700 and a weighted CDF 1705 are shown, in accordance with some embodiments of the present disclosure. The weighted CDF 1700 is for a window 1710 having a first set of data points of data 1715 and the weighted CDF 1705 is for a window 1720 having a second set of data points of the data 1715. In some embodiments, the window 1710 may be a reference window and the window 1720 may be a current window. Both the window 1710 and the window 1720 may be damped windows in which more recent data points are assigned higher damped weight values than older data points.

The weighted CDF 1700 includes a plurality of bins 1725 (e.g., each bin may be represented by one bar of the weighted CDF). Similarly, the weighted CDF 1705 includes a plurality of bins 1730 (e.g., each bin may be represented by one bar of the weighted CDF). In some embodiments, each bin of the plurality of bins 1725 of the weighted CDF 1700 and each bin of the plurality of bins 1730 of the weighted CDF 1705 may have a bin center, indicated on X-axes 1735 and 1740, respectively. The bin center of a bin may be the midpoint of the bin interval. For example, if the bin interval spans from value a to value b, the bin center may be given by Equation 4 below:

$$Bin Center = ( a + b ) / 2 \qquad Equation 4$$

In some embodiments, the bin center helps with change point detection. In some embodiments, each bin may also be associated with a bin height that extends along Y-axes 1745 and 1745. The bin height of a bin is indicative of a number of data points (e.g., frequency) that fall within a particular bin. Thus, the greater the number of data points in a particular bin, the greater the height of that bin. Thus, by looking at the height of a particular bin, the number of data points in that bin may be determined. Additional details of computing a weighted CDF are discussed below.

Returning to FIG. 15, the change point detection application 1435 may compare the weighted CDFs. For example, the change point detection application 1435 may compare the weighted CDF 1545 with the weighted CDF 1550A, the weighted CDF 1545 with the weighted CDF 1550B, the weighted CDF 1545 with the weighted-CDF 1550W, and so on. In some embodiments, the change point detection application 1435 may compare two weighted CDFs by using the Kolmogorov Smirnov (KS) test. For example, in some embodiments, the change point detection application 1435 may implement a two-sample KS test for comparing two damped empirical CDFs. For two empirical distributions (e.g., damped histograms) P1 and P2, with sample sizes n and m, independent and identically distributed samples over an underlying continuous distribution P on the real line R the KS test measures the maximum absolute distance between two cumulative distribution functions (CDFs), FP1 and FP2:

$$KS ( P 1 , P 2 ) = {sup}_{x ϵ ℝ} \vert FP 1 ( x ) - FP 2 ( x ) \vert \qquad Equation 5$$

In Equation 5 above, KS (P1, P2) is the KS metric of damped histograms P1 and P2, FP1 is the CDF of the damped histogram P1, FP2 is the CDF of damped histogram P2, and x is the streaming data.

The KS test may quantify an empirical distribution's convergence rate to the underlying continuous distribution. In particular, as n→∞, where n is the size of the reference window 1520 (or the new reference window 1535), \sqrt{n}|FP1(x)−FP2(x)| converges in distribution to the Kolmogorov distribution. K. Therefore, \sqrt{n}KS(P1, P2) may converge in distribution to the known Kolmogorov distribution, K. For a two-sample KS test,

$$\sqrt{\frac{m n}{n + m}} K S ( P 1 , P 2 ) \to K as n \cdot m \to ∞ \qquad Equation 6$$

In Equation 6 above, m is the size of the current window (e.g., the current windows 1525A-1525W, the new current window 1540). The approximation of Equation 6 holds for a test at a fixed time point, allowing definition of a threshold value. In particular, using an approximation for the tail of the Kolmogorov distribution, for any significance level a, a reference window of size n, a current window of size m, and the damping factor, λ, the threshold, Dₜₕ, may be computed using Equation 7:

$${D}_{th} = \sqrt{- \frac{1}{2} ln ( \frac{α}{2} ) \frac{( 1 - λ ) ( 2 - {λ}^{n} - {λ}^{m} )}{( 1 - {λ}^{n} ) ( 1 - {λ}^{m} )}} \qquad Equation 7$$

In the case of exponentially damped windows, the proportional weight fᵢ of a data point that is i time steps old is given by Equation 8:

$${f}_{i} = \frac{{w}_{i}}{{\sum }_{i = 0}^{n - 1} {w}_{i}} = \frac{{λ}^{i} ( 1 - λ )}{1 - {λ}^{n}} \qquad Equation 8$$

In Equation 8 above, as n→∞, with fixed λ, fᵢ→λⁱ(1−λ). If λ→1, with fixed n, fᵢ→1/n. So, the case where the empirical distribution converges to the Kolmogorov distribution occurs when, for example, n=k/(1−λ), for some fixed k and λ→1. This may be satisfied by having an initial number of data points, Nᵢₙᵢₜ to be a factor of the effective weight of a damped window, defined as the number of data points tends to infinity as:

$${n}_{eff} = {lim}_{n \to ∞} {\sum }_{i = 0}^{n - 1} {λ}^{n} = \frac{1}{1 - λ} \qquad Equation 9$$

Thus, in some embodiments, Nᵢₙᵢₜ=kn_{eff}, for some fixed constant, k. Thus, to summarize, the KS test may include three input parameters: a significance level, a, a reference window size, n_{w}, and a damping factor, A. The significance level corresponds to the probability of rejecting a true null hypothesis. Based on the three input parameters, the change point detection application 1435 may compute the threshold value using Equation 7. The threshold value may provide an acceptable measure of dissimilarity in the distribution of the real-time streaming data. In other words, the threshold value may indicate when the difference between two damped histograms is large enough to constitute a change point.

As an example, to show numerical convergence of KSᵢ(PW1, PW2) to the Kolmogorov distribution by sampling independent damped windows W1 and W2 under a stationary Gaussian distribution, with damping factor λ and reference window size,

$${n}_{eff} = \frac{1}{1 - λ} ,$$

the following example code may be used:

```
  1. Inputs: λ ← 0.999, k ← 1, n_{bins} ← 50, N ← 10000
  $2. {n}_{eff} ← \frac{1}{1 - λ} , {n}_{w} ← ⌈ {kn}_{eff} ⌉$
  3. for (i = 0; i < N; i + +) do [symbol]
      Draw n samples from distribution P
  4.  P_{w}_{₁} = sampleP(n), P_{w}_{₂} = sampleP(n) [symbol]
      Compute the empirical weighted CDF
  5.  eCDF1_{λ} = computedweightedCDF(P_{w}_{₁}, λ)
  6.  eCDF2_{λ} = computedweightedCDF(P_{w}_{₂}, λ) [symbol]
      Compute the two-sample KS test statistic
  7.  KS[i] = ksDistance(eCDF1_{λ}), eCDF2_{λ})
  8. end for
  9. Plot histogram of KS and the Kolmogorov distribution
10. Plot the QQ-plot of KS and the Kolmogorov distribution
```

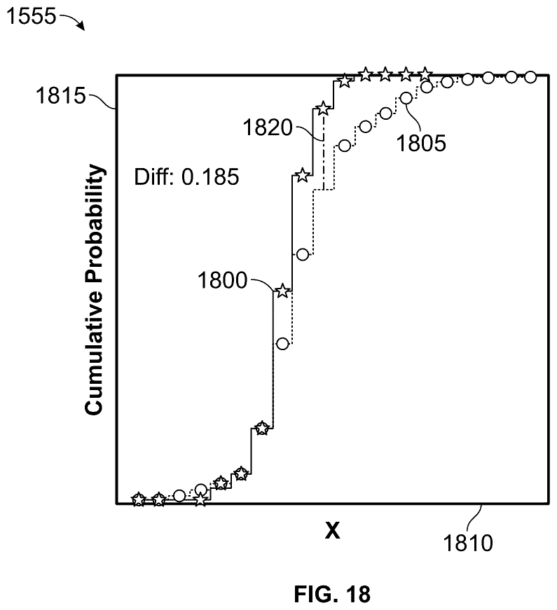

Therefore, in some embodiments, the change point detection application 1435 utilizes the KS test to compare two damped histograms. Specifically, in some embodiments, the change point detection application 1435 may compute a weighted CDF from each damped histogram. The change point detection application 1435 may then determine a difference between the computed weighted CDF, as shown in graph 1555, an expanded version of which is shown in FIG. 18. Referring to FIG. 18 in conjunction with FIG. 15, the graph 1555 is shown in accordance with some embodiments of the present disclosure. The graph 1555 plots a first weighted CDF plot 1800 and a second weighted CDF plot 1805. In some embodiments, the first weighted CDF plot 1800 may correspond to the reference window (e.g., the reference window 1520) and may be computed based on the damped histogram 1545 determined for the reference window. In some embodiments, the second weighted CDF plot 1805 may correspond to a current window (e.g., the current window 1525A) and may be computed based on the damped histogram (e.g., the damped histogram 1550A) determined for the current window. The graph 1555 plots a generic point or observation, X, on X-axis 1810 against a cumulative probability on Y-axis 1815.

The change point detection application 1435 may compute a maximum difference 1820 between the first weighted CDF plot 1800 and the second weighted CDF plot 1805. In some embodiments, the maximum difference 1820 may be a maximum absolute difference between the first weighted CDF plot 1800 and the second weighted CDF plot 1805. In some embodiments, the change point detection application 1435 may compare the maximum difference 1820 with the threshold value computed using Equation 7. In some embodiments, if the maximum difference is greater than the threshold value, the change point detection application 1435 may determine that the distribution of the data 1500 has changed and that the change point 1515 has been detected.

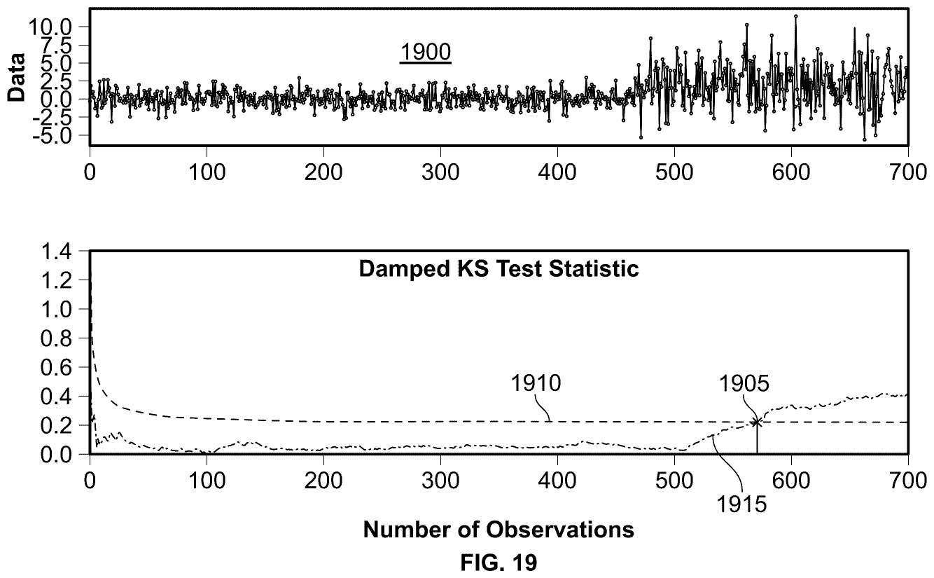

Referring to FIG. 19 in conjunction with FIGS. 15 and 18, an example of streaming data 1900 is shown, in accordance with some embodiments of the present disclosure. The data 1900 shows a change point 1905 at which the distribution of the data has changed. FIG. 19 also shows a plot 1910 of threshold values computed using Equation 7 and a plot 1915 of the maximum difference 1820. The plot 1915 crosses the plot 1910 at the change point 1905. Thus, at the change point 1905, the change in the distribution of the data 1900 changes enough to trigger a change point.

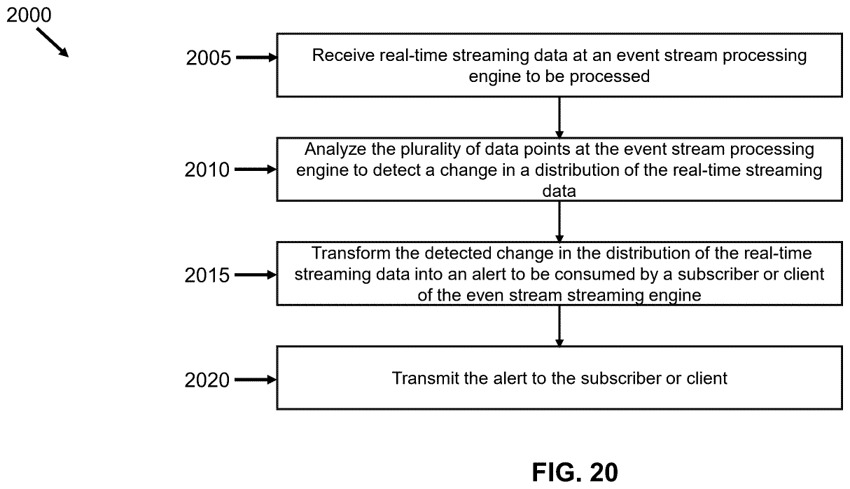

Referring to FIG. 20, an example flowchart outlining the operations of a process 2000 is shown, in accordance with some embodiments of the present disclosure. The process 2000 is used to detect a change point in streaming data in real-time (or substantial real-time). The process 2000 may be executed by one or more processors (e.g., the processor 1430) executing computer-readable instructions (e.g., the change point detection computer-readable instructions 1445) stored on a computer-readable medium (e.g., the computer-readable medium 1410). The process 2000 may be implemented by the change point detection application 1435. In other embodiments, the process 2000 may include other or additional operations.

At operation 2005, the processor receives real-time (or substantial real-time) streaming data (e.g., the data 1500) at an ESP engine (e.g., the ESP engine 800) to be processed. In some embodiments, the real-time streaming data may be part of a data analytics project being analyzed at the ESP engine. The real-time streaming data may include a plurality of data points. In some embodiments, the real-time streaming data may include time-series data. The ESP engine may implement the change point detection application 1435 to detect one or more change points in the real-time streaming data.

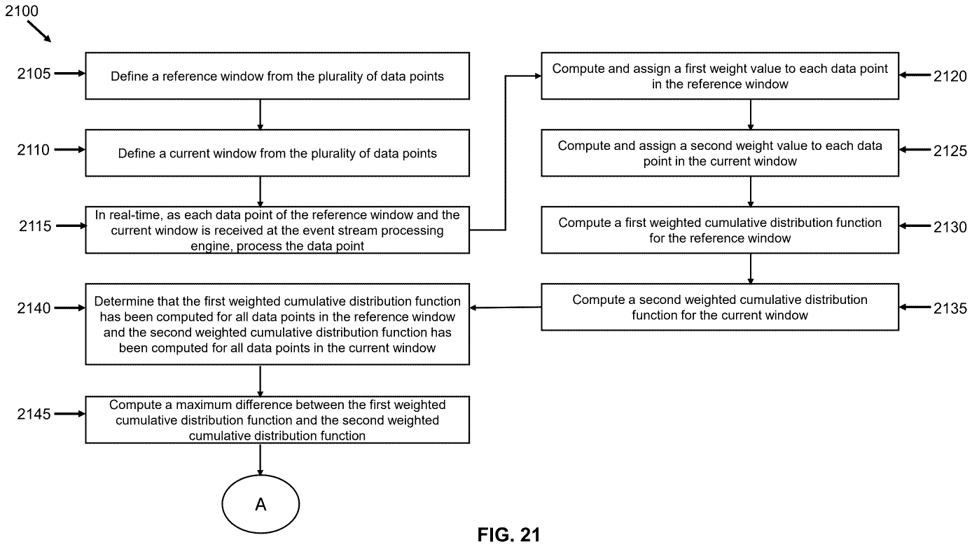

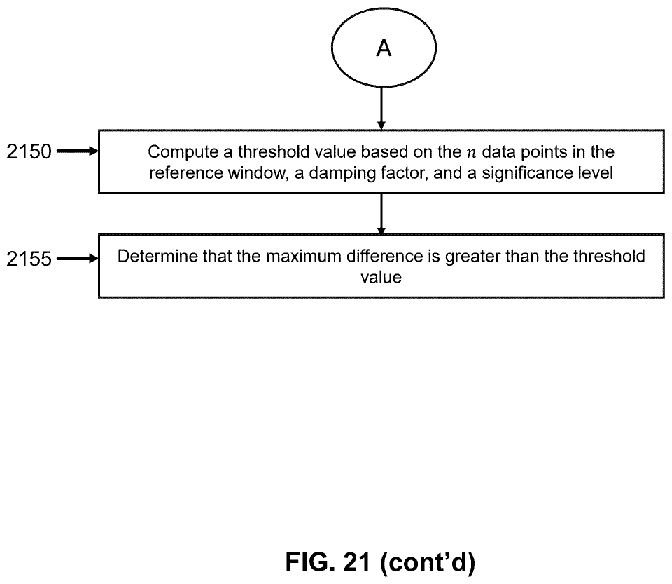

At operation 2010, the processor analyzes the plurality of data points at the ESP engine to detect a change in distribution of the real-time streaming data. The change in the distribution of the real-time streaming data may be indicative of a change point. Additional details of the operation 2010 are described in FIG. 21.

At operation 2015, the processor transforms the detected change in the distribution of the real-time streaming data into an alert for a subscriber or client of the ESP engine. In particular, when the change point is detected in the real-time streaming data, as discussed above, the change point may be indictive of a change in the underlying system that generated the real-time streaming data. For example, in some embodiments, the change point may indicate that a mechanical system is reaching critical point or coming back to normal from a critical point, that a patient's condition being monitored is showing variations, etc. In other words, detection of a change point may be indictive of a condition that may need someone's attention. Thus, in some embodiments, the detected change point may be converted into an alert. In some embodiments, the alert may be automatically generated.

The alert may be a signal or notification that is triggered when the change point is detected. The alert may assume any desired suitable form. For example, in some embodiments, the alert may be an audible alert such as a siren, beep, chime, wailing tone, ringtone, buzzer, or other types of sounds. In some embodiments, the audible alert may be designed to have a specific tone, volume, and/or pattern to match the level of detected change point. For example, if a change point greater than a specific range is detected, then a tone, volume, and/or pattern indicating more criticality may be used. In some embodiments, the alert may be a visual alert that uses light (e.g., flashing light), color (e.g., red light), and/or motion (e.g., screen flashes) to draw attention to the detected change point. In some embodiments, the visual alert may include pop-up messages, emails, text messages, icons, symbols, paging systems, etc. In some embodiments, a combination of audible and visual alerts may be used. In other embodiments, other or additional types of suitable alerts may be used to draw attention to the detected change point. In some embodiments, the alert may include the notification (e.g., as described above) and any additional information that may be desired or considered useful to have. For example, in some embodiments, the alert may include information related to when the change point was detected, which underlying sensors or systems generated the change point, etc.

At operation 2020, the processor transmits the alert generated at the operation 2015 to the subscriber or client. In some embodiments, the alert may be transmitted using any suitable channels depending on the type, urgency, and target audience. For example, in some embodiments, the alert may be a wireless emergency alert that is transmitted directly to one or more portable devices (e.g., mobile phones) via cell towers. In some embodiments, the alert may be transmitted using an emergency alert system such as using broadcasts over AM/FM radio, satellite radio, television (e.g., cable and satellite), etc. In some embodiments, the alert may be transmitted using a weather radio, using an integrated public alert and warning system, local system, hand or manual delivery, etc. In some embodiments, transmitting the alert may include displaying the alert on a device. In some embodiments, transmitting the alert may include visually or audibly broadcasting the alert, as discussed above. Responsive to receiving the alert, the subscriber or client may perform additional actions (e.g., inspect the system that generated data having the change point, diagnose the patient, take remedial actions, etc.).

Referring to FIG. 21, an example flowchart outlining the operations of a process 2100 is shown, in accordance with some embodiments of the present disclosure. The process 2100 is used to detect a change point in streaming data in real-time (or substantial real-time). The process 2100 may be executed by one or more processors (e.g., the processor 1430) executing computer-readable instructions (e.g., the change point detection computer-readable instructions 1445) stored on a computer-readable medium (e.g., the computer-readable medium 1410). The process 2100 may be implemented by the change point detection application 1435. In other embodiments, the process 2100 may include other or additional operations. The process 2100 describes the operation 2010 in greater detail.

At operation 2105, the processor defines a reference window from the plurality of data points of the real-time streaming data received at the operation 2005. For example, the processor may define the reference window 1520. The reference window 1520 may include n data points of the plurality of data points. The reference window 1520 may be a damped window (e.g., more recent data points may be assigned higher weight values).

At operation 2110, the processor defines a current window from the plurality of data points of the real-time streaming data received at the operation 2005. For example, the current window may include one or more of the current windows 1525A-1525W (the current window 1525A is used for explanation s below). The current window 1525A may include greater than n data points of the plurality of data points. The current window 1525A may be a damped window. In some embodiments, the reference window 1520 may be a fixed size window (e.g., with n data points), and the current window 1525A may be a varying size window. For example, in some embodiments, the current window 1525A may include the n data points of the reference window 1520 plus additional data points from the plurality of data points.

At operation 2115, in real-time, as each data point of the reference window 1520 and the current window 1525A is received at the ESP engine (e.g., the ESP engine 800), the processor processes the data point. To process the data point, the processor may execute operations 2120-2135. In particular, at the operation 2120, responsive to determining that the data point is not an (n+1)th data point, the processor computes and assigns a first weight value to each data point in the reference window 1520. Because the reference window 1520 is a damped window, more recent data points in the reference window are assigned a higher weight value than less recent data points in the reference window. Further, because the reference window 1520 only has n data points, the operation 2120 is executed only for the initial n data points. When the (n+1)^{th} data point is received, no further first weight values are computed for the reference window and the subsequent data points may be ignored for the reference window until the reference window 1520 is reset. In some embodiments, the processor may compute the first weight value of each of the n data points in the reference window 1520 using Equation 1.

At the operation 2125, the processor computes and assigns a second weight value to each data point in the current window 1525A. Because the current window 1525A is a damped window, more recent data points in the current window are assigned a higher weight value than less recent data points in the current window. Further, because the current window 1525A has greater than n data points, the operation 2125 may continue to be executed even when the operation 2120 is skipped (e.g., after the n data points have been received). The operation 2125 may be executed until all data points in the current window 2125 have been assigned a second weight value. For example, if the current window 1525A has m data points, where m>n, the operation 2125 be executed m times.

At the operation 2130, the processor computes a first weighted cumulative distribution function (CDF) for the reference window 1520 based on the first weight value assigned to each data point in the reference window. In particular, to compute the first CDF, the processor computes a first damped window histogram for each data point in the reference window 1520. For example, the processor may create a damped window histogram, as discussed in FIG. 17. In some embodiments, and as discussed above, the first damped window histogram may include a first plurality of bins (e.g., the plurality of bins 1725). Each bin of the plurality of bins may include one or more data points of the n data points of the reference window 1520. To compute the first damped window histogram, the processor may compute a first weighted height of each of the first plurality of bins.

Further, for each bin of the first plurality of bins, the processor may add the first weighted height of all previous bins of the first plurality of bins up to the bin to obtain a first cumulative weighted height of the bin. For example, for bin #5, the processor may add the first weighted height of bin #1, bin #2, bin #3, and bin #4 to obtain the first cumulative weighted height for bin #5. For bin #6, the processor may add the first weighted height of bin #1, bin #2, bin #3, bib #4, and bin #5 to obtain the first cumulative weighted height for bin #6. This way, for each bin of the plurality of bins, the processor may compute the cumulative weighted height. The processor may then plot the first cumulative height of each bin of the first plurality of bins to obtain the first weighted CDF for the reference window 1520, for example, as shown by the plot 1800.

At the operation 2135, the processor computes a second weighted cumulative distribution function (CDF) for the current window 1525A based on the second weight value assigned to each data point in the current window. To compute the second weighted CDF, the processor may compute a second damped window histogram for each data point in the current window 1525A. For example, the processor may create a damped window histogram, as discussed in FIG. 17. The second damped window histogram may include a plurality of bins (e.g., the plurality of bins 1730). To compute the second damped window histogram, the processor may compute a second weighted height of each of the second plurality of bins. Further, for each bin of the second plurality of bins, the processor may add the second weighted height of all previous bins of the second plurality of bins up to the bin to obtain a second cumulative weighted height of the bin, similar to the operation 2130. The processor may plot the second cumulative height of each bin of the second plurality of bins to obtain the second weighted CDF for the current window 1525A.

At operation 2140, the processor determines that the first weighted CDF has been computed for all data points in the reference window 1520 and the second weighted CDF has been computed for all data points in the current window 1525A. In particular, the first weighted CDF and the second weighted CDF are computed as each data point is received. Thus, when a new data point is received, the previously computed first weighted CDF is updated. When all n data points have been received and the first weighted CDF has been updated for all the n data points, the processor may determine that the first weighted CDF has been computed for all data points in the reference window 1520. Similarly, when a new data point is received, the previously computed second weighted CDF is updated. When all n+m data points have been received and the second weighted CDF has been updated for all the n+m data points, the processor may determine that the second weighted CDF has been computed for all data points in the current window 1525A.

At operation 2145, the processor, responsive to determining that the first weighted CDF has been computed for all data points in the reference window 1520 and the second weighted CDF has been computed for all data points in the current window 1525A, computes a maximum difference between the first weighted CDF and the second weighted CDF. In other words, the processor determines the maximum difference 1820. In particular, the maximum difference is a maximum absolute difference between a plot of the first cumulative height of each bin of the first plurality of bins and the plot of the second cumulative height of each bin of the second plurality of bins. In some embodiments, the processor may determine the maximum absolute difference by subtracting the corresponding values of the first weighted CDF and the second weighted CDF at each bin center.

At operation 2150, the processor computes a threshold value, Dₜₕ, based on the n data points in the reference window, a damping factor, λ, and a significance level, α. In some embodiments, the processor may compute the threshold value, Dₜₕ, using Equation 7. The threshold value, Dₜₕ, may be an acceptable measure of dissimilarity in the distribution of the real-time streaming data.

At operation 2155, the processor determines that the maximum difference is greater than the threshold value, Dₜₕ. In some embodiments, the maximum difference being greater than the threshold value, Dₜₕ, may indicate that the detected change in the distribution of the real-time streaming data is greater than the acceptable measure of dissimilarity. In other words, the maximum difference being greater than the threshold value, Dₜₕ, may indicate that the distribution of the real-time streaming data has changed enough to constitute a change point.

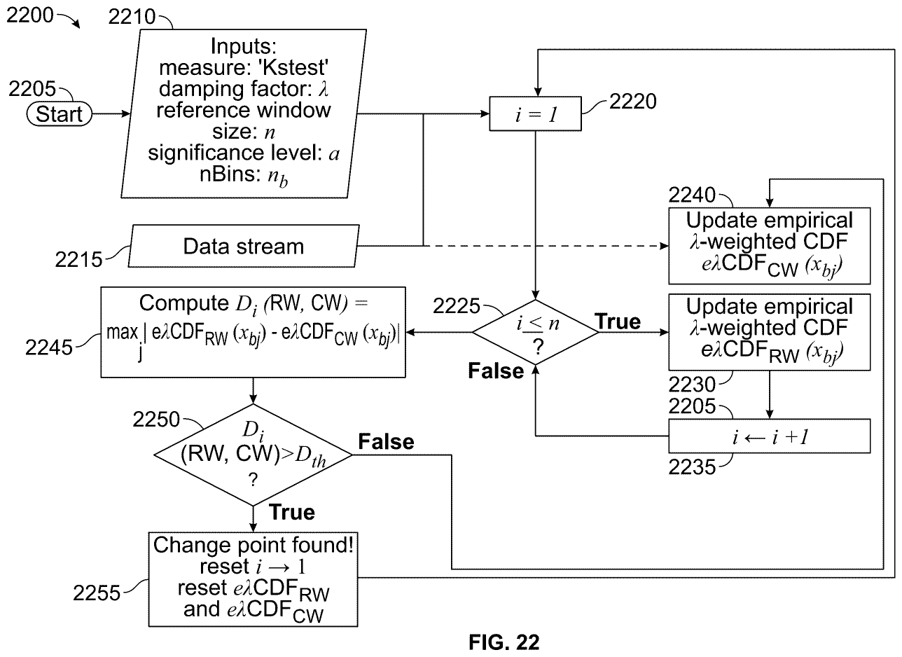

Referring to FIG. 22, an example flowchart outlining the operations of a process 2200 is shown, in accordance with some embodiments of the present disclosure. The process 2200 is used to detect a change point in streaming data in real-time (or substantial real-time). The process 2200 may be executed by one or more processors (e.g., the processor 1430) executing computer-readable instructions (e.g., the change point detection computer-readable instructions 1445) stored on a computer-readable medium (e.g., the computer-readable medium 1410). The process 2200 may be implemented by the change point detection application 1435. In other embodiments, the process 2200 may include other or additional operations. The process 2200 describes the operation 2010 and the process 2100 in greater detail.

The process 2200 starts at operation 2205 and receives inputs at operation 2210. In some embodiments, the inputs received may be used to implement the KS test for comparing the damped window histograms. In some embodiments, the inputs may include an indication that the KS test is to be used for comparing the damped window histograms. In some embodiments, the indication of the KS test may be received through a user interface (e.g., associated with the input devices 1415 or the output devices 1420). In some embodiments, the indication of the KS test may be selected from a drop-down list on the user interface. In some embodiments, the indication of the KS test may be received in other ways. The other inputs received at the operation 210 may include the significance level, α, a size, n, of the reference window 1520, a damping factor, λ, and a number of bins, n_{b}, of the plurality of bins 1725 and 1730. In some embodiments, and as discussed below, by selectively varying one or more of the significance level, α, the size, n, of the reference window 1520, or the damping factor, λ, the sensitivity of the change point detection may be modified. In some embodiments, one or more of the significance level, α, the size, n, of the reference window 1520, or the damping factor, λ, may be selected via the user interface (e.g., associated with the input devices 1415 or the output devices 1420), for example, by entering values, selecting values from a drop-down list, using default values, etc.

At operation 2215, the real-time streaming data (e.g., the data 1500) is received. In some embodiments, the operation 2215 may occur before or after the operation 2210 or simultaneously with the operation 2210.

At operation 2220, an index, i=1, is defined for the first data point that is received. The index, i, may be used to keep track of the n data points in the reference window 1520. At operation 2225, the processor determines if the index, i≤n. Because the reference window 1520 has a size, n, if i≤n, the process 2200 proceeds to operation 2230. At the operation 2230, damped weights are assigned to each data point that is in the reference window 1520 using Equation 1. Based on the assigned damped weights, a damped histogram is computed, and a CDF is computed or updated. Thus, at the operation 2230, an updated empirical λ-weighted CDF, eλCDF_{RW}(x_{b}_{ⱼ}) is determined, where the notation e indicates that the CDF is an empirical CDF, λCDF_{RW} is the λ-weighted CDF of the reference window, RW, and x_{b}_{ⱼ} is the j^{th} bin center. The empirical cumulative distribution function is calculated from the damped histogram by cumulatively summing the bin-heights (probabilities) of the histogram. In other words, the cumulative sum of the bin-heights up to a certain point represents the empirical CDF's value at that point.

At operation 2235, the index, i, is incremented by 1 and the process 2200 loops back to the operation 2225 until all n data points in the reference window 1520 have been received and the CDF updated for all the n data points. Simultaneously with computing/updating the CDF for the reference window 1520, at operation 2240, an empirical λ-weighted CDF for the current window is computed. In particular, at the operation 2240, damped weights are computed for each data point in the current window 1525A, a damped histogram is computed, and a CDF is computed. When the CDF for all n data points in the reference window 1520 has been computed and the CDF for all data points in the current window 1525A has been computed, the process 2200 proceeds to operation 2245 where a maximum difference (e.g., the maximum difference 1820) is computed between the CDFs computed at operations 2230 and 2240. In particular, the processor may compute a maximum absolute difference, Dᵢ(RW, CW), as:

$${D}_{i} ( RW , CW ) = {max}_{j} \vert e λ {CDF}_{RW} ( {x}_{{b}_{j}} ) - e λ {CDF}_{CW} ( {x}_{{b}_{j}} ) \vert \qquad Equation 10$$

At operation 2250, the processor compares the maximum absolute difference, Dᵢ(RW, CW) with the threshold value, Dₜₕ. The threshold value, Dₜₕ, may be computed using Equation 7 as discussed above. If Dᵢ(RW, CW)>Dₜₕ, the processor determines, at operation 2255, that a change point is detected and triggers an alert. The processor may also reset the index, i, to 1 to reset the reference window 1520, resets the CDFs for both the reference window and the current window 1525A, and loops back to the operation 2220 to detect the next change point. However, if at the operation 2250, Dᵢ(RW, CW)≤Dₜₕ, the processor determines that a change point has not been detected and the process 2200 loops back to the operation 2240 to keep computing the CDF for the current window 1525A.

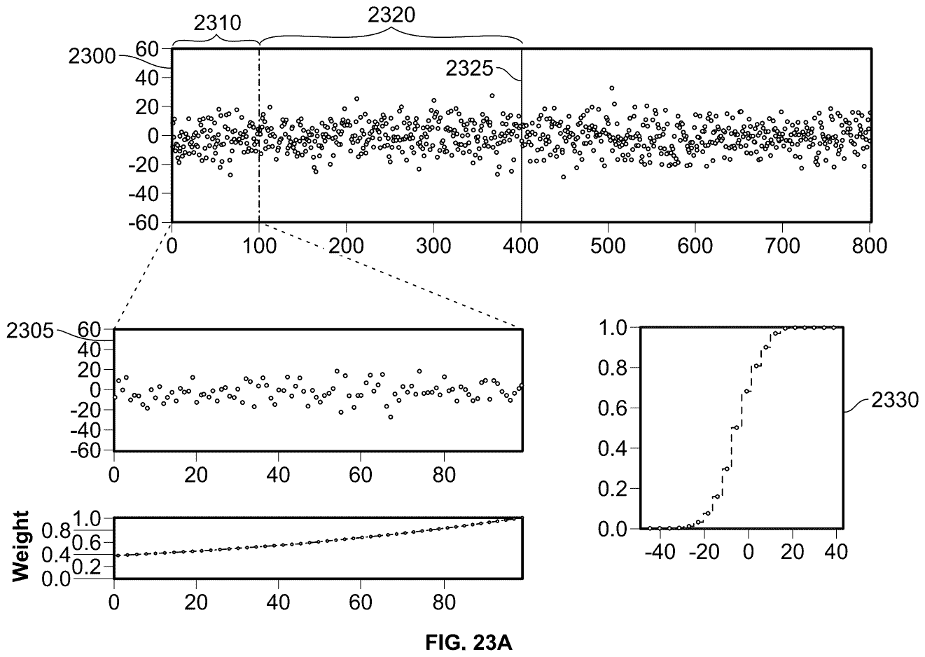

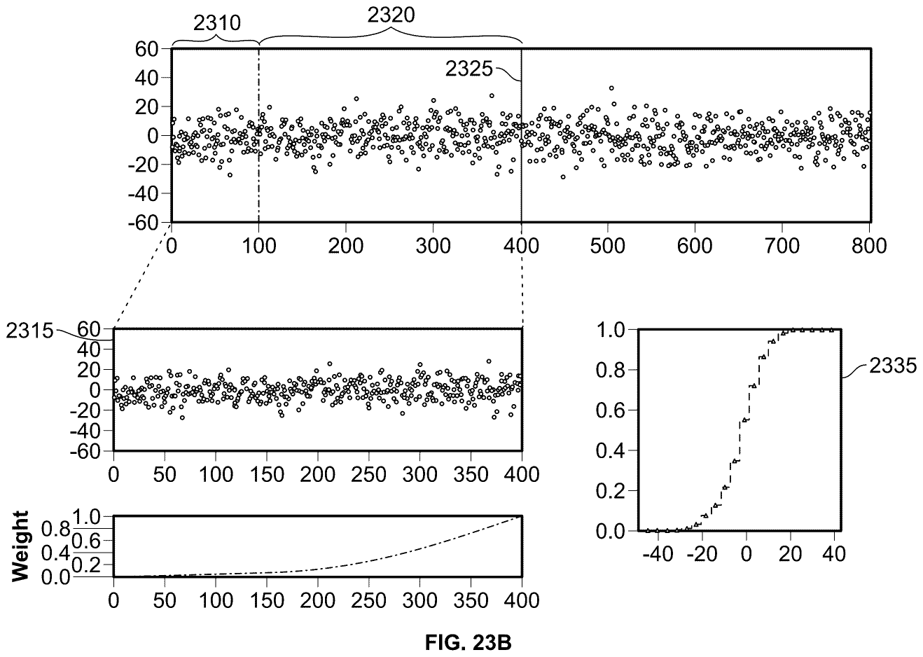

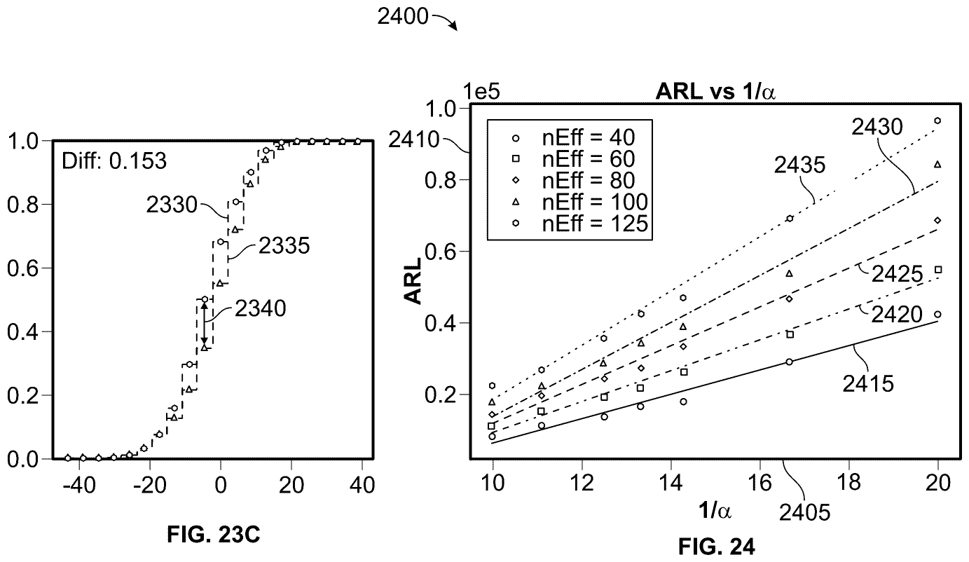

Turning now to FIGS. 23A-23C, examples of an Average Run Length (ARL) and false alarm rate of the change point detection are shown, in accordance with some embodiments of the present disclosure. As discussed above, in some embodiments, by selectively varying one or more of the significance level, α, the size, n, of the reference window 1520, or the damping factor, λ, the sensitivity of the change point detection may be modified. In particular, by adjusting one or more of the significance level, α, the size, n, of the reference window 1520, and/or the damping factor, λ, the computed threshold value, Dₜₕ, may be modified, which in turn may modify the sensitivity of the change point detection. In some embodiments, sensitivity of the change point detection may be measured in terms of ARL and false alarm rate. A false alarm occurs when a change point is detected when there is actually no change point. In other words, a false alarm occurs when the change point detection application 1435 determines that the distribution of the streaming data has changed when the distribution has not in fact changed. The false alarm rate indicates how frequently the false alarms are occurring. The false alarm rate is related to ARL. ARL measures how many data points are ingested before a false alarm is triggered. In other words, ARL determines how long can the process go without detecting a false alarm.

For example, and looking at FIGS. 23A-23C, an example data stream 2300 is shown, in accordance with some embodiments of the present disclosure. The data stream 2300 may include a reference window 2305 having data points 2310 and a current window 2315 having data points 2320. The data stream 2300 has no change point. However, a change point is shown as being detected at point 2325. Thus, a false alarm occurs at the point 2335. In particular, a CDF plot 2330 may be computed for the reference window 2305 and a CDF plot 2335 may be computed for the current window 2315. A maximum difference 2340 may be computed based on the CDF plots 2330 and 2335, as shown in FIG. 23C. Assuming the maximum difference is 0.153 and if the computed threshold value, Dₜₕ, is 0.1, then because 0.153 is greater than 0.1, a change point may be detected. However, as seen from the data stream 2300, no change in distribution occurs at the point 2325. Thus, a false alarm may be said to have been triggered at the point 2325.

Fewer false alarms may be desired. Thus, a false alarm rate as small as possible may be desired, which may mean that an ARL as large as possible may be desired. To have an ARL as large as possible, a sum as large as possible of the number of data points 2310 and 2320 may be desired. This means that fewer occurrences of false alarms are desired. Thus, ARL is inversely proportional to the false alarm rate. In some embodiments, the false alarm rate and the ARL may be adjusted by adjusting the threshold value, Dₜₕ. Thus, in some embodiments, by adjusting the threshold value, Dₜₕ, the false alarm rate indicating a false change in the distribution of the real-time streaming data may be adjusted. In some embodiments, the threshold value, Dₜₕ, may be adjusted by adjusting the significance level, α. ARL is inversely proportional to significance level, a (and false alarm rate is directly proportional to the significance level, α). Thus, in some embodiments, by adjusting the significance level, α, the false alarm rate, and therefore, ARL, may be adjusted. A decreasing significance level, a may indicate increasing confidence level, which may mean reduced false alarm rate or increased ARL. The relationship between the significance level, α, and the ARL is shown in FIG. 24.

Referring to FIG. 24, an example graph 2400 is shown, in accordance with some embodiments of the present disclosure. The graph 2400 plots the relationship between ARL and the significance level, α. In particular, the graph 2400 plots 1/α on X-axis 2405 against the ARL on Y-axis 2410. The graph 2400 shows five plots 2415, 2420, 2425, 2430, and 2435, each of which corresponds to a particular size, n, of the reference window 1520, with the plot 2435 having the largest reference window size and the plot 2415 having the smallest reference window size. Each of the plots 2415-2435 assumes the same value of the damping factor, λ. Further, as seen from the graph 2400, each of the five plots 2415-2435 has a linear relationship between ARL and 1/α. Specifically, as a decreases (or 1/α increases), ARL increases.

By decreasing the significance level, α, the threshold value, Dₜₕ, may be increased and by increasing the significance level, α, the threshold value, Dₜₕ, may be increased (keeping the size of the reference window and the damping factor, λ, constant). Therefore, by increasing the threshold value, Dₜₕ, the ARL may be increased and by decreasing the threshold value, Dₜₕ, the ARL may be decreased. Since ARL is inversely proportional to the false alarm rate, by increasing the threshold value, the false alarm rate may be decreased and by decreasing the threshold value, the false alarm rate may be increased. Thus, the false alarm rate is directly proportional to the significance level, α.

Additionally, as seen from the graph 2400, for a given value of 1/α, as the size of the reference window increases, the ARL increases. Thus, in some embodiments, ARL (and therefore the false alarm rate) may also be adjusted by adjusting the reference window size, while keeping the significance level, α constant. For example, in some embodiments, the threshold value, Dₜₕ, may be increased by decreasing a number of data points in the reference window and the threshold value is decreased by increasing a number of data points in the reference window. In other words, in some embodiments, the threshold value, Dₜₕ, may be increased by decreasing the size of the reference window and the threshold value, Dₜₕ, may be decreased by increasing the size of the reference window. Thus, in some embodiments, ARL may be increased (and the false alarm rate may be decreased) by decreasing the size of the reference window and the ARL may be decreased (and the false alarm rate may be increased) by increasing the size of the reference window.

In some embodiments, an example pseudo code for computing ARL may be as follows:

```
  1. Inputs: λ ← 0.99, α = 0.075, k ← 1
  2. Inputs: n_{bins} ← 20, N ← 5000, nₜᵣₐⱼ ← 100000
  $3. {n}_{eff} ← \frac{1}{1 - λ} , {n}_{w} ← ⌈ {kn}_{eff} ⌉$
  4. for (i = 0; i < N; i + +) do
        a. [symbol]    Create two trajectories
  5.  X₁ = sampleP(N(0,10), nₜᵣₐⱼ); X₂ = sampleP(N(0,10), nₜᵣₐⱼ)
        a. [symbol]    Create two trajectories
  6.  P_{w}_{₁} = DampedWindow(λ), P_{w}_{₂} = DampedWindow(λ)
  7.  for (j = 0; j < nₜᵣₐⱼ; j + +) do
            i. [symbol]    Add new observations from streams X₁, X₂, and Update
                histogram/CDF
  8.  P_{w}_{₁} · addPoint(x₁ⱼ); P_{w}_{₂} · addPoint(x₂ⱼ)
  9.  if j ≥ n_{w} then
        a. [symbol]    Compare the two windows
10.  changeFound = compareWindows(P_{w}_{₁}, P_{w2}, α)
11.  if changeFound then
        a. [symbol]    Record change point and exit loop
12.  rl[i] = j
13.  break
14.  end if
15.  end if
16.  end for
17. end for
18. ARL = average(rl)
```

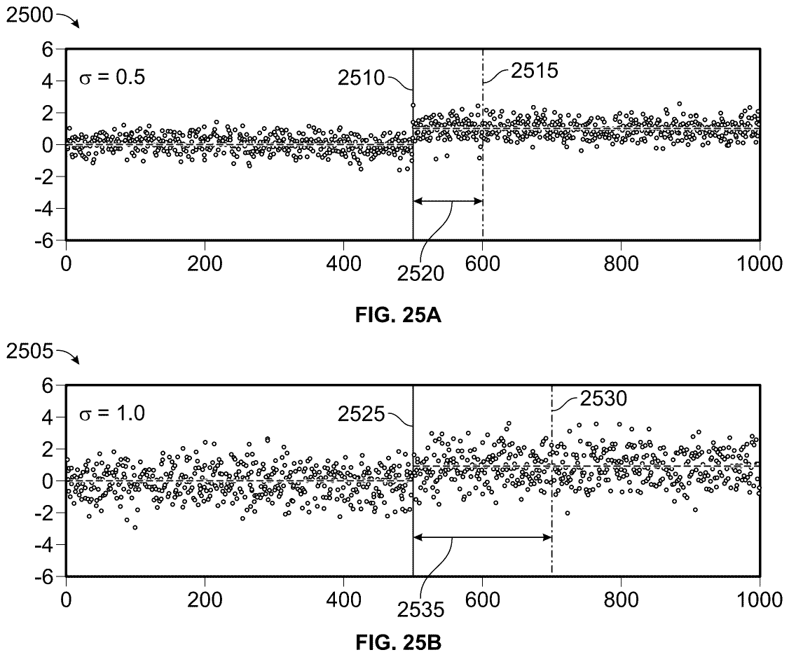

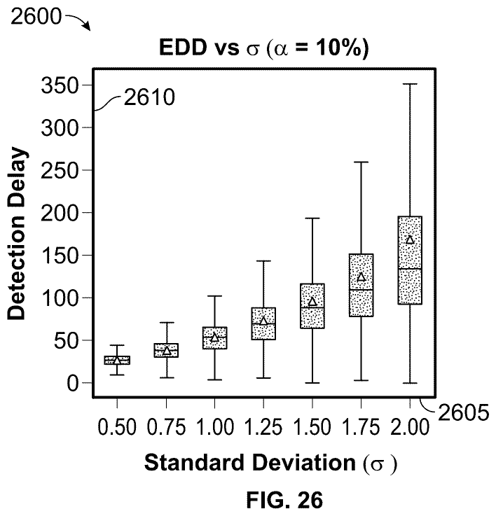

Referring now to FIGS. 25A and 25B, example data streams 2500 and 2505, respectively, are shown, in accordance with some embodiments of the present disclosure. Another measure to adjust the sensitivity of the change point detection is Expected Detection Delay (EDD). EDD is the expected stopping time after a change point has been detected. In other words, EDD is the delay in detecting that a change point has occurred. FIG. 25A shows an example in which the distribution of the data stream 2500 changes at point 2510. Thus, the change point occurs at the point 2510. However, the change point is not detected until point 2515. Thus, the time difference between the points 2510 and 2515 is EDD 2520. Similarly, in the data stream 2505, a change point occurs at point 2525 but is not detected until point 2530. Thus, the time difference between the points 2525 and 2530 is EDD 2535. The EDD 2520 is smaller than the EDD 2535. A smaller EDD may be desired. In other words, a quicker detection of the change point may be desired. In some embodiments, EDD may be due to noise in the data. For example, in some embodiments, the greater the noise in the streaming data, the greater the EDD. Thus, in some embodiments, the noise in the streaming data 2505 may be greater than the noise in the streaming data 2500, thereby resulting in the greater EDD 2535. In some embodiments, the noise in the streaming data may be reflected by standard deviation, a. The greater the noise, the greater the standard deviation of the streaming data. The standard deviation captures the noise in the data by measuring the spread or dispersion of data points around the mean. The relationship between noise (e.g., the standard deviation) and EDD is shown in FIG. 26.

Referring to FIG. 26, an example graph 2600 is shown, in accordance with some embodiments of the present disclosure. The graph 2600 plots the relationship between noise and EDD. In particular, the graph 2600 plots noise in terms of standard deviation, a, on X-axis 2605 against EDD on Y-axis 2610. Assuming constant size of the reference window and constant values of the significance level, α, and damping factor, λ, it may be seen from the graph 2600 that as the standard deviation increases on the X-axis 2605, the EDD increases on the Y-axis 2610. Thus, in some embodiments, by reducing the noise in the streaming data, the EDD may be reduced and change points may be detected more quickly after the change points actually occur. In some embodiments, the noise may be reduced by improving (e.g., in terms of hardware and/or software) the underlying sensors that measure/collect the streaming data.

In some embodiments, by adjusting the threshold value, Dₜₕ, the EDD (also referred to herein as EDD period) indicating a delay in detecting the change in the distribution of the real-time streaming data after the change in the distribution of the real-time streaming data has occurred may be adjusted. For example, in some embodiments, by increasing the threshold value, Dₜₕ, the EDD may be decreased, and by decreasing the threshold value, Dₜₕ, the EDD may be increased. In some embodiments, the threshold value, Dₜₕ, may be increased by decreasing the significance level, α, and the threshold value, Dₜₕ, may be decreased by increasing the significance level, α. In some embodiments, the threshold value, Dₜₕ, may be increased by decreasing a number of data points in the reference window (e.g., the size, n, of the reference window) and the threshold value, Dₜₕ, may be decreased by increasing a number of data points in the reference window. In some embodiments, the threshold value, Dₜₕ, may be increased by decreasing the damping factor, λ, and the threshold value, Dₜₕ, may be decreased by increasing the damping factor, A.

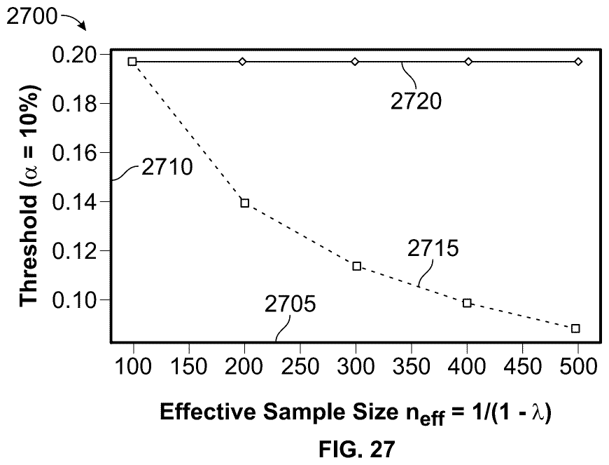

Referring to FIG. 27, an example graph 2700 is shown, in accordance with some embodiments of the present disclosure. The graph 2700 shows the relationship between the size, n, of the reference window 1520 and the threshold value, Dₜₕ, when the significance level, α is kept constant. For example, in the graph 2700, the significance level, α is kept constant at 0.1. The graph 2700 plots the size, n, of the reference window on X-axis 2705 against the threshold value, Dₜₕ, on Y-axis 2710. Note that the X-axis 2705 plots n_{eff} to reflect the ideal size of a reference window. In some embodiments, to change the size, n, of the reference window, the damping factor, λ, may be changed because the size, n, of the reference window is computed using

$$\frac{1}{1 - λ} .$$

Thus, in some embodiments, by varying the damping, factor, λ, the size, n, of the reference window 1520 may be varied. In some embodiments, as the damping factor, λ, increases, the size, n, of the reference window increases as well. Further, as shown by plot 2715, as the size of the reference window increases, the threshold value decreases. Decreasing the threshold value, Dₜₕ, means that a smaller difference in the change of distribution of the streaming data may trigger a change point detection. In contrast, as shown by plot 2720, if the threshold value, Dₜₕ, is also kept constant with increasing the size of the reference window, the change point detection threshold does not change.

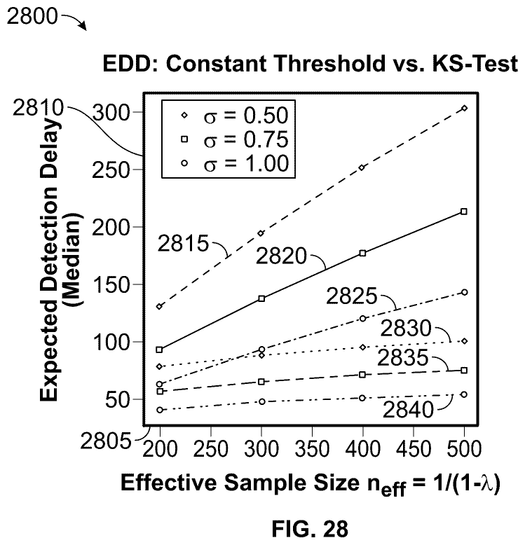

Moreover, with the constant threshold value, Dₜₕ, the EDD increases as the size, n, of the effective window increases because more of the historical data is needed before a change point may be found. In contrast, when the threshold value, Dₜₕ, is reduced with increasing the size, n, of the reference window, the EDD still increases but not as rapidly. It may be desirable to ensure that the EDD does not increase as rapidly with increasing sizes of the reference window to ensure that change points may be detected closer to the actual change points. Thus, in some embodiments, varying the threshold value, Dₜₕ, may be desirable. The difference in how much the EDD increases when the threshold value, Dₜₕ, is constant versus variable is shown in FIG. 28.

Referring to FIG. 28, an example graph 2800 is shown, in accordance with some embodiments of the present disclosure. The graph 2800 plots the size, n, of the reference window (e.g., n_{eff}) on X-axis 2805 against EDD on Y-axis 2810. Thus, the graph 2800 shows the relationship between EDD and the size, n, of the reference window. The graph 2800 shows plots 2815, 2820, and 2820 that correspond to three different data streams where the threshold value, Dₜₕ, is constant (e.g., as shown in FIG. 27 for the plot 2720) as the size, n, of the reference window is increased. The graph 2800 also shows three plots 2830, 2835, and 2840 corresponding to the same three data streams used for the plots 2815-2825 but having a variable threshold value, Dₜₕ, as the size, n, of the reference window increases. Thus, the plots 2815 and 2830 correspond to the same data stream, the plots 2820 and 2835 are for the same data stream, and the plots 2825 and 2840 are for the same data stream. As seen from the graph 2800, as the size, n, of the effective window increases on the X-axis 2805, the EDD on the Y-axis 2810 also increases for all of the plots 2815-2840. However, the rate of increase of the EDD is significantly slower in the plots 2830-2840 when the threshold value, Dₜₕ, is variable compared to the plots 2815-2825 when the threshold value, Dₜₕ, is constant.

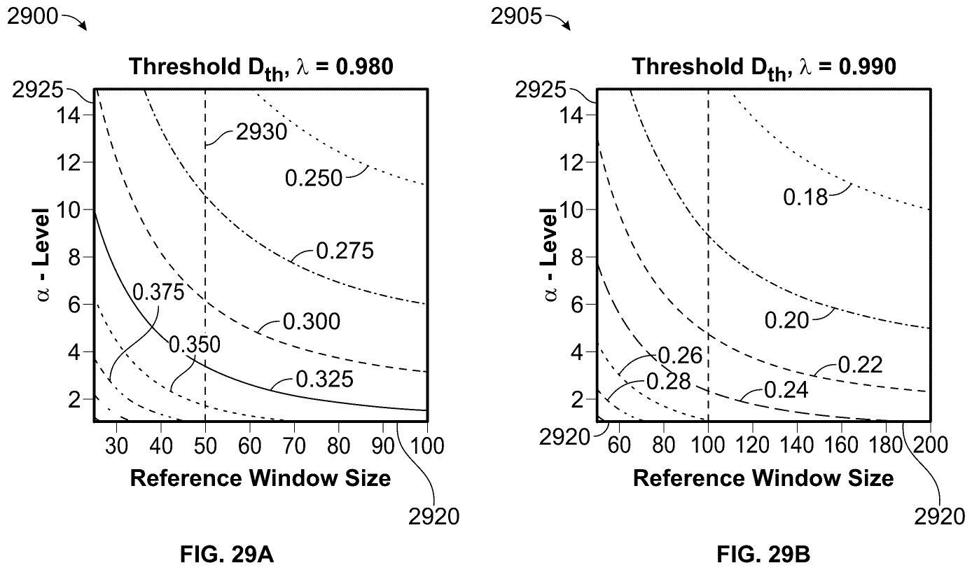

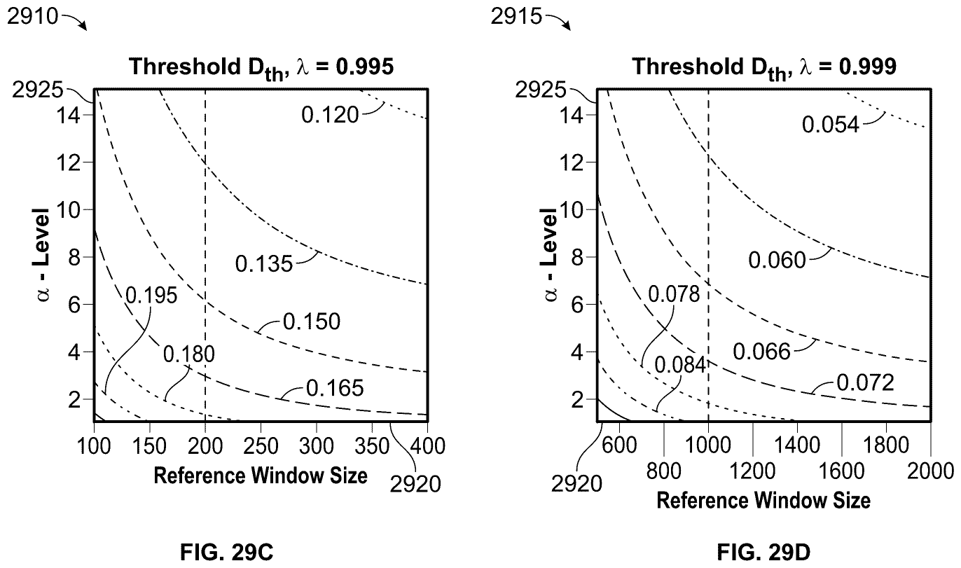

Turning now to FIGS. 29A-29D, example graphs 2900-2915 are shown, in accordance with some embodiments of the present disclosure. Each of the graphs 2900-2915 plots a size, n, of the reference window on X-axis 2920 against the significance level, α, on Y-axis 2925. The graphs 2900-2915 show how the threshold value, Dₜₕ, may be adjusted by changing one or more of the size, n, of the reference window, the significance level, α, or the damping factor, λ. In some embodiments, the size, n, of the reference window may be changed by changing the damping factor, λ. Decreasing the significance level, α, may increase the threshold value, Dₜₕ, which would mean a smaller change in the distribution of the streaming data results in a change point detection. Decreasing the significance level, α, also decreases the false alarm rate. Increasing the damping factor, λ, increases the size, n, of the reference window, meaning more data points are ingested for the reference window (and the current window). In some embodiments, the size, n, of the reference window may be fixed. In such a case, the threshold value, Dₜₕ, may be varied by varying either the significance level, α, or the damping factor, λ, or both.

For example, as shown in FIG. 29A, if the size, n, of the reference window is fixed to a particular value, for example, at 50, shown by line 2930, corresponding to a damping factor, λ, of 0.980, the various plots in the graph 2900 show how the threshold value, Dₜₕ, may vary by varying the significance level, α. Similarly, the graphs 2905-2915 show how by adjusting the size, n, of the reference window, thereby fixing the damping factor, λ, how the threshold value, Dₜₕ, may be varied at different values of the significance level, α.

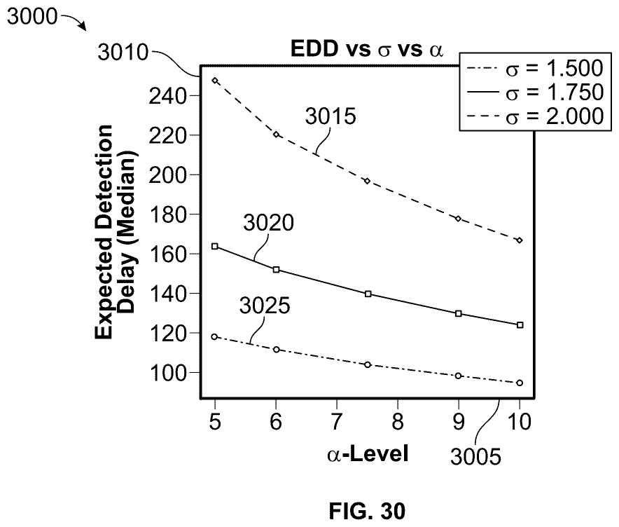

Referring to FIG. 30, an example graph 3000 is shown, in accordance with some embodiments of the present disclosure. The graph 3000 shows the relationship between EDD, the significance level, α, and noise. The graph 3000 plots the significance level, α, on X-axis 3005 against the EDD on Y-axis 3010. The graph 3000 includes plots 3015, 3020, and 3025 corresponding to data streams having differing noise levels. The data stream associated with the plot 3015 has the highest noise level and the data stream associated with the plot 3025 has the lowest noise level. As seen from each of the three plots 3015-3025, as the significance level, α, increases, the EDD decreases. The level of EDD decrease varies based on the noise level.

Thus, the proposed disclosure provides a tunable threshold value, Dₜₕ, that may be adjusted by changing one or more of the significance level, α, the damping factor, λ, the size n, of the reference window, or the noise in the data stream.

The herein described subject matter illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to disclosures containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the disclosure be defined by the claims appended hereto and their equivalents. The word “illustrative” is used herein to mean serving as an example, instance, or illustration. Any aspect or design described herein as “illustrative” is not necessarily to be construed as preferred or advantageous over other aspects or designs.

1. A non-transitory computer-readable medium comprising computer-readable instructions stored thereon that when executed by a processor cause the processor to:
receive real-time streaming data at an event stream processing engine to be processed, the real-time streaming data comprising a plurality of data points;
analyze the plurality of data points at the event stream processing engine to detect a change in a distribution of the real-time streaming data by:
(A) defining a reference window from the plurality of data points, the reference window comprising n data points of the plurality of data points, wherein the reference window is a damped window;
(B) defining a current window from the plurality of data points, the current window comprising greater than n data points of the plurality of data points, wherein the current window is a damped window;
(C) in real-time, as each data point of the reference window and the current window is received at the event stream processing engine:
computing and incrementally updating a first weighted cumulative distribution function for the reference window based on a first weight value assigned to each data point in the reference window, wherein more recent data points of the n data points are assigned greater weight than less recent data points of the n data points according to a damping factor;
(D) determining that the first weighted cumulative distribution function has been computed for all data points in the reference window and the second weighted cumulative distribution function has been computed for all data points in the current window;
(E) responsive to determining that the first weighted cumulative distribution function has been computed for all data points in the reference window and the second weighted cumulative distribution function has been computed for all data points in the current window, computing a maximum difference between the first weighted cumulative distribution function and the second weighted cumulative distribution function, wherein the assignment of greater weight to more recent data points causes the maximum difference to respond more rapidly to a change in distribution of the real-time streaming data such that an unacceptable measure of dissimilarity is detected using fewer subsequently received data points in the real-time streaming data at the event stream processing engine;
(F) computing a threshold value based on the n data points in the reference window, a damping factor, and a significance level, wherein the threshold value is an acceptable measure of dissimilarity in the distribution of the real-time streaming data; and
(G) determining that the maximum difference is greater than the threshold value, wherein the maximum difference being greater than the threshold value indicates that the detected change in the distribution of the real-time streaming data is greater than the acceptable measure of dissimilarity;
transform the detected change in the distribution of the real-time streaming data into an alert for a subscriber or client of the event streaming engine; and transmit the alert to the subscriber or client.

2. The non-transitory computer-readable medium of claim 1, wherein the computer-readable instructions further cause the processor to reset the reference window and the current window responsive to determining that the maximum difference is greater than the threshold value in (G).

3. The non-transitory computer-readable medium of claim 1, wherein the reference window is a fixed size window, and the current window is a varying size window.

4. The non-transitory computer-readable medium of claim 1, wherein the current window includes the n data points of the reference window plus additional data points from the plurality of data points.

5. The non-transitory computer-readable medium of claim 1, wherein the computer-readable instructions further cause the processor to:
responsive to determining that the data point is not an (n+1)th data point, compute and assign the first weight value to each data point in the reference window, wherein more recent data points in the reference window are assigned a higher weight value than less recent data points in the reference window; and
compute and assign the second weight value to each data point in the current window, wherein more recent data points in the current window are assigned a higher weight value than less recent data points in the current window.

6. The non-transitory computer-readable medium of claim 5, wherein the computer-readable instructions further cause the processor to compute the first weight value by computing w_i\hat{ }1=λ\hat{ }i, where w is the first weight value of a data point in the reference window, λ is the damping factor, and i=0, 1, . . . , n.

7. The non-transitory computer-readable medium of claim 5, wherein the computer-readable instructions further cause the processor to compute the second weight value by computing w_j\hat{ }=λ_1\hat{ }j, where w_1 is the second weight value of a data point in the current window, λ_1 is the damping factor, and j=0, 1, . . . , m, and m is a number of data points in the current window.

8. The non-transitory computer-readable medium of claim 1, wherein the computer-readable instructions further cause the processor to compute the first weighted cumulative distribution function for the reference window by:
computing a first damped window histogram for each data point in the reference window, the first damped window histogram comprising a first plurality of bins, wherein computing the first damped window histogram comprises computing a first weighted height of each of the first plurality of bins;
for each bin of the first plurality of bins, adding the first weighted height of all previous bins of the first plurality of bins up to the bin to obtain a first cumulative weighted height of the bin; and
plotting the first cumulative height of each bin of the first plurality of bins to obtain the first weighted cumulative distribution function for the reference window.

9. The non-transitory computer-readable medium of claim 8, wherein the computer-readable instructions further cause the processor to compute the second weighted cumulative distribution function for the current window by:
computing a second damped window histogram for each data point in the current window, the second damped window histogram comprising a second plurality of bins, wherein computing the second damped window histogram comprises computing a second weighted height of each of the second plurality of bins;
for each bin of the second plurality of bins, adding the second weighted height of all previous bins of the second plurality of bins up to the bin to obtain a second cumulative weighted height of the bin; and
plotting the second cumulative height of each bin of the second plurality of bins to obtain the second weighted cumulative distribution function for the current window.

10. The non-transitory computer-readable medium of claim 9, wherein the maximum difference is a maximum absolute difference between a plot of the first cumulative height of each bin of the first plurality of bins and the plot of the second cumulative height of each bin of the second plurality of bins.

11. The non-transitory computer-readable medium of claim 1, wherein the computer-readable instructions further cause the processor to compute the threshold value by:
$$D\_th = √ ( - 1 / 2 ln ( α / 2 ) * ( ( 1 - λ ) ( 2 {λ}^{⋀} n - {λ}^{⋀} m ) ) / ( ( 1 - {λ}^{⋀} n ) ( 1 - {λ}^{⋀} m ) ) )$$
wherein D_th is the threshold value, α is the significance level, λ is the damping factor, and m is a number of data points in the current window.

12. The non-transitory computer-readable medium of claim 1, wherein by adjusting the threshold value, (a) a false alarm rate indicating a false change in the distribution of the real-time streaming data is adjusted, and (b) an expected detection delay period indicating a delay in detecting the change in the distribution of the real-time streaming data after the change in the distribution of the real-time streaming data has occurred is adjusted.

13. The non-transitory computer-readable medium of claim 12, wherein by increasing the threshold value, the false alarm rate decreases and the expected detection delay decreases, and wherein by decreasing the threshold value, the false alarm rate increases and the expected detection delay increases.

14. The non-transitory computer-readable medium of claim 13, wherein the threshold value is increased by decreasing the significance level and the threshold value is decreased by increasing the significance level.

15. The non-transitory computer-readable medium of claim 14, wherein the false alarm rate is directly proportional to the significance level.

16. The non-transitory computer-readable medium of claim 13, wherein the threshold value is increased by decreasing a number of data points in the reference window and the threshold value is decreased by increasing a number of data points in the reference window.

17. The non-transitory computer-readable medium of claim 13, wherein the threshold value is increased by decreasing the damping factor and the threshold value is decreased by increasing the damping factor.

18. A system comprising:
a memory having computer-readable instructions stored thereon; and
a processor that executes the computer-readable instructions to:
receive real-time streaming data at an event stream processing engine to be processed, the real-time streaming data comprising a plurality of data points;
analyze the plurality of data points at the event stream processing engine to detect a change in a distribution of the real-time streaming data by:
(A) defining a reference window from the plurality of data points, the reference window comprising n data points of the plurality of data points, wherein the reference window is a damped window;
(B) defining a current window from the plurality of data points, the current window comprising greater than n data points of the plurality of data points, wherein the current window is a damped window;
(C) in real-time, as each data point of the reference window and the current window is received at the event stream processing engine:
computing and incrementally updating a first weighted cumulative distribution function for the reference window based on a first weight value assigned to each data point in the reference window, wherein more recent data points of the n data points are assigned greater weight than less recent data points of the n data points according to a damping factor; and
computing a second weighted cumulative distribution function for the current window based on a second weight value assigned to each data point in the current window;
(D) determining that the first weighted cumulative distribution function has been computed for all data points in the reference window and the second weighted cumulative distribution function has been computed for all data points in the current window;
(E) responsive to determining that the first weighted cumulative distribution function has been computed for all data points in the reference window and the second weighted cumulative distribution function has been computed for all data points in the current window, computing a maximum absolute difference between the first weighted cumulative distribution function and the second weighted cumulative distribution function, wherein the assignment of greater weight to more recent data points causes the maximum difference to respond more rapidly to a change in distribution of the real-time streaming data such that an unacceptable measure of dissimilarity is detected using fewer subsequently received data points in the real-time streaming data at the event stream processing engine;
(F) computing a threshold value based on the n data points in the reference window, a damping factor, and a significance level, wherein the threshold value is an acceptable measure of dissimilarity in the distribution of the real-time streaming data; and
(G) determining that the maximum difference is greater than the threshold value, wherein the maximum difference being greater than the threshold value indicates that the detected change in the distribution of the real-time streaming data is greater than the acceptable measure of dissimilarity;
transform the detected change in the distribution of the real-time streaming data into an alert for a subscriber or client of the event streaming engine; and
transmit the alert to the subscriber or client.

19. The system of claim 18, wherein the computer-readable instructions further cause the processor to reset the reference window and the current window responsive to determining that the maximum difference is greater than the threshold value in (G), wherein the reference window is a fixed size window, and the current window is a varying size window.

20. The system of claim 18, wherein the computer-readable instructions further cause the processor to:
compute the first weight value by computing w_i\hat{ }=λ\hat{ }i, where w is the first weight value of a data point in the reference window, X is the damping factor, and i=0, 1, . . . , n; and
compute the second weight value by computing w_j\hat{ }₂=λ_1\hat{ }j, where w_1 is the second weight value of a data point in the current window, λ_1 is the damping factor, and j=0, 1, . . . , m, and m is a number of data points in the current window.

21. The system of claim 18, wherein the computer-readable instructions further cause the processor to compute the first weighted cumulative distribution function for the reference window by:
computing a first damped window histogram for each data point in the reference window, the first damped window histogram comprising a first plurality of bins, wherein computing the first damped window histogram comprises computing a first weighted height of each of the first plurality of bins;
for each bin of the first plurality of bins, adding the first weighted height of all previous bins of the first plurality of bins up to the bin to obtain a first cumulative weighted height of the bin; and
plotting the first cumulative height of each bin of the first plurality of bins to obtain the first weighted cumulative distribution function for the reference window; and
wherein the computer-readable instructions further cause the processor to compute the second weighted cumulative distribution function for the current window by:
computing a second damped window histogram for each data point in the current window, the second damped window histogram comprising a second plurality of bins, wherein computing the second damped window histogram comprises computing a second weighted height of each of the second plurality of bins;
for each bin of the second plurality of bins, adding the second weighted height of all previous bins of the second plurality of bins up to the bin to obtain a second cumulative weighted height of the bin; and
plotting the second cumulative height of each bin of the second plurality of bins to obtain the second weighted cumulative distribution function for the current window.

22. The system of claim 21, wherein the maximum difference is a maximum absolute difference between a plot of the first cumulative height of each bin of the first plurality of bins and the plot of the second cumulative height of each bin of the second plurality of bins.

23. The system of claim 18, wherein the computer-readable instructions further cause the processor to compute the threshold value by:
$$D\_th = √ ( - 1 / 2 ln ( α / 2 ) * ( ( 1 - λ ) ( 2 {λ}^{⋀} n - {λ}^{⋀} m ) ) / ( ( 1 - {λ}^{⋀} n ) ( 1 - {λ}^{⋀} m ) ) )$$
wherein D_th is the threshold value, α is the significance level, λ is the damping factor, and m is a number of data points in the current window.

24. The system of claim 18, wherein by adjusting the threshold value, (a) a false alarm rate indicating a false change in the distribution of the real-time streaming data is adjusted, and (b) an expected detection delay period indicating a delay in detecting the change in the distribution of the real-time streaming data after the change in the distribution of the real-time streaming data has occurred is adjusted.

25. The system of claim 24, wherein by increasing the threshold value, the false alarm rate decreases and the expected detection delay decreases, and wherein by decreasing the threshold value, the false alarm rate increases and the expected detection delay increases, wherein the threshold value is increased by decreasing the significance level and the threshold value is decreased by increasing the significance level.

26. The system of claim 24, wherein the false alarm rate is directly proportional to the significance level.

27. The system of claim 24, wherein the threshold value is increased by decreasing a number of data points in the reference window and the threshold value is decreased by increasing a number of data points in the reference window, or wherein the threshold value is increased by decreasing the damping factor and the threshold value is decreased by increasing the damping factor.

28. A method comprising:
receiving, by a processor executing computer-readable instructions stored on a memory, real-time streaming data at an event stream processing engine to be processed, the real-time streaming data comprising a plurality of data points;
analyzing, by the processor, the plurality of data points at the event stream processing engine to detect a change in a distribution of the real-time streaming data by:
(A) defining, by the processor, a reference window from the plurality of data points, the reference window comprising n data points of the plurality of data points, wherein the reference window is a damped window;
(B) defining, by the processor, a current window from the plurality of data points, the current window comprising greater than n data points of the plurality of data points, wherein the current window is a damped window;
(C) in real-time, as each data point of the reference window and the current window is received at the event stream processing engine:
computing and incrementally updating, by the processor, a first weighted cumulative distribution function for the reference window based on a first weight value assigned to each data point in the reference window, wherein more recent data points of the n data points are assigned greater weight than less recent data points of the n data points according to a damping factor; and
computing, by the processor, a second weighted cumulative distribution function for the current window based on a second weight value assigned to each data point in the current window;
(D) determining, by the processor, that the first weighted cumulative distribution function has been computed for all data points in the reference window and the second weighted cumulative distribution function has been computed for all data points in the current window;
(E) responsive to determining that the first weighted cumulative distribution function has been computed for all data points in the reference window and the second weighted cumulative distribution function has been computed for all data points in the current window, computing, by the processor, a maximum difference between the first weighted cumulative distribution function and the second weighted cumulative distribution function, wherein the assignment of greater weight to more recent data points causes the maximum difference to respond more rapidly to a change in distribution of the real-time streaming data such that an unacceptable measure of dissimilarity is detected using fewer subsequently received data points in the real-time streaming data at the event stream processing engine;
(F) computing, by the processor, a threshold value based on the n data points in the reference window, a damping factor, and a significance level, wherein the threshold value is an acceptable measure of dissimilarity in the distribution of the real-time streaming data; and
(G) determining, by the processor, that the maximum difference is greater than the threshold value, wherein the maximum difference being greater than the threshold value indicates that the detected change in the distribution of the real-time streaming data is greater than the acceptable measure of dissimilarity;
transforming, by the processor, the detected change in the distribution of the real-time streaming data into an alert for a subscriber or client of the event streaming engine; and
transmitting, by the processor, the alert to the subscriber or client.

29. The method of claim 28, further comprising computing, by the processor, the threshold value by:
$$D\_th = √ ( - 1 / 2 ln ( α / 2 ) * ( ( 1 - λ ) ( 2 {λ}^{⋀} n - {λ}^{⋀} m ) ) / ( ( 1 - {λ}^{⋀} n ) ( 1 - {λ}^{⋀} m ) ) )$$
wherein D_th is the threshold value, α is the significance level, λ is the damping factor, and m is a number of data points in the current window.

30. The method of claim 28, wherein by adjusting the threshold value, (a) a false alarm rate indicating a false change in the distribution of the real-time streaming data is adjusted, and (b) an expected detection delay period indicating a delay in detecting the change in the distribution of the real-time streaming data after the change in the distribution of the real-time streaming data has occurred is adjusted.

31. The non-transitory computer-readable medium of claim 1, wherein the real-time streaming data comprises telemetry data generated by one or more networked devices, and wherein detecting the change in the distribution of the real-time streaming data comprises detecting an operational anomaly in the one or more networked devices and transmitting the alert to a monitoring system for responsive action.

32. The non-transitory computer-readable medium of claim 1, wherein detecting the change in the distribution of the real-time streaming data is performed as part of a continuous query executed within the event stream processing engine, and wherein the alert is published to subscribed clients via a publish-subscribe mechanism of the event stream processing engine.
